(19) United States
(12) Patent Application Publication
(10) Pub. No.: US 2018/0133956 A1
(43) Pub. Date: May 17, 2018

(54) MATERIAL-FALL THREE-DIMENSIONAL PRINTING

(71) Applicant: Velo3D, Inc., Campbell, CA (US)

(72) Inventors: Benyamin Buller, Cupertino, CA (US); Erel Milshtein, Cupertino, CA (US); Thomas Blasius Brezoczky, Los Gatos, CA (US); Sherman Seelinger, San Jose, CA (US)

(21) Appl. No.: 15/870,561

(22) Filed: Jan. 12, 2018

Related U.S. Application Data
(63) Continuation of application No. PCT/US16/41895, filed on Jul. 12, 2016.
(60) Provisional application No. 62/193,559, filed on Jul. 16, 2015.
(60) Provisional application No. 62/214,148, filed on Sep. 3, 2015.

(51) Int. Cl. B29C 64/153; B22F 3/105; B28B 1/00; B28B 17/00; B33Y 10/00; B33Y 50/02; B29C 64/393; B29C 64/357; B23K 26/354; B23K 26/34

(52) U.S. Cl. CPC B29C 64/153; B22F 3/1055; B28B 1/001; B28B 17/0081; B33Y 10/00; B22F 2003/1059; B29C 64/393; B29C 64/357; B23K 26/354; B23K 26/34; B22F 2003/1057; B33Y 50/02

(57) ABSTRACT

The present disclosure provides three-dimensional (3D) objects, 3D printing processes, as well as methods, apparatuses, non-transitory computer readable medium, and systems for the production of a 3D object utilizing a material-fall directed towards a target surface.

### CROSS-REFERENCE

This application is a continuation application of International Patent Application No. PCT/US16/41895, filed Jul. 12, 2016, which claims priority to U.S. Provisional Patent Application No. 62/193,559, filed Jul. 16, 2015 and U.S. Provisional Patent Application No. 62/214,148, filed Sep. 3, 2015, each of which is entirely incorporated herein by reference.

### BACKGROUND

Three-dimensional (3D) printing (e.g., additive manufacturing) is a process for making a 3D object of any shape from a design. The design may be in the form of a data source such as an electronic data source, or may be in the form of a hard copy. The hard copy may be a two dimensional representation of a 3D object. The data source may be an electronic 3D model. 3D printing may be accomplished through an additive process in which successive layers of material are laid down on top of each other. This process may be controlled (e.g., computer controlled, manually controlled, or both). A 3D printer can be an industrial robot.

Three-dimensional printing can generate custom parts quickly and efficiently. A variety of materials can be used in a 3D printing process including elemental metal, metal alloy, ceramic, elemental carbon, or polymeric material. In a typical additive 3D printing process, a first material-layer is formed, and thereafter, successive material-layers are added one by one, wherein each new material-layer is added on a pre-formed material-layer, until the entire designed three-dimensional structure (3D object) is materialized.

Three-dimensional models may be created with a computer aided design package or via 3D scanner. The manual modeling process of preparing geometric data for 3D computer graphics may be similar to plastic arts, such as sculpting or animating. In an example, three-dimensional scanning is a process of analyzing and collecting digital data on the shape and appearance of a real object. Based on this data, 3D models of the scanned object can be produced. The 3D models may include computer-aided design (CAD).

A large number of additive processes are currently available. They may differ in the manner layers are deposited to create the materialized structure. They may vary in the material or materials that are used to materialize the designed structure. Some methods transform (e.g., sinter or melt) or soften material to produce the layers. Examples for 3D printing methods include selective laser melting (SLM), selective laser sintering (SLS), direct metal laser sintering (DMLS), shape deposition manufacturing (SDM), or fused deposition modeling (FDM). Other methods cure liquid materials using different technologies such as stereo lithography (SLA). In the method of laminated object manufacturing (LOM), thin layers (made, inter alia, of paper, polymer, metal) are cut to shape and joined together.

At times, the printed 3D object may bend, warp, roll, curl, or otherwise deform during the 3D printing process. Auxiliary supports may be inserted to circumvent such bending, warping, rolling, curling, or other deformation. These auxiliary supports may be removed from the printed 3D object to produce a desired 3D product (e.g., 3D object).

In some embodiments, the present disclosure delineates methods, systems, apparatuses, and software that allow modeling of 3D objects with a reduced amount of design constraints (e.g., no design constraints). The present disclosure delineates delineates methods, systems, apparatuses, and software that allow materialization of these 3D object models.

### SUMMARY

In an aspect disclosed herein are methods, systems, software, and apparatuses for three-dimensional (3D) printing that use a curtain of falling particulate material (e.g., powder material) designated herein as “material-fall.” The curtain of falling particulate material may be a stream of particulate material. The material-fall may comprise falling particulate material. For example, the material may fall from a material dispenser towards a target surface (e.g., a top surface of a material bed). The fall may be autonomous, or may be aided by at least one (e.g., pressurized) gas. The fall may be directed, for example, towards a target surface. The particulate material may be a solid material (e.g., a powder). During the fall, an energy beam may transform (e.g., melt or sinter) a (e.g., designated) portion of the particulate material within the material-fall into a transformed material. The transformed material may subsequently harden into a hardened material.

In another aspect, a method for forming a three-dimensional object, comprises: (a) generating a material-fall directed towards a target surface, wherein the material-fall comprises a particulate material; (b) projecting an energy beam onto the material-fall in one or more specified locations that correspond to a model design of the three-dimensional object, wherein the energy beam does not intersect the target surface; and (c) transforming at least a portion of the particulate material in the material-fall to a transformed material that forms at least a portion of the three-dimensional object.

The target surface can comprise a platform or an exposed surface of a material bed. The material bed can be formed of the particulate material. The material bed may comprise the particulate material. The particulate material can comprise a powder material. The particulate material can comprise a solid material. The particulate material can be formed of a material selected from the group consisting of an elemental metal, metal alloy, ceramic, and an allotrope of carbon. The transforming can comprise melting or sintering. Forms at least a portion of the three-dimensional object can comprise (e.g., subsequently) hardens to form least a portion of the three-dimensional object. Hardens can comprise solidifies. The material-fall can be a stream of the particulate material. The stream can be a directional stream. The stream can be a directed stream. The directed may be collimated. The energy beam can be projected (i) in a direction parallel or (ii) in an angle away from the target surface (e.g., form an angle with the target surface), which angle is between the energy beam and the average target surface plane. The energy beam can project (e.g., substantially) parallel to the target surface. The energy beam can project at an angle away from the target surface (e.g., form an angle with the target surface). The energy beam may travel (e.g., may progress) in a first direction that is different from a second direction in which the material-fall travels. The direction (e.g., first and/or second) may be a horizontal and/or vertical direction. For example, the material fall may travel to in a (e.g., substantially) vertical direction, whereas the energy beam travels in a (e.g., substantially) horizontal direction. The energy beam may travel towards a first position that is different from a second position to which the material-fall is directed to. The energy beam may progress in a direction that intersects the material-fall. The energy beam may travel towards a side or a top of the enclosure. The energy beam may additionally or alternatively intersect the material-fall. The material-fall may travel towards the bottom of the enclosure. The material-fall and the target surface may be disposed within an enclosure. The material-fall may be otherwise (e.g., except for being in the enclosure) unconfined within a physical structure. The material-fall may travel freely within the enclosure. The energy beam may travel unconfined (e.g., except for traveling within the enclosure) within the enclosure. The energy beam may travel freely (e.g., unobstructed and/or unconfined) within the enclosure. The particulate material in the material-fall may travel at a (e.g., substantially) constant speed. The particulate material in the material-fall may not (e.g., substantially) accelerate (e.g., by a pressurized gas). The material-fall may be collimated. The collimation may comprise a gas. The collimation can comprise a lens (e.g., one or more lenses). The lens can comprise a hydraulic lens. The lens can comprise a magnetic lens. The lens can comprise an electrostatic lens. The lens can comprise an electrode. The particulate material may be unsuspended in at least one gas prior to entering the material-fall. The particulate material may not form a suspension prior to entering (e.g., forming) the material-fall. For example, the particular material may not form a (e.g., substantially) homogeneous suspension prior to entering (e.g., forming) the material-fall. The material-fall may be enclosed within an enclosure. The material-fall may not be otherwise confined by an additional physical structure (e.g., except for being in an enclosure). The physical structure may be a nozzle. The physical structure may be a tube.

In another aspect is a method for forming a 3D object that comprises: (a) generating a material-fall directed towards a target surface, wherein the material-fall comprises a particulate material; (b) projecting an energy beam onto the material-fall in one or more specified locations that correspond to a model design of the 3D object, wherein the energy beam does not project onto a plane comprising the target surface; and (c) transforming at least a portion of the particulate material in the material-fall to a transformed material that subsequently forms at least a portion of the 3D object.

Subsequently forms at least a portion of the 3D object may comprise subsequently hardens to form at least a portion of the 3D object. The solid material may be formed of a material selected from the group consisting of an elemental metal, metal alloy, ceramic, and an allotrope of carbon. The particulate material may comprise powder. The particulate material may comprise a solid material. Transforming may comprise melting or sintering. In some examples, “hardens” comprises “solidifies.” The material-fall may be a stream of the particulate material. The stream can be a directional stream. The stream can be a directed stream. The energy beam can project substantially parallel to the target surface. The energy beam can project in an angle away from the target surface. The energy beam can project parallel or in an angle away from the target surface. The energy beam can travel in a direction different from a direction of the material-fall. The energy beam may travel towards a side or a top of the enclosure incorporating the material-fall, and wherein the material-fall travels towards the bottom of the enclosure. The material-fall and the target surface may be disposed within an enclosure, wherein the material-fall may not be otherwise confined within a physical structure. The target surface may comprise an exposed surface of a material bed. The material-fall and the target surface may be disposed within an enclosure, wherein the energy beam may not be otherwise confined within a physical structure. The particulate material in the material-fall may not be accelerated by a pressurized gas. The material-fall may be collimated by a gas. The material-fall may be collimated by one or more lenses. The one or more lenses may comprise hydraulic lenses. The one or more lenses can comprise magnetic lenses. The one or more lenses can comprise electrostatic lenses. The one or more lenses can comprise at least one electrode. The particulate material may not be suspended in a gas prior to entering the material-fall. At times, the particulate material may not form a substantially homogeneous suspension prior to entering the material-fall. At times, the particulate material may not form a suspension prior to entering the material-fall. The material-fall can be enclosed within an enclosure and not be otherwise confined by a physical structure (e.g., a nozzle or a tube).

In another aspect is a method for forming a 3D object that comprises: (a) generating a material-fall directed towards a target surface to form at least a portion of a material bed, wherein the material-fall comprises a particulate material; (b) projecting an energy beam onto the material-fall in one or more specified locations that correspond to a model design of the 3D object; and (c) transforming at least a portion of the particulate material in the material-fall to a transformed material that subsequently forms at least a portion of the 3D object.

Subsequently forms at least a portion of the 3D object may comprise subsequently hardens to form at least a portion of the 3D object. The particulate material may be a solid material. The target surface comprises an exposed surface of the material bed. The at least a portion of the 3D object can be suspended within the material bed. The 3D object can be devoid of auxiliary support. The 3D object can be devoid of auxiliary supports. In some examples, correspond to a model design of the 3D object comprises a deviation from a cross-section of a model design of the 3D object. The deviation can include a corrective deviation. The 3D object may substantially correspond to the model design of the 3D object.

In another aspect is a method for forming a 3D object that comprises: (a) generating a material-fall directed towards a target surface, wherein the material-fall comprises a solid material, and wherein the material-fall is disposed within an enclosure and is not otherwise confined; (b) projecting an energy beam onto the material-fall in one or more specified locations that correspond to a model design of the 3D object; and (c) transforming at least a portion of the solid material in the material-fall to a transformed material that subsequently forms at least a portion of the 3D object.

In another aspect is a system for generating a 3D object that comprises: a material dispenser for generating a material-fall towards a target surface, wherein the material-fall comprises a particulate material; an energy source for projecting an energy beam onto the material-fall in one or more specified locations that correspond to a model design of the 3D object; and a controller operatively coupled to the material dispenser and the energy source, wherein the controller is programmed to: (i) direct the material dispenser to generate the material-fall towards the target surface, and (ii) direct the energy source to project the energy beam onto the material-fall in the one or more specified locations that correspond to the model design of the 3D object, to transform at least a portion of the particulate material in the material-fall to a transformed material that subsequently forms at least a portion of the 3D object, wherein the energy beam does not intersect (e.g., project towards) the target surface.

In another aspect is a system for generating a 3D object that comprises: a material dispenser for generating a material-fall towards a target surface to form at least a portion of a material bed, wherein the material-fall comprises a particulate material; an energy source for projecting an energy beam onto the material-fall in one or more specified locations that correspond to a model design of the 3D object; and a controller operatively coupled to the material dispenser and the energy source, wherein the controller is programmed to: (i) direct the material dispenser to generate the material-fall towards the target surface, and (ii) direct the energy source to project the energy beam onto the material-fall in the one or more specified locations that correspond to the model design of the 3D object, to transform at least a portion of the particulate material in the material-fall to a transformed material that subsequently forms at least a portion of the 3D object.

In another aspect is a system for generating a 3D object that comprises: a material dispenser for generating a material-fall towards a target, wherein the material-fall comprises a particulate material, and wherein the material-fall is disposed within an enclosure and is otherwise unconfined; an energy source for projecting an energy beam onto the material-fall in one or more specified locations that correspond to a model design of the 3D object; and a controller operatively coupled to the material dispenser and the energy source, wherein the controller is programmed to: (i) direct the material dispenser to generate the material-fall towards the target surface, and (ii) direct the energy source to project the energy beam onto the material-fall in the one or more specified locations that correspond to the model design of the 3D object, to transform at least a portion of the solid material in the material-fall to a transformed material that subsequently forms at least a portion of the 3D object.

In another aspect is an apparatus for generating a 3D object that comprises: (a) an enclosure comprising a target surface; (b) a material dispenser disposed adjacent to the target surface, wherein the material dispenser is separated from the target surface by a gap, wherein the material dispenser generates a material-fall towards the target surface, and wherein the material-fall comprises a particulate material; and (c) an energy source for projecting an energy beam onto the material-fall in one or more specified locations that correspond to a model design of the 3D object, wherein the energy beam does not intersect with the target surface, and wherein the energy beam facilitates transformation of at least a portion of the particulate material in the material-fall to a transformed material that subsequently forms at least a portion of the 3D object.

In another aspect is an apparatus for generating a 3D object that comprises: (a) an enclosure comprising a target surface; (b) a material (e.g., powder) dispenser disposed adjacent to the target surface, wherein the material dispenser is separated from the target surface by a gap, wherein the material dispenser generates a material-fall towards the target surface to form at least a portion of a material bed, and wherein the material-fall comprises a particulate (e.g., solid) material; and (c) an energy source for projecting an energy beam onto the material-fall in one or more specified locations that correspond to a model design of the 3D object, wherein the energy beam facilitates transformation of at least a portion of the particulate material in the material-fall to a transformed material that subsequently forms at least a portion of the 3D object.

In another aspect is an apparatus for generating a 3D object that comprises: (a) an enclosure comprising a target surface; (b) a material dispenser disposed adjacent to the target surface, wherein the material dispenser is separated from the target surface by a gap, wherein the material dispenser generates a material-fall towards the target surface, wherein the material-fall comprises a particulate material, and wherein the material-fall is disposed within the enclosure and is not otherwise confined; and (c) an energy source for projecting an energy beam onto the material-fall in one or more specified locations that correspond to a model design of the 3D object, wherein the energy beam facilitates transformation of at least a portion of the particulate material in the material-fall to a transformed material that subsequently forms at least a portion of the 3D object.

In another aspect is an apparatus for generating a 3D object that comprises a controller that is programmed to: direct a material dispenser to generate a material-fall towards a target surface, wherein the material-fall comprises a solid material; and direct an energy source to project an energy beam onto the material-fall in one or more specified locations that correspond to a model design of the 3D object, wherein the energy beam projects onto a surface different from the target surface, and wherein the energy beam facilitates transformation of at least a portion of the particulate material in the material-fall to a transformed material that subsequently forms at least a portion of the 3D.

In another aspect is an apparatus for generating a 3D object, comprising a controller that is programmed to: direct a material dispenser to generate a material-fall towards a target surface to form at least a portion of a material bed, wherein the material-fall comprises a particulate material; and direct an energy source to project an energy beam onto the material-fall in one or more specified locations that correspond to a model design of the 3D object, wherein the energy beam facilitates transformation of at least a portion of the particulate material in the material-fall to a transformed material that subsequently forms at least a portion of the 3D.

In another aspect is an apparatus for generating a 3D object that comprises a controller that is programmed to: (a) direct a material dispenser to generate a material-fall towards a target surface, wherein the material-fall comprises a particulate material, and wherein the material-fall is disposed within an enclosure and is not otherwise confined; and (b) direct an energy source to project an energy beam onto the material-fall in one or more specified locations that correspond to a model design of the 3D object, wherein the energy beam facilitates transformation of at least a portion of the particulate material in the material-fall to a transformed material that subsequently forms at least a portion of the 3D.

Another aspect of the present disclosure provides a non-transitory computer readable medium comprising machine-executable code that, upon execution by one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 schematically illustrates a three-dimensional (3D) printing system and its components;

FIG. 2 schematically illustrates a 3D printing system and its components;

FIGS. 3A-3D schematically illustrate vertical cross sections of various mechanisms for dispensing material;

FIG. 4 schematically illustrates vertical cross sections of a mechanism for dispensing material;

FIGS. 5A-5B schematically illustrate vertical side cross sections of various mechanisms for dispensing material;

FIG. 6 schematically illustrates a vertical cross section of a mechanism for dispensing material;

FIG. 7 schematically illustrates a vertical cross sections of a mechanism for dispensing material;

FIG. 8 schematically illustrates an example of material-falls;

FIG. 9 schematically illustrates a 3D printing system and its components;

FIGS. 10A-10I schematically illustrate 3D printing operations;

FIG. 11 schematically illustrates a computer control system that is programmed or otherwise configured to facilitate the formation of a 3D object;

FIG. 12 schematically illustrates various components of a 3D printing system;

FIG. 13 schematically illustrates a 3D object;

FIG. 14 shows a horizontal view of a 3D object; and

FIG. 15 shows schematics of various vertical cross sectional views of different 3D objects.

The figures and components therein may not be drawn to scale. Various components of the figures described herein may not be drawn to scale.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a”, “an” and “the” are not intended to refer to only a singular entity, but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2.

The term “adjacent” or “adjacent to,” as used herein, includes ‘next to’, ‘adjoining’, ‘in contact with’, and ‘in proximity to.’ The term “adjacent to” may be ‘above’ or ‘below.’

Disclosed herein are methods, systems, and apparatuses for three-dimensional (herein “3D”) printing comprising a material-fall, which is formed by at least one particulate material (e.g., powder material) that transports from a source position towards a target position (e.g., at a target surface). The particulate material can comprise a granular material. The granular material may comprise a solid material. The particulate material can comprise vesicles. The particular material may be a pre-transformed material. Pre-transformed material, as understood herein, is a material before it has been transformed during the 3D printing process. The transformation can be effectuated by utilizing an energy beam and/or flux. The pre-transformed material may be a material that was, or was not, transformed prior to its use in a 3D printing process. The pre-transformed material may be a starting material for the 3D printing process.

The material-fall may (e.g., substantially) span the width of the target surface. The material-fall may travel laterally along the length of a target surface (e.g., a platform, and/or an exposed surface of a material bed). In some instances, the travel of the material-fall along the target surface will cover in one traveling round the entire target surface. In some embodiments, the material-fall may span a portion of the target surface width. In some embodiments, multiple material-falls may span the width of the target surface. In some instances, the material-fall may span a portion of the width of the target surface. In some instances, two or more material-falls (multiplicity of material-falls) may span the width of the target surface. Two or more energy beams may scan the two or more material-falls respectively. Two or more scanners may scan the two or more material-falls respectively. Each travel round of the material-fall along the length of the target surface may produce a layer of transformed material. The transformed material may (e.g., subsequently) hardens into a hardened material (e.g., to form a layer of hardened material) that forms at least a portion of the 3D object. In some embodiments, each travel round may produce a portion of a layer of transformed material. For example, one round may produce a portion of a layer of transformed material, and a second round may produce the missing portion of that layer, such that after two rounds, a completed layer of transformed material is formed. In a similar manner, a layer of transformed material may be constructed after at least 3, 4, 5, 6, 7, 8, 9, or 10 rounds. Successive travel rounds may layer-wise produce the desired 3D object.

The top (i.e., exposed) surface of a material bed (e.g., powder bed) may be leveled after each round by a powder leveling mechanism (e.g., comprising a rake or a blade). In some instances, the top surface of the material bed may not be leveled after each round by a leveling mechanism. The leveling mechanism may expose the previously formed hardened material (e.g., to allow adherence to a newly deposited transformed material). Sometimes the leveling may not exposed the previously formed hardened material. In some instances, a portion of hardened material will remain covered by a pre-transformed (e.g., powder) material. In some instances, the transformed material that reaches a target surface (e.g., top surface of the material bed) may have sufficient energy (e.g., heat) to transform any residual pre-transformed material that lies above the hardened material in the material bed. In some instances, the material removal mechanism does not contact the target surface. For example, a leveling mechanism may comprise a material removal mechanism that does not contact the top surface of the material bed.

The energy beam may travel (e.g., laterally) in synchronicity with the material-fall. The energy beam (e.g., laser beam) may comprise a modulated energy beam (e.g., power modulated) such that at or above a certain power level threshold, the energy beam transforms the particulate material, and the energy beam does not transform the particulate material below the power level threshold. The 3D printing can be done in an ambient, negative, or positive pressure.

The 3D object formed by the methods, systems, software, and/or apparatuses described herein may comprise a lesser degree of stress and/or deformation as compared to a respective 3D object produced by conventional 3D printing methodology. The 3D object formed by the methods, systems and/or apparatuses described herein may be produced at a faster rate, and/or lower cost as compared to a respective 3D object produced by conventional 3D printing.

The software may be a non-transitory computer readable medium.

In some embodiments, the material-fall comprises a line (e.g., horizontal or vertical line) of falling particulate material. The material-fall may comprise a curtain of falling particulate material. The material-fall may comprise a stream of falling particulate material. The material-fall may comprise streaming of falling particulate material. The particulate material may transport (e.g., travel) within the material-fall to form a path (a trajectory). The particulate material may be deposited onto the target surfaced via the material-fall. The trajectory may be a (e.g., substantially) vertical line. At time, the vertical line may be substantially normal to the average plane of the target surface. At times (e.g., over a period of time), the vertical line may form an angle with the average plane of the target surface. The particulate material may fall substantially vertically. The particulate material may translate in a trajectory that is (e.g., substantially) a straight line, which is (e.g., substantially) perpendicular to the target surface. The source position can be the exit opening port of a material dispensing mechanism (e.g., material dispenser such as a powder dispenser, or a recoater). The particulate material may exit the exit opening port in a substantially linear trajectory (e.g., without hitting a surface outside of the opening port, such as a wall (e.g., of a chamber) or a nozzle). In some examples, the particulate material may not be suspended in at least one gas to form a suspension prior to exiting the opening port. In some examples, the particulate material may be suspended in at least one gas to form a suspension prior to exiting the opening port. The particulate material may transport in a laminar flow within the material-fall. The material flow may comprise a laminar flow of the particulate material.

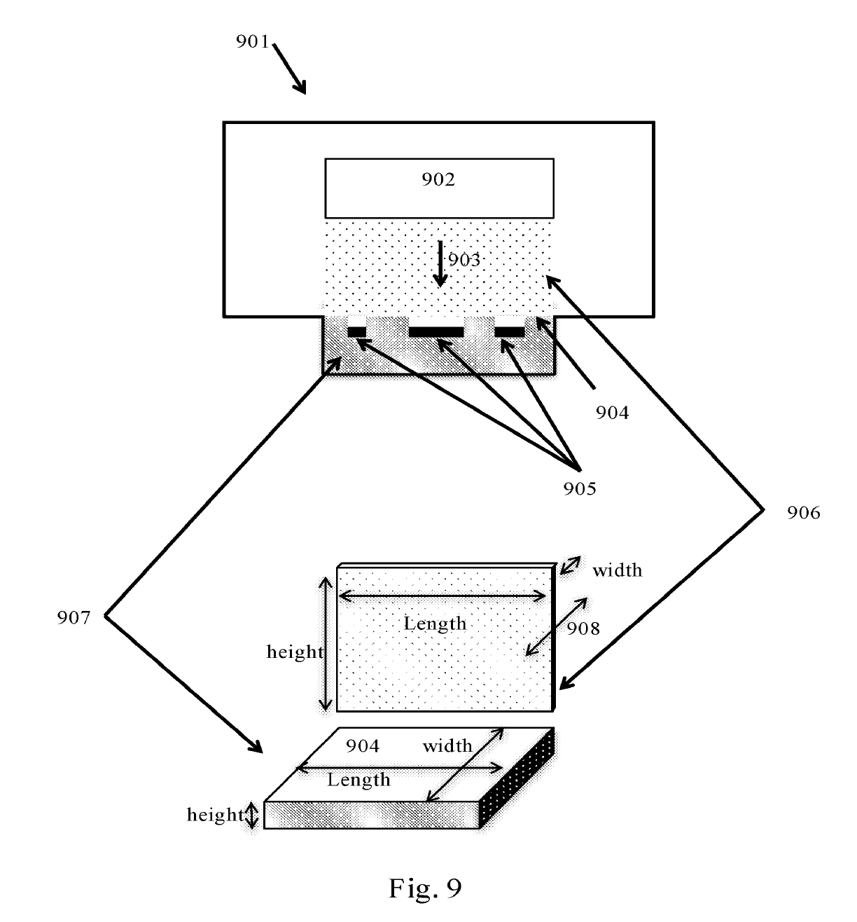

At times, the particulate material transforms from one state (e.g., state of matter) to another (e.g., from solid to liquid) prior to reaching the target surface. The transformation may be complete transformation. The transformation may be a partial transformation. The transformation may occur during the transport of the material in the material-fall. The transformation can occur at specific location within the material-fall. The specific locations may correspond to a model of the (desired) 3D object. In some instances, the specific locations may correspond to a cross section of the model of the 3D object. In some instances, the specific locations may deviate from a cross section of the model of the 3D object. The deviation may be a corrective deviation, such that the formed 3D object (e.g., after hardening such as after solidifying) may substantially correspond to the model of the 3D object. The material-fall may translate laterally along the target surface. FIG. 9 shows an example of a material-fall 906, which translates laterally (e.g., 908) along the target surface 904 of a material (e.g., powder) bed 907. The lateral translation may be in a direction that is (e.g., substantially) perpendicular to the average plane of the material-fall. The material-fall can have a (e.g., substantially) cuboid, cylindrical or ring shape. The lateral translation may be in a direction that is (e.g., substantially) perpendicular to the height and/or the length of the material-fall (e.g., FIG. 9, 906). The length of the material-fall may span the length of the building chamber or the material bed (e.g., the length of the target surface). In some embodiments, the length of the material-fall may be smaller or larger than the length of the target surface. The lateral translation of the material-fall may be perpendicular to the average trajectory of the solid material within the material-fall. The average plane of the material-fall may be a plane perpendicular to the average plane of the target surface. The average plane of the material-fall may be a plane perpendicular to the average plane of the substrate on which the material bed forms. The material-fall may travel (e.g., substantially) laterally along the target surface, and subsequently (e.g., upon cooling) generate a layer of hardened material, which may constitute a part of the 3D object. The material-fall may travel along the target surface to deposit an additional layer of material that may be similarly transformed to subsequently form an additional layer of hardened material as part of the 3D object. The material-fall may constitute one or more types of material. A material dispensing mechanism may comprise a single type of particulate material, or a multiplicity of particulate material types. The material dispensing mechanism may dispense a single type of particulate material. The types of material within the material-fall may change after each scan, or after several scans, of the target surface. During each successive scans of the target surface, the types of material within the material-fall may remain substantially unchanged.

The particulate material (e.g., powder) may be used to produce a solidified 3D object by transforming (e.g., melting, sintering, connecting or binding the material) and subsequently hardening (e.g., solidifying) the transformed material to form at least a part of the 3D object. The falling stream of particulate material (e.g., a falling curtain of particulate material, herein designated as “material-fall”) may transfer to a target surface (e.g., the exposed surface of a material bed, a base, a substrate, or a previously formed 3D object). The particulate material may transfer from an exit opening port of a material dispensing mechanism (e.g., a material dispenser) to the target surface.

The particulate material that transfers to the target surface within the material-fall may be at its pre-transformed or transformed state. One or more portions of the material-fall may be transformed into a transformed material before (e.g., just before) contacting the target surface. The one or more portions may be predetermined portions. The portion may correspond to at least portion of a 3D object slice. The vertical position at which the energy beam transforms the material may be just before the material reaches the target surface. The position may be at least about 0.1 millimeters (mm), 0.2 mm, 0.3 mm, 0.4 mm, 0.5 mm, 0.6 mm, 0.7 mm, 0.8 mm, 0.9 mm, 1 mm, 1.5 mm, 2 mm, 4 mm, 6 mm, 8 mm, 10 mm, 15 mm, 20 mm, 25 mm, 30 mm, 35 mm, 40 mm, 45 mm, 50 mm, 55 mm, or 60 mm above the target surface. The position may be at most about 0.1 millimeters (mm), 0.2 mm, 0.3 mm, 0.4 mm, 0.5 mm, 0.6 mm, 0.7 mm, 0.8 mm, 0.9 mm, 1 mm, 1.5 mm, 2 mm, 4 mm, 6 mm, 8 mm, 10 mm, 15 mm, 20 mm, 25 mm, 30 mm, 35 mm, 40 mm, 45 mm, 50 mm, 55 mm, or 60 mm above the target surface. The position may be any height between the aforementioned heights above the target surface (e.g., from about 0.1 mm to about 60 mm, from about 0.1 mm to about 10 mm, from about 5 mm to about 20 mm, or from about 15 mm to about 60 mm). The energy beam may graze the target surface. The horizontal position at which the energy beam transforms the material may correspond to a model of the 3D object (e.g., portions of a slice thereof).

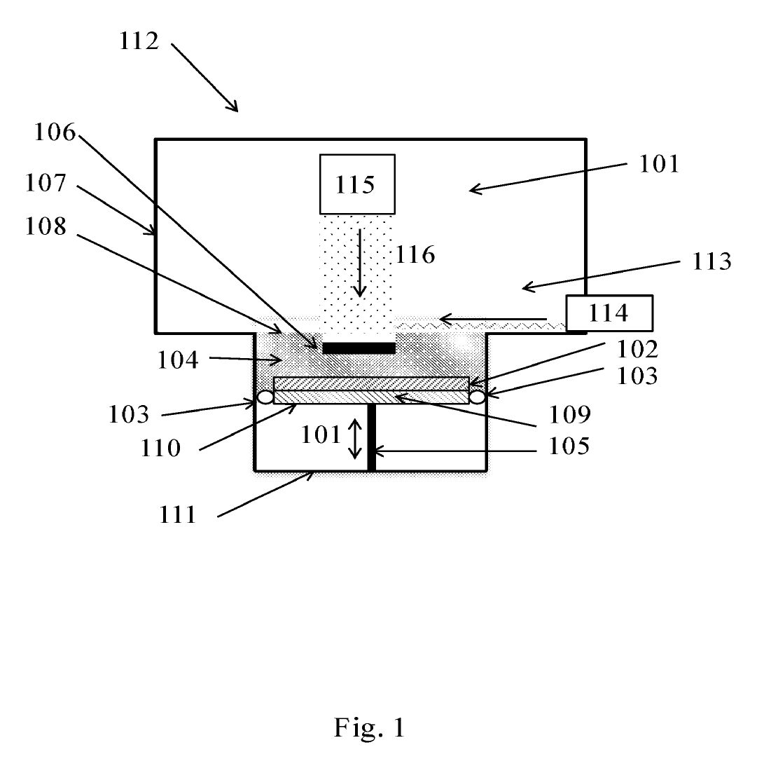

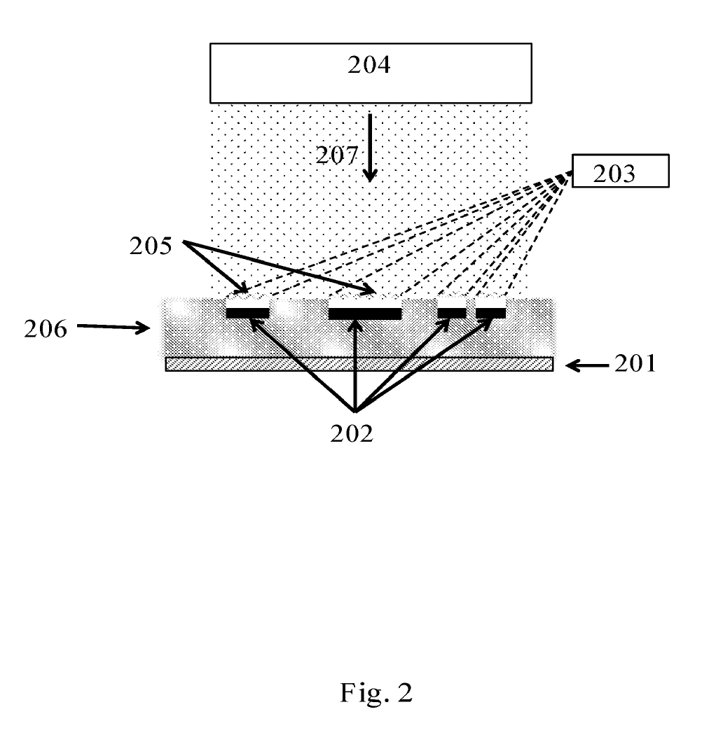

The transformation of the material may be effectuated by an energy source that emits an energy beam (e.g., an electromagnetic beam, or a charged particle beam) at specific positions of the material-fall (designated herein as the “material-fall energy beam”). FIG. 1 shows an example a powder dispenser 115 that dispenses a material-fall 116 within an enclosure 107. The material-falls towards the exposed surface 108 of a material bed 104 situated on a base 102, which is in turn situated on a substrate 109 that can be vertically translated by a vertical translator (e.g., a vertical actuator, or an elevator) 101. At times, an energy source 114 emits an energy beam at a position just above the target surface 108. The energy source can be located outside the enclosure, in the enclosure, or both in an out of the enclosure (e.g., transversing the enclosure wall as shown in the example in FIG. 1, 114). When the energy source is disposed outside of the enclosure, the emitted energy beam can travel into the enclosure though an optical window that (e.g., substantially) retains the characteristics of the energy beam (e.g., amplitude, power per unit area, focus, or cross section) as it travels though the optical window. At times, the energy beam transforms the material in the material-fall into a transformed material that hardens into a hardened material 106 that forms at least a portion of the generated 3D object. FIG. 2 shows an example of an energy source 203 that projects (e.g., generates) an energy beam which transforms the material in the material-fall 207 at designated locations (e.g., 205) to form transformed material that hardens into a hardened material 202, which forms layer portions of a generated 3D object. The designated locations can be transformed (e.g., substantially) simultaneously and/or sequentially. Sequential formation of additional layers may generate the desired 3D object. The energy beam may be projected in a direction away from the target surface. The energy beam may not intersect the target surface. The energy beam may be projected in a direction (e.g., substantially) parallel to the target surface. The energy beam may be projected at a grazing angle relative to the target surface.

The particulate material may be charged by a first type of polarity, while the target surface may be charged by an opposite charge polarity. The particulate material may be attracted to the target surface by an attractive force. The charge may include a magnetic or electrical charge. The attractive force may comprise gravitational, electrical, or magnetic force. The polarity may be negative or positive.

The particulate material may interact with the energy beam. For example, energy beam may heat up the particulate material. The heating may cause the particulate material to transform. The heat energy that is absorbed by the particulate material may dissipate slower as compared to the heat energy absorbed by the particulate material that is disposed on a target surface. The heat energy that is absorbed by the particulate material may dissipate slower as compared to a respective heat energy that is absorbed by the particulate material disposed in a material bed. The heat energy that is absorbed by the particulate material may dissipate slower as compared to a respective heat energy that is absorbed by the particulate material disposed adjacent to at least a portion of a 3D object. A layer of hardened material produced by the methods, systems, software, and/or apparatuses described herein may comprise a diminished amount of material stress, as compared to a respective layer produced by conventional 3D printing methodology. A layer of hardened material produced by the methods, systems, software, and/or apparatuses described herein may comprise a diminished amount of deformation, as compared to a respective layer produced by conventional 3D printing methodology.

The deformation may include geometric distortion. The deformation may include internal deformation. Internal may be within the 3D object or a portion thereof. The deformation may include a change in the material properties. The deformation may be disruptive (e.g., for the intended purpose of the 3D object). The deformation may comprise a geometric deformation. The deformation may comprise inconsistent material properties. The deformation may occur before, during, and/or after hardening of the transformed material. The deformation may comprise bending, warping, arching, curving, twisting, balling, cracking, bending, or dislocating. The deformation may comprise a deviation from a structural dimension or from a desired structureal and/or material characteristics.

The 3D objects produced using the methods, systems, software, and/or apparatuses described herein may generate a 3D object with diminished number of auxiliary supports, spaced-apart auxiliary supports, or without usage of auxiliary supports. In some examples, the diminished number of auxiliary supports or lack of one or more auxiliary support, will provide a 3D printing process that requires a smaller amount of material, produces a smaller amount of material waste, and/or requires smaller energy as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforesaid values (e.g., from about 1.1 to about 10, or from about 1.5 to about 5). The methods, systems, software, and/or apparatuses described herein may produce a 3D object portion at an accelerated rate. The 3D object generation rate may be at least about 0.01 cubic centimeter per second (cm³/sec), 0.03 cm³/sec, 0.05 cm³/sec, 0.08 cm³/sec, 0.1 cm³/sec, 0.3 cm³/sec, 0.5 cm³/sec, 0.8 cm³/sec, 1 cm³/sec, 1.5 cm³/sec, 2 cm³/sec 5 cm³/sec, 8 cm³/sec, 10 cm³/sec, or 15 cm³/sec. The 3D object generation rate may be at most about 15 cm³/sec, 10 cm³/sec, 8 cm³/sec, 5 cm³/sec, 2 cm³/sec, 1.5 cm³/sec, 1 cm³/sec, 0.8 cm³/sec, 0.5 cm³/sec, 0.3 cm³/sec, 0.1 cm³/sec, 0.08 cm³/sec, 0.05 cm³/sec, 0.03 cm³/sec, or 0.01 cm³/sec. The 3D object generation rate may be between any of the aforementioned values (e.g., from about 0.01 cm³/sec to about 15 cm³/sec, from about 0.01 cm³/sec to about 1 cm³/sec, from about 0.1 cm³/sec, to about 2 cm³/sec, from about 1 cm³/sec to about 10 cm³/sec, or from about 10 cm³/sec to about 15 cm³/sec).

The material-fall energy beam may scan the material-fall in a scanning velocity. The scanning may be by using a scanner. The scanning velocity may be at least about 1 meter per second (m/sec), 5 m/sec, 10 m/sec, 30 m/sec, 50 m/sec, 80 m/sec, 100 m/sec, 300 m/sec, 500 m/sec, 800 m/sec, 1000 m/sec, 2000 m/sec, or 4000 m/sec. The scanning velocity may be at most about 5000 m/sec, 4000 m/sec, 2000 m/sec, 1000 m/sec, 800 m/sec, 500 m/sec, 300 m/sec, 100 m/sec, 80 m/sec, 50 m/sec, 30 m/sec, 10 m/sec, 5 m/sec, or 1 m/sec. The scanning velocity may be any value between the aforementioned values (e.g., from about 1 m/sec to about 5000 m/sec, from about 1 m/sec to about 100 m/sec, from about 80 m/sec to about 500 m/sec, or from about 300 m/sec to about 1000 m/sec).

The velocity of the solid material that translates within the material-fall may be at least about 1 millimeter per second (mm/sec), 5 mm/sec, 10 mm/sec, 30 mm/sec, 50 mm/sec, 80 mm/sec, 100 mm/sec, 300 mm/sec, 500 mm/sec, 800 mm/sec, 1000 mm/sec, 5000 mm/sec, or 10000 mm/sec. The velocity of the solid material that translates within the material-fall may be at most about 10000 mm/sec, 5000 mm/sec, 1000 mm/sec, 800 mm/sec, 500 mm/sec, 300 mm/sec, 100 mm/sec, 80 mm/sec, 50 mm/sec, 30 mm/sec, 10 mm/sec, 5 mm/sec, or 1 mm/sec. The velocity of the solid material that translates within the material-fall may be any value between the aforementioned values (e.g., from 1 mm/sec to 10000 mm/sec, from 1 mm/sec to 100 mm/sec, from 80 mm/sec to 500 mm/sec, or from 300 mm/sec to 10000 mm/sec). The material-fall may translate across the length and/or width of the target surface. The energy beam and/or scanner may translate across the length and/or width of the target surface. The translation of the material-fall, energy beam, and/or scanner may be synchronized. The translation of the material-fall, energy beam, and/or scanner may be controlled (e.g., monitored, regulated, or modulated).

The material-fall energy beam (e.g., laser or electron beam) may be modulated. The modulation may comprise power modulation. The modulation may comprise a power threshold at or above which the solid material may be transformed by interaction with the material-fall energy beam, and below which the material may not be transformed when interacting with the material-fall energy beam. The energy beam may be modulated by a modulator (e.g., comprising a direct or an external modulator). The modulator can include an amplitude, phase, or polarization modulator. The modulation may alter the intensity of the energy beam. The modulation may alter the current supplied to the energy source (e.g., direct modulation). The modulation may affect the energy beam (e.g., external modulation such as, for example, an external light modulator). The modulation may include direct modulation (e.g., by a modulator). The modulation may include an external modulator. The modulator can include an aucusto-optic or an electro-optic modulator. The modulator can comprise an absorptive or a refractive modulator. The modulation may alter the absorption coefficient of the material that is used to modulate the energy beam. The modulator may alter the refractive index of the material that is used to modulate the energy beam.

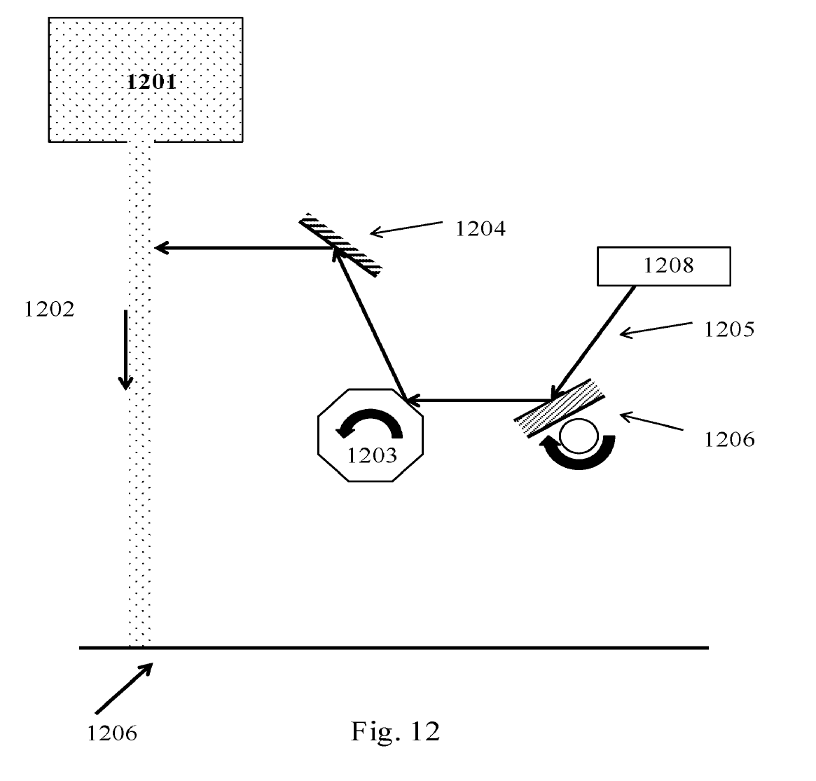

The energy source may comprise a laser diode or laser diode array. The energy source may comprise a fiber laser. The energy source may comprise a solid-state laser. The energy beam(s) and/or source(s) can be moved via a galvanometer scanner, a polygon a mechanical stage, or any combination of thereof. The scanner may comprise a galvanometer, electric motor, rotating polygon, voice coil, piezoelectric actuator, magnetostrictive actuator, acousto-optic deflector, or electro-optic deflector. The galvanometer may comprise resonant or servo-controlled galvanometer. The scanner may comprise one or more mirrors. The mirrors can comprise a polygon mirror (e.g., a rotating mirror polygon). The scanner may comprise a Risley prism, or an optical lens. FIG. 12 shows an example of an energy source 1208 projecting an energy-beam 1205 that travels towards the material-fall 1202 and is directed by various optical components such as an adjustment mirror (e.g., galvanometer) 1206, a scanning mirror (e.g., polygon) 1203, and a mirror 1204.

In some embodiments one or more energy beams may be directed to the material-fall. The direction may be effectuated by the one or more optical components. The energy beams may transform material within the material-fall prior to reaching the target surface. The energy beams may transform the material at (e.g., specific) locations sequentially and/or in parallel. The transformation of the pre-transformed (e.g., particulate) material may correspond to a model design of the 3D object. The material-fall may travel (e.g., laterally) at a constant speed or at a variable speed. At times, a small fraction of the material within the material-fall may be transformed. At times, none of the material within the material-fall may be transformed. At times, an (e.g., substantially) entire horizontal row of material within the material-fall may be transformed. At times, none of the material within the material-fall may be transformed. When a large portion of the material within the material-fall is being transformed, the material-fall may translate (e.g., laterally) at a speed that is slower than when a smaller portion of the material in the material-fall is being transformed. The (e.g., lateral) speed of the material-fall may relate to the amount of particulate material transformed within the material-fall. The (e.g., lateral) speed of the material-fall may be proportional to the amount of material transformed (e.g., at a fixed time or time-frame) within the material-fall. The (e.g., lateral) speed of the material-fall may be controlled manually and/or by a controller. The velocity of the material-fall may correlate to the model design of the 3D object (e.g., to a cross section of the 3D object).

The temperature of the particulate material may be controlled (e.g., heated, cooled, or maintained) before entering the material-fall, during its fall to the target surface (e.g., at the material-fall), or at the material bed. The temperature of the enclosure in which the 3D object is being generated can be controlled. The atmosphere within the enclosure can be controlled. The material bed can be controlled. The temperature of the forming 3D object may be controlled. A controller can effectuate the control. An energy (e.g., heat radiator or lamp) may radiate towards the target surface and cause the target surface to heat. An energy beam may scan the target surface and cause the target surface to heat at specified locations. The specified locations can be synchronized with the locations of the material-fall that is being or about to be transformed by the material-fall energy beam. The specified locations can be synchronized with the locations of the scanner of the material-fall energy beam. Heating the target surface may allow better adherence to the falling transformed material with the target surface. In some examples, the methods, apparatuses, software, and/or systems disclosed herein exclude compaction of the material (e.g., utilizing a compaction plate).

The temperature (e.g., average temperature) of the material bed may be controlled. The average temperature of the material bed may be (e.g., substantially) equal to an ambient, or room temperature. The average temperature of the material bed can be at most about 10° C. (degrees Celsius), 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed can be at least about 10° C., 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed can be any temperature between the afore-mentioned material average temperatures (e.g., from about 10° C. to about 2000° C., from about 10° C. to about 60° C., from about 10° C. to about 100° C., from about 10° C. to about 150° C., from about 10° C. to about 200° C., from about 10° C. to about 400° C., from about 400° C. to about 1000° C., or from about 1000° C. to about 2000° C.).

The enclosure (e.g., chamber) may comprise a gaseous environment (e.g., an atmosphere, FIG. 1, 101) comprising a gas. A gas flow may accelerate the velocity of the particulate material as it falls as part of the material-fall. The gas can comprise argon, nitrogen, helium, neon, krypton, xenon, hydrogen, carbon monoxide, or carbon dioxide. The pressure in the chamber can be at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, 1000 bar, or more. The pressure in the chamber can be at least 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, 1200 Torr. The pressure in the chamber can be at most 10⁻⁷ Torr, 10⁻⁶ Torr, 10⁻⁵ Torr, or 10⁻⁴ Torr, 10⁻³ Torr, 10⁻² Torr, 10⁻¹ Torr, 1 Torr, 10 Torr, 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at a range between any of the aforementioned pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). In some cases, the pressure in the chamber can be standard atmospheric pressure. In some examples, the chamber can be under vacuum pressure. At times, the pressure in the chamber may be (e.g., substantially) homogenous. At times, the pressure across the material bed may be (e.g., substantially) homogenous. The pressure in the chamber may exclude (e.g., substantial) pressure gradients (e.g., across the material bed)

The (e.g., particulate or hardened) material may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball or a carbon nanotube. The ceramic material may comprise cement. The ceramic material may comprise alumina. The material may comprise sand, glass, or stone. In some embodiments, the material may comprise an organic material, for example, a polymer or a resin. In some embodiments, the material may exclude an organic material. In some embodiments, the material may comprise an organic material, for example, a polymer or a resin. The polymer may comprise styrene. The organic material may comprise a hydrocarbon. The polymer may comprise styrene. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude organic material. The material may comprise a solid or a liquid. In some embodiments, the material may comprise a silicon-based material, for example, silicon based polymer or a resin. The material may comprise an organosilicon-based material. The material may comprise silicon and hydrogen atoms. The material may comprise silicon and carbon atoms. In some embodiments, the material may exclude a silicon-based material. The material may comprise a solid or a liquid. In some embodiments, the material is a solid. The solid material may comprise powder material. The powder material may be coated by a coating (e.g., organic coating such as the organic material (e.g., plastic coating)). The (e.g., particulate) material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) or wires.

The (e.g., particulate) material can comprise powder (e.g., granular material) or wires. The material may comprise an organic polymer that is infused with an additive, wherein the additive may comprise an elemental metal, metal alloy, ceramics, or an allotrope of elemental carbon. The additive may be of at least about 1%, 2%, 3%, 4%, 5%, 6%, 7%, 8%, 9%, 10%, 20%, 30%, 40%, or 50% of an average solid material particle (e.g., powder particle). The additive may be of at most about 50%, 40%, 30%, 20%, 10%, 9%, 8%, 7%, 6%, 5%, 4%, 3%, 2%, or 1% of an average solid material particle (e.g., powder particle). The additive may be of any value between the afore-mentioned percentage values (e.g., from about 1% to about 50%, from about 1% to about 30%, or from about 20% to about 50%). The percentages may be weight per weight percentages, or volume per volume percentages.

Three-dimensional printing (also “3D printing”) generally refers to a process for generating a 3D object. For example, 3D printing may refer to sequential addition of material layer or joining of material layers (or parts of material layers) to form a 3D structure, in a controlled manner. The controlled manner may include automated control. In the 3D printing process, the deposited material can be transformed to subsequently harden and form at least a part of the 3D object. Fusing, binding, or otherwise connecting the material is collectively referred to herein as transforming. Transforming may be of the particulate material (e.g., powder material). Fusing the material may include melting or sintering the material. Binding can comprise chemical bonding. Chemical bonding can comprise covalent bonding. Examples of 3D printing include additive printing (e.g., layer by layer printing, or additive manufacturing). 3D printing may include layered manufacturing. 3D printing may include rapid prototyping. 3D printing may include solid freeform fabrication. 3D printing may include direct material deposition. The 3D printing may further comprise subtractive printing. 3D printing methodologies can comprise extrusion, wire, granular, laminated, light polymerization, or power bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Power bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM).

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

The methods, apparatuses, and systems of the present disclosure can be used to form 3D objects for various uses and applications. Such uses and applications include, without limitation, electronics, components of electronics (e.g., casings), machines, parts of machines, tools, implants, prosthetics, fashion items, clothing, shoes, or jewelry. The implants may be directed (e.g., integrated) to a hard, a soft tissue, or a combination of hard and soft tissues. The implants may form adhesion with hard and/or soft tissue. The machines may include a motor or motor part. The machines may include a vehicle. The machines may comprise aerospace related machines. The machines may comprise airborne machines. The vehicle may include an airplane, drone, car, train, bicycle, boat, or shuttle (e.g., space shuttle). The machine may include a satellite or a missile. The uses and applications may include 3D objects relating to the industries and/or products listed herein.

A fundamental length scale is the diameter, spherical equivalent diameter, length, width, or diameter of a bounding sphere, and is abbreviated herein as “FLS.” The FLS of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object can be at most about 1000 m, 500 m, 100 m, 80 m, 50 m, 10 m, 5 m, 4 m, 3 m, 2 m, 1 m, 90 cm, 80 cm, 60 cm, 50 cm, 40 cm, 30 cm, 20 cm, 10 cm, or 5 cm. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

Particulate material may comprise solid, semi-solid, or liquid particles. Solid particulate material may comprise powder. Liquid particulate material may comprise droplets or vesicles. The term “powder,” as used herein, generally refers to a solid having fine particles. Powders may be granular materials. The particulate material may comprise particles that are microparticles. The particulate material may comprise particles that are nanoparticles. In some examples, a particulate material comprising particles having an average fundamental length scale (e.g., the diameter, spherical equivalent diameter, diameter of a bounding circle, or the largest of height, width and length) of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. The particulate material may comprise particles may have an average fundamental length scale of at most about 100 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, 1 μm, 500 nm, 400 nm, 300 nm, 200 nm, 100 nm, 50 nm, 40 nm, 30 nm, 20 nm, 10 nm, or 5 nm. In some cases, the powder may have an average fundamental length scale between any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm). The inventions disclosed herein are not limited to powder material, but may use any particulate material in place of the powder material, or in addition to the powder material. The particulate material may be solid (e.g., powder), semi-solid (e.g., gel), or liquid (e.g., vesicles comprising liquid).

The particulate material can be composed of individual particles. The individual particles can be spherical, oval, prismatic, cubic, or irregularly shaped. The particles can have a FLS. The powder can be composed of a homogenously shaped particle mixture such that all of the particles have substantially the same shape and FLS magnitude within at most 1%, 5%, 8%, 10%, 15%, 20%, 25%, 30%, 35%, 40%, 50%, 60%, or 70%, distribution of FLS. The powder can be a heterogeneous mixture such that the particles have variable shape and/or FLS magnitude.

In some examples the material (e.g., pre-transformed or transformed) comprises a material wherein its constituents (e.g., atoms or molecules) readily lose their outer shell electrons, resulting in a free flowing cloud of electrons within their otherwise solid arrangement. In some examples the material is characterized in having high electrical conductivity, low electrical resistivity, high thermal conductivity, or high density. The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the aforementioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the aforementioned electrical resistivity values (e.g., from about 1×10⁻⁵ Ω*m to about 1×10⁻⁸ Ω*m). The high thermal conductivity may be at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the aforementioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the aforementioned density values (e.g., from about 1 g/cm³ to about 25 g/cm³). The thermal conductivity, electrical resistivity, electrical conductivity, and/or density can be measured at ambient temperature (e.g., at R.T., or 20° C.).

A metallic material (e.g., elemental metal or metal alloy) can comprise small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (on the basis of weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (on the basis of weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

The materials of at least one layer in the powder bed may differ in the FLS of its powder particles from the FLS of the powder material within at least one other layer in the powder bed. A layer may comprise two or more material types at any combination. For example, two or more elemental metals, two or more metal alloys, two or more ceramics, two or more allotropes of elemental carbon. For example, an elemental metal and a metal alloy, an elemental metal and a ceramic, an elemental metal and an allotrope of elemental carbon, a metal alloy and a ceramic, a metal alloy and an allotrope of elemental carbon, a ceramic and an allotrope of elemental carbon. All the layers deposited during the 3D printing process may be of the same material composition. In some instances, a metal alloy is formed in situ during the process of transforming the powder material.

In some cases, the layers of different compositions are deposited (e.g., imaged, relocated, transferred, or placed) at a predetermined pattern. The pattern may correspond to a model design of the 3D object. For example, each layer can have composition that increases or decreases in a certain element, or in a certain material type. In some examples, each even layer may have one composition, and each odd layer may have another composition. The varied compositions of the layer may follow a mathematical series algorithm. In some cases, at least one area within a layer has a different material composition than another area within that layer. In some examples, each even numbered layer may have one type of electrical polarity, and each odd numbered layer may have a type of electrical polarity that is opposite to the one type of electrical polarity. In some instances, the opposite electrical polarities substantially cancel out the electrical charge in the powder bed. In some instances, the opposite electrical polarities reduce the accumulated electrical charge in the powder bed. In some instances, the material bed is electrically grounded. In some instances, the material bed is charged. In some examples, each even numbered layer may have one type of magnetic polarity, and each odd numbered layer may have a type of magnetic polarity that is opposite to the one type of magnetic polarity. In some instances, the opposite magnetic polarities substantially cancel out the magnetic charge in the powder bed. In some instances, the opposite magnetic polarities reduce the accumulated magnetic charge in the powder bed. In some instances, the material bed is not charged.

In some embodiments, the material is charged using a charging device. The charging device may comprise a corona discharge, charged particle gun, static charge device (e.g., charging roller), or a device generating an electrical potential difference. The charging device may charge the material bed. The charging device may charge the material within the material bed. The charging device may charge the exposed layer of the material bed. Alternatively or additionally, the structure supporting the material bed may be charged. For example, voltage can be applied to the structure supporting the material bed. The structure supporting the material bed may comprise a platform (e.g., base, substrate, or bottom of the enclosure). The charged particle gun may include an ion gun. The static charge device may include a charged surface.

In some instances, adjacent components in the material bed are separated from one another by one or more intervening layers. In an example, a first layer is adjacent to a second layer when the first layer is in direct contact with the second layer. In another example, a first layer is adjacent to a second layer when the first layer is separated from the second layer by at least one layer (e.g., a third layer). The intervening layer may be of any layer size disclosed herein.

The present disclosure provides systems, apparatuses, software, and/or methods for 3D printing of a 3D object from a particulate material. The 3D object can be pre-ordered, pre-designed, pre-modeled, or designed in real time (i.e., during the process of 3D printing). The 3D printing method can be an additive method in which a first layer is printed, and thereafter a volume of a material is added to the first layer as separate sequential layer (or parts thereof). Each additional sequential layer (or part thereof) can be added to the previous layer by transforming (e.g., fusing, e.g., melting) a fraction of the powder material and subsequently hardening the transformed material to form at least a portion of the 3D object. The hardening can be actively induced or can occur without intervention (e.g., naturally).

The particulate material can be chosen such that the material is the desired or otherwise predetermined material for the 3D object. In some cases, a layer of the 3D object comprises a single type of material. In some examples, a layer of the 3D object may comprise a single elemental metal type, or a single metal alloy type. In some examples, a layer within the 3D object may comprise several types of material (e.g., an elemental metal and an alloy, an alloy and ceramics, an alloy and an allotrope of elemental carbon). In certain embodiments each type of material comprises only a single member of that type. For example: a single member of elemental metal (e.g., iron), a single member of metal alloy (e.g., stainless steel), a single member of ceramic material (e.g., silicon carbide or tungsten carbide), or a single member (e.g., an allotrope) of elemental carbon (e.g., graphite). In some cases, a layer of the 3D object comprises more than one type of material. In some cases, a layer of the 3D object comprises more than one member of a material type.

The elemental metal can be an alkali metal, an alkaline earth metal, a transition metal, a rare earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare earth metal can be a lantanide, or an actinide. The lantinide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

The metal alloy can be an iron based alloy, nickel based alloy, cobalt based allow, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The metal (e.g., alloy or elemental) may comprise an alloy used for products for human or veterinary applications comprising implants, or prosthetics. The metal alloy may comprise an alloy used for applications in the fields comprising human or veterinary surgery, implants (e.g., dental), or prosthetics.

The alloy may include a superalloy. The alloy may include a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may include cast iron, or pig iron. The steel may include Bulat steel, Chromoly, Crucible steel, Damascus steel, Hadfield steel, High speed steel, HSLA steel, Maraging steel, Reynolds 531, Silicon steel, Spring steel, Stainless steel, Tool steel, Weathering steel, or Wootz steel. The high-speed steel may include Mushet steel. The stainless steel may include AL-6XN, Alloy 20, celestrium, marine grade stainless, Martensitic stainless steel, surgical stainless steel, or Zeron 100. The tool steel may include Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may include 316L, or 316LVM. The steel may include 17-4 Precipitation Hardening steel (also known as type 630, a chromium-copper precipitation hardening stainless steel, 17-4PH steel).

The titanium-based alloys may include alpha alloys, near alpha alloys, alpha and beta alloys, or beta alloys. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy includes Ti-6Al-4V or Ti-6Al-7Nb.

The Nickel alloy may include Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may include Nickel hydride, Stainless or Coin silver. The cobalt alloy may include Megallium, Stellite (e. g. Talonite), Ultimet, or Vitallium. The chromium alloy may include chromium hydroxide, or Nichrome.

The aluminum alloy may include AA-8000, Al—Li (aluminum-lithium), Alnico, Duralumin, Hiduminium, Kryron Magnalium, Nambe, Scandium-aluminum, or Y alloy. The magnesium alloy may be Elektron, Magnox, or T—Mg—Al—Zn (Bergman phase) alloy.

The copper alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may include Calamine brass, Chinese silver, Dutch metal, Gilding metal, Muntz metal, Pinchbeck, Prince's metal, or Tombac. The Bronze may include Aluminum bronze, Arsenical bronze, Bell metal, Florentine bronze, Guanin, Gunmetal, Glucydur, Phosphor bronze, Ormolu, or Speculum metal.

The particulate material within the material bed (e.g., powder) can be configured to provide support to the 3D object as it is formed in the material bed by the 3D printing process. For example, the supportive particulate material may be of the same type of particulate material from which the 3D object is generated, of a different type, or any combination thereof. In some instances, a low flowability particulate material can be capable of supporting a 3D object better than a high flowability particulate material. A low flowability particulate material can be achieved inter alia with a particulate material composed of relatively small particles, with particles of non-uniform size or with particles that attract each other. The particulate material may be of low, medium, or high flowability. The particulate material may have compressibility of at least about 1%, 2%, 3%, 4%, 5%, 6%, 7%, 8%, 9%, or 10% in response to an applied force of 15 kilo Pascals (kPa). The particulate material may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The particulate material may have basic flow energy of at least about 100 milli-Joule (mJ), 200 mJ, 300 mJ, 400 mJ, 450 mJ, 500 mJ, 550 mJ, 600 mJ, 650 mJ, 700 mJ, 750 mJ, 800 mJ, or 900 mJ. The powder may have basic flow energy of at most about 200 mJ, 300 mJ, 400 mJ, 450 mJ, 500 mJ, 550 mJ, 600 mJ, 650 mJ, 700 mJ, 750 mJ, 800 mJ, 900 mJ, or 1000 mJ. The particulate material may have basic flow energy in between the above listed values of basic flow energy (e.g., from about 100 mj to about 1000 mJ, from about 100 mj to about 600 mJ, or from about 500 mj to about 1000 mJ). The particulate material may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The powder may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The particulate material may have a specific energy in between any of the above values of specific energy (e.g., from about 1.0 mJ/g to about 5.0 mJ/g, from about 3.0 mJ/g to about 5 mJ/g, or from about 1.0 mJ/g to about 3.5 mJ/g).

The 3D object can have one or more auxiliary features. The auxiliary feature(s) can be supported by the material bed. The term “auxiliary features,” as used herein, generally refers to features that are part of a printed 3D object, but are not part of the desired, intended, designed, ordered, modeled, or final 3D object. Auxiliary features (e.g., auxiliary supports) may provide structural support during and/or subsequent to the formation of the 3D object. Auxiliary features may enable the removal or energy from the 3D object that is being formed. Examples of auxiliary features comprise heat fins, anchors, handles, supports, pillars, columns, frame, footing, scaffold, flange, projection, protrusion, mold (a.k.a. mould), or other stabilization features. In some instances, the auxiliary support is a scaffold that encloses the 3D object or part thereof. The scaffold may comprise lightly sintered or lightly fused particulate material. The 3D object can have auxiliary features that can be supported by the material bed (e.g., powder bed) and not touch the base, substrate, container accommodating the material bed, or the bottom of the enclosure. The 3D part (3D object) in a complete or partially formed state can be completely supported by the material bed (e.g., without touching the substrate, base, container accommodating the powder bed, or enclosure). The 3D object in a complete or partially formed state can be completely supported by the powder bed (e.g., without touching anything except the powder bed). The 3D object in a complete or partially formed state can be suspended in the powder bed without resting on any additional support structures. In some cases, the 3D object in a complete or partially formed (i.e., nascent) state can float in the material bed.

In some embodiments, the generated 3D object may be generated with the accuracy of at least about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm as compared to a model of the 3D object (e.g., the desired 3D object). The generated 3D object may be generated with the accuracy of at most about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm as compared to a model of the 3D object. As compared to a model of the 3D object, the generated 3D object may be generated with the accuracy of any accuracy value between the aforementioned values (e.g., from about 5 μm to about 100 μm, from about 15 μm to about 35 μm, from about 100 μm to about 1500 μm, from about 5 μm to about 1500 μm, or from about 400 μm to about 600 μm).

The 3D object can have various surface roughness profiles, which may be suitable for various applications. The surface roughness may be the deviations in the direction of the normal vector of a real surface, from its ideal form. The surface roughness may be measured as the arithmetic average of the roughness profile (hereinafter “Ra”). The 3D object can have a Ra value of at least about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The formed object can have a Ra value of at most about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The 3D object can have a Ra value between any of the aforementioned Ra values (e.g., from about 30 nm to about 50 μm, from about 5 μm to about 40 μm, from about 3 μm to about 30 μm, from about 10 nm to about 50 μm, or from about 15 nm to about 80 μm). The Ra values may be measured by a contact or by a non-contact method. The Ra values may be measured by microscopy method. The microscopy method may comprise ultrasound or nuclear magnetic resonance. The microscopy method may comprise optical microscopy. The microscopy method may comprise electromagnetic, electron, or proximal probe microscopy. The electron microscopy may comprise scanning, tunneling, X-ray photo-, or Auger electron microscopy. The electromagnetic microscopy may comprise confocal, stereoscope, or compound microscopy. The proximal probe microscopy may comprise atomic force, or scanning tunneling microscopy, or any other microscopy described herein. The roughness measurement may include using Lambert's emission law when evaluating the optical measurements. The Ra values may comprise measuring by a roughness tester and/or by a microscopy method (e.g., any microscopy method described herein). The measurements may be conducted at ambient temperatures (e.g., R.T.). The roughness may be measured by a contact or by a non-contact method. The roughness measurement may comprise one or more sensors (e.g., optical sensors). The roughness measurement may comprise a metrological measurement device (e.g., using metrological sensor(s)). The roughness may be measured using an electromagnetic beam (e.g., visible or IR).

The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the aforementioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

The 3D object may be composed of successive layers (e.g., successive cross sections) of solid material that originated from a transformed material (e.g., fused, bound or otherwise connected powder material), and subsequently hardened. The transformed material may be connected to a hardened (e.g., solidified) material. The hardened material may reside within the same layer, or in another layer (e.g., a previous layer). In some examples, the hardened material comprises disconnected parts of the 3D object, which are subsequently connected by the newly transformed material (e.g., by fusing, binding or otherwise connecting a powder material).

A cross section (e.g., vertical cross section) of the generated (i.e., formed) 3D object may reveal a microstructure or a grain structure indicative of a layered deposition. Without wishing to be bound to theory, the microstructure or grain structure may arise due to the solidification of transformed material that is typical to and/or indicative of the 3D printing method. For example, a cross section may reveal a microstructure resembling ripples or waves that are indicative of solidified melt pools that may be formed during the 3D printing process. The repetitive layered structure of the solidified melt pools may reveal the orientation at which the part was printed. The cross section may reveal a substantially repetitive microstructure or grain structure. The microstructure or grain structure may comprise substantially repetitive variations in material composition, grain orientation, material density, degree of compound segregation or of element segregation to grain boundaries, material phase, metallurgical phase, crystal phase, crystal structure, material porosity, or any combination thereof. The microstructure or grain structure may comprise substantially repetitive solidification of layered melt pools. The substantially repetitive microstructure may have an average layer size of at least about 0.5 μm, 1 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, or 500 μm. The substantially repetitive microstructure may have an average layer size of at most about 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, or 10 μm. The substantially repetitive microstructure may have an average layer size of any value between the aforementioned values of layer size (e.g., from about 0.5 μm to about 500 μm, from about 15 μm to about 50 μm, from about 5 μm to about 150 μm, from about 20 μm to about 100 μm, or from about 10 μm to about 80 μm).

The printed 3D object may be printed without the use of one or more auxiliary features, may be printed using a reduced amount of auxiliary features, or printed using spaced apart auxiliary features. The single auxiliary feature (e.g., auxiliary support or auxiliary structure) may be a platform (e.g., a base or substrate), or a mold. The auxiliary support may be adhered to the platform, or mold. The 3D object may be devoid of an auxiliary support (e.g., during its 3D printing). The two or more auxiliary features may be spaced apart by a spacing distance of at least 1.5 millimeters (mm), 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features may be spaced apart by a spacing distance of at most 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features may be spaced apart by a spacing distance of any value between the aforementioned auxiliary support space values (e.g., from 1.5 mm to 500 mm, from 2 mm to 100 mm, from 15 mm to 50 mm, or from 45 mm to 200 mm). Collectively referred to herein as the “auxiliary feature spacing distance.”

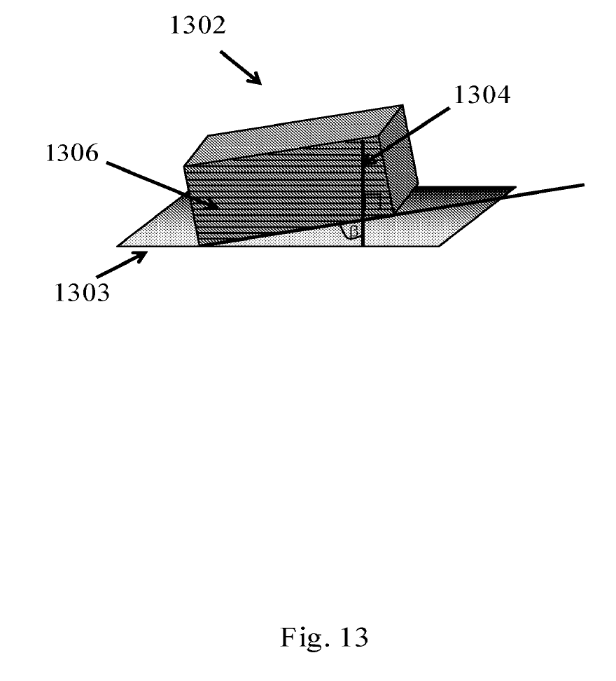

The layered structure can have a layering plane. FIG. 13 shows a schematic example of a 3D object 1302 having a layering structure (e.g., comprising layer 1306). In one example, two auxiliary support features present in the 3D object may be spaced apart by the auxiliary feature spacing distance. The acute (i.e., sharp) angle alpha between the straight line connecting the two auxiliary supports and the direction of normal to the layering plane may be at least about 45 degrees (°), 50°, 55°, 60°, 65°, 70°, 75°, 80°, or 85°. The acute angle alpha between the straight line connecting the two auxiliary supports and the direction of normal to the layering plane may be at most about 90°, 85°, 80°, 75°, 70°, 65°, 60°, 55°, 50°, or 45°. The acute angle alpha between the straight line connecting the two auxiliary supports and the direction of normal to the layering plane may be any angle range between the aforementioned angles (e.g., from about 45 degrees)(°, to about 90°, from about 60° to about 90°, from about 75° to about 90°, from about 80° to about 90°, from about 85° to about 90°). The acute angle alpha between the straight line connecting the two auxiliary supports and the direction normal to the layering plane may from about 87° to about 90°. The two auxiliary supports can be on the same surface. The same surface can be an external surface or an internal surface (e.g., a surface of a cavity within the 3D object). When the angle between the shortest straight line connecting the two auxiliary supports and the direction of normal to the layering plane is greater than 90 degrees, one can consider the complementary acute angle. In some embodiments, any two auxiliary supports are spaced apart by the auxiliary feature spacing distance.

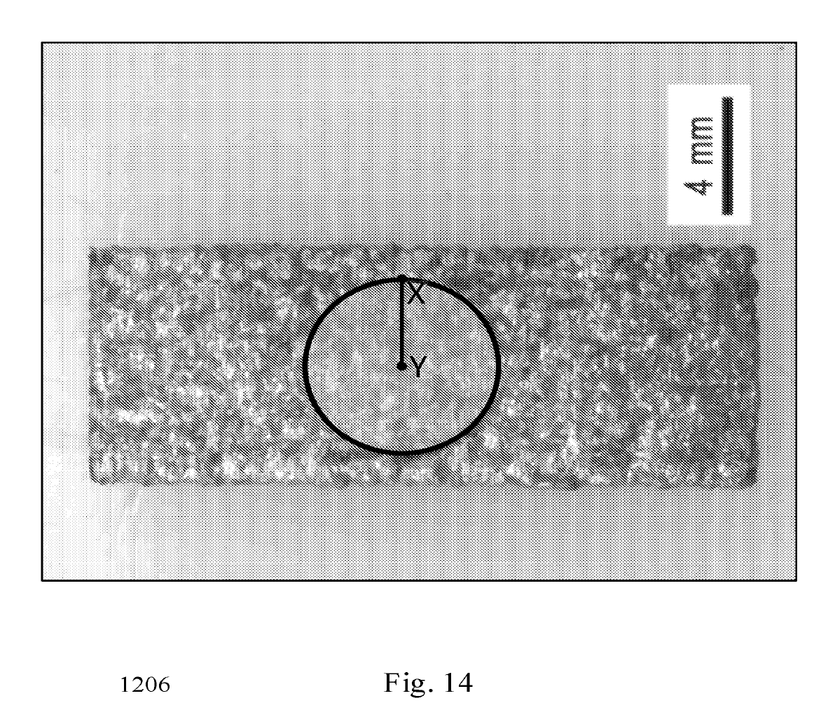

The 3D object may comprise a layering plane N of the layered structure (e.g., FIG. 13, 1306). The 3D object may comprise points X and Y (e.g., FIG. 14), which reside on the surface of the 3D object, wherein X is spaced apart from Y by at least about 10.5 millimeters or more. In some embodiments, X is spaced apart from Y by the auxiliary feature spacing distance. A sphere of radius XY that is centered at X lacks one or more auxiliary supports that are indicative of a presence or removal of the one or more auxiliary support features. The acute angle between the straight line XY and the direction normal to the layering plane may be of the value of the acute angle alpha. When the angle between the straight line XY and the direction of normal to N is greater than 90 degrees, one can consider the complementary acute angle. The layer structure may comprise any material(s) used for 3D printing described herein. Each layer of the 3D structure can be made of a single material or of multiple materials. Sometimes one part of the layer may comprise one material, and another part may comprise a second material different than the first material. A layer of the 3D object may be composed of a composite material. The 3D object may be composed of a composite material. The 3D object may comprise a functionally graded material. At times, the area of an intersecting sphere of radius XY with an exposed surface of the 3D object is devoid of auxiliary support. FIG. 14 shows an example of a top view of a 3D object that has an exposed surface. The exposed surface includes an intersection area of a sphere having a radius XY, which intersection area is devoid of auxiliary support. The value of the radius XY may be any value of the auxiliary feature spacing distance.

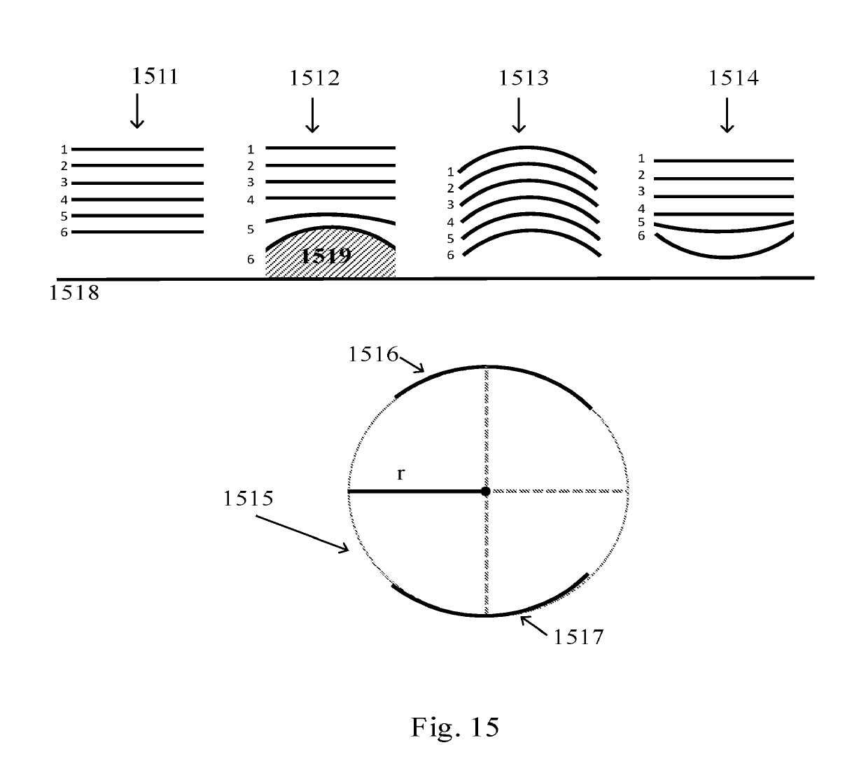

The one or more layers within the 3D object may be (e.g., substantially) planar (e.g., FIG. 15, 1511). The one or more layers within the 3D object may be (e.g., substantially) flat. The (e.g., substantially) planar one or more layers may have a large radius of curvature. The one or more layers may have a radius of curvature equal to the surface radius of curvature. The surface radius of curvature may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The surface radius of curvature may have a value of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The surface radius of curvature may have any value between any of the afore-mentioned values of the radius of curvature (e.g., from about 10 cm to about 90 m, from about 50 cm to about 10 m, from about 5 cm to about 1 m, from about 50 cm to about 5 m, or from about 40 cm to about 50 m). In some examples, the one or more layers may be included in a planar section of the 3D object, or may be a planar 3D object. In some instances, part of at least one layer within the 3D object has the radius of curvature mentioned herein. The radius of curvature may be measured by optical microscopy, electron microscopy, confocal microscopy, atomic force microscopy, speedometer, caliber (e.g., vernier caliber), positive lens, interferometer, or laser (e.g., tracker). The radius of curvature may be measured by a microscopy method described herein.

The radius of curvature, “r,” of a curve at a point can be a measure of the radius of the circular arc (e.g., FIG. 15, 1516) which best approximates the curve at that point. The radius of curvature can be the inverse of the curvature. In the case of a 3D curve (also herein a “space curve”), the radius of curvature may be the length of the curvature vector. The curvature vector can comprise of a curvature (e.g., the inverse of the radius of curvature) having a particular direction. For example, the particular direction can be the direction towards the platform (e.g., designated herein as negative curvature), or away from the platform (e.g., designated herein as positive curvature). For example, the particular direction can be the direction towards the direction of the gravitational field (e.g., designated herein as negative curvature), or opposite to the direction of the gravitational field (e.g., designated herein as positive curvature). A curve (also herein a “curved line”) can be an object similar to a line that is not required to be straight. A straight line can be a special case of curved line wherein the curvature is (e.g., substantially) zero. A line of substantially zero curvature has a (e.g., substantially) infinite radius of curvature. A curve can be in two dimensions (e.g., vertical cross section of a plane), or in three-dimension (e.g., curvature of a plane). The curve may represent a cross section of a curved plane. A straight line may represent a cross section of a flat (e.g., planar) plane. FIG. 15 shows an example of a vertical cross section of a 3D object 1512 comprising planar layers (layers numbers 1-4) and non-planar layers (e.g., layers numbers 5-6) that have a radius of curvature. FIGS. 15, 1516 and 1517 are super-positions of curved layer on a circle 1515 having a radius of curvature “r.” The one or more layers may have a radius of curvature equal to the radius of curvature of the layer surface.

Any apparatus, member, mechanism, system, and/or device disclosed herein, as well as any part thereof may comprise a socket and/or a communication port. The apparatus, member, mechanism, and/or system disclosed herein may comprise a screen, a keyboard, and/or a printer. The apparatus, member, mechanism, and/or system may comprise Bluethooth technology. The communication port may be a serial port or a parallel port. The communication port may be a Universal Serial Bus port (i.e., USB). The apparatus, member, mechanism, and/or system may comprise USB ports. The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The mechanism may comprise a plug and/or a socket (e.g., electrical, AC power, DC power). The apparatus, member, mechanism, and/or system may comprise an adapter (e.g., AC and/or DC power adapter). The apparatus, member, mechanism, and/or system may comprise a power and/or data connector. The connector can be an electrical power connector. The connector may comprise a magnetically attached connector. The connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

The method, apparatus and systems disclosed herein may enable printing two or more materials in a single layer of a 3D object by scanning the target surface with a first material-fall comprising a first material, transforming the first material in a first pattern; and then scanning the target surface with a second material-fall comprising a second material, and transforming the second material in a second pattern.

In one aspect disclosed herein are methods, systems, software and apparatuses for printing a particulate material (e.g., a powder) for multiple-material printing (e.g., in order to form functionally graded material), and/or for material selective printing by utilizing the material selectivity (e.g. selectivity to absorption or melting at a certain temperature).

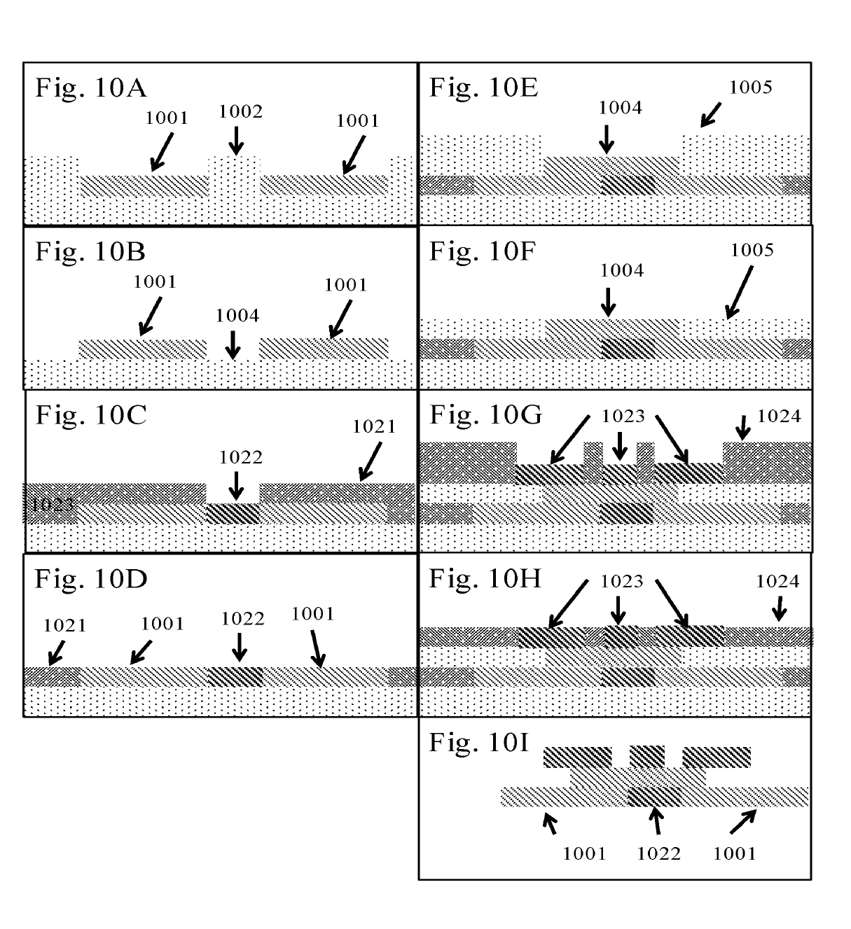

In an embodiment, the methods, systems, and/or apparatuses described herein may effectuate multiple material printing (e.g., 3D printing). FIGS. 10A-10I show examples of multiple material printing. A material-fall may comprise a first type of material as it translates along the target surface (e.g., laterally) in a first direction. As the material-fall translates in the first direction, the first material may translate (e.g., fall) to the target surface, and form a transformed material at (e.g., specific) locations (e.g., as it interacts with the energy beam at designated locations), which transformed material subsequently hardens into a hardened material (e.g., FIG. 10A, 1001). A newly deposited particulate material of the first type, which did not transform during the first translation (e.g., FIG. 10A, 1002), may be removed from the material bed (e.g., using a material removal mechanism; FIG. 10B, 1004). The material-fall may comprise a second type of particulate material as it translates (e.g., laterally) along the target surface in a second translation. A second particulate material type may be deposited onto the material bed as the material-fall translates (e.g., laterally) in the second translation. Since the non-transformed material of the first type is removed, the second deposited material can be situated in (e.g., substantially) the same horizontal level as the transformed first material (e.g., that subsequently hardens into a hardened material to form at least a portion of the layer within the 3D object). The second material type can be transformed (e.g., and subsequently harden) as the material-fall translates in the second translation (e.g., FIG. 10C, 1022). The transformed material of the second type of material can adhere (e.g., laterally) to the first hardened material, thus forming a planar layer of hardened material comprising a first and a second material (e.g., FIG. 10D, 1001 and 1022), as at least a portion of the 3D object (e.g., the 3D object shown in FIG. 101). A remainder particulate material is depicted in FIGS. 10C and 10D, numbered 1021, which did not transform to form a portion of the 3D object. This method may allow formation of composite and/or functionally graded materials. The process can be repeated. An example of a repetition of the above process can be shown in FIGS. 10E-10I.

In some embodiments, the methods, systems, software, and/or apparatuses may effectuate material selective printing (e.g., 3D printing). The second material may not transform into a transformed material of a second type as it deposits into the material bed (e.g., during the second translation of the material beam). For example, the second material type may comprise a higher melting point, a different energy absorption coefficient, or any combination thereof, as compared to the first material type. The second non-transformed material may support the 3D object as it is generated in the material bed. The non-transformed material may be subsequently removed by a material removal mechanism.

A material dispensing mechanism may produce the material-fall. For example, a powder plotter having a powder dispensing mechanism akin to an ink-jet plotter may produce the material-fall. The material dispensing mechanism may comprise a powder dispenser (e.g., a hopper, or a recoater).

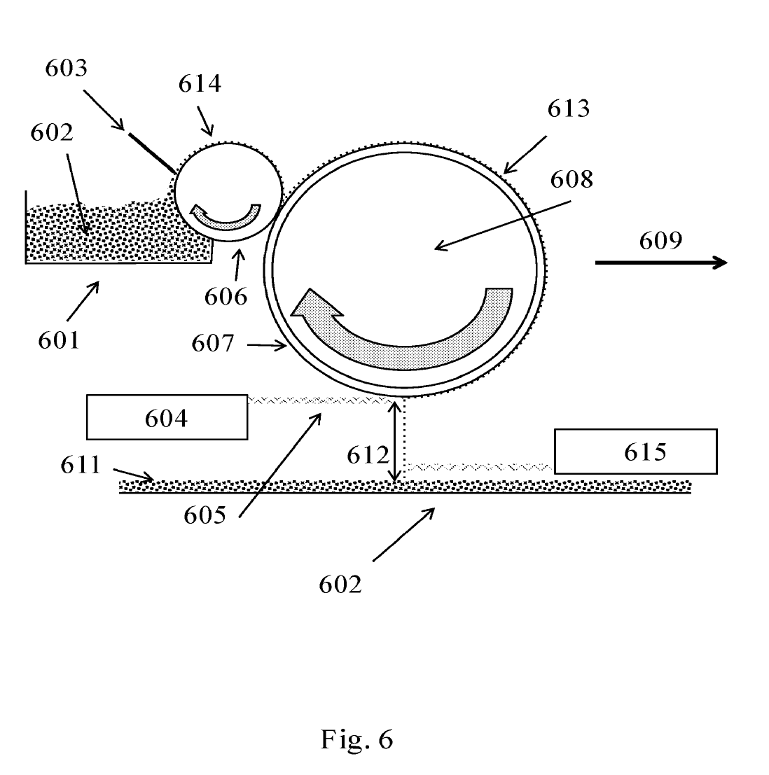

In some embodiments, the material dispensing mechanism may comprise a material reservoir, and a source surface disposed on an item (e.g., a drum). The item may revolve. The item (e.g., drum, roller, or cylinder) may revolve at a speed of at least 5 revolutions per minute (rev/min), 10 rev/min, 15 rev/min, 20 rev/min, 25 rev/min, 30 rev/min, 40 rev/min, or 50 rev/min. The item may revolve at a speed between any of the aforementioned speeds (e.g., from about 5 rev/min to about 50 rev/min, from about 5 rev/min to about 30 rev/min, from about 10 rev/min to about 40 rev/min, or from about 10 rev/min to about 50 rev/min). The item may translate. The translation speed may be (e.g., substantially) equal to the scanning speed values disclosed herein. In some instances, the material dispensing mechanism may further comprise an intermediate surface. The intermediate surface can be disposed (e.g., situated) between the material reservoir and the source surface. FIG. 6, shows an example of a material dispensing mechanism comprising a material reservoir 601 and two items (e.g., cylinders): the first item including the source surface 607, and the second item including the intermediate surface 606. The item may comprise a charged side. The item may comprise a charged interior (e.g., an electrical and/or magnetically charged interior such as, for example, a metal). For example, FIG. 6, 608 points to the interior of an item. The source surface may be photoconductive. The source surface may comprise a photoelectric polymer. An energy beam (e.g., a laser) may alter the charge of the photoconductive surface in a certain position on the item. The chargeable particulate material (e.g., metal powder) may selectively adhere to the source surface, depending on its charge. For example, the particulate (e.g., solid) material may be charged in a first type of charge polarity (e.g., electrical or magnetic). The source surface may be charged in a second type of charge polarity type that is opposite to the first charge polarity type. The target surface may be charged by the second type of charge polarity type, but with a larger magnitude. The particulate material (charged with the first type of charge polarity), will be attracted more to the target surface than to the source surface, and detach itself from the source surface.

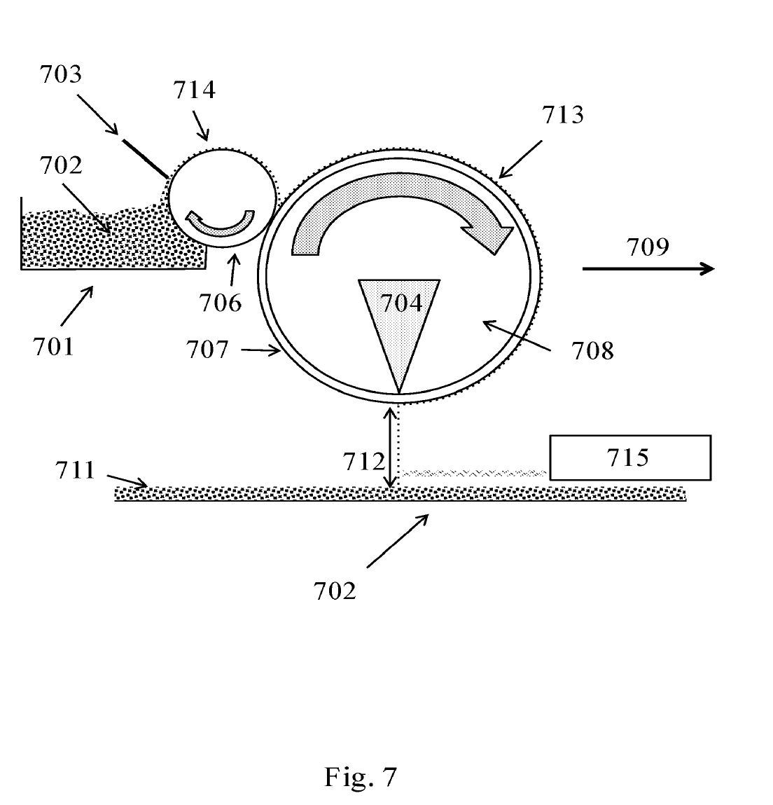

The particulate material may adhere to the source surface. For example, FIG. 6, 613 shows an example of a particulate material (e.g., powder) that adheres to the source surface of a cylinder. The particulate material may detach from the source surface at a desired location. The detachment can be effectuated by a first energy beam that alters the adhesion of the charged material to the source surface. The detachment may be effectuated by a force that repels the attached particulate material from the source surface. In an example, a first energy beam may cause the source surface to change its electrical charge such that the solid material is no longer attracted to the source surface, and falls onto the target surface (e.g., via gravitational fall). For example, the energy beam may discharge the charge of (or on) the source surface. FIG. 6, 604 shows an example of an energy source that projects an energy beam 605 that is projected at a desired position on the source surface (e.g., photoconductive surface), and thus alters its electrical charge at that (e.g., desired) position to cause a disruption in the adherence (e.g., cause a repulsion) between the charge and the source surface at that position. The first energy beam (e.g., laser) may be projected at a substantially constant position or travel along a path on the source surface (e.g., along a line). In another example, at least one electrode may cause repulsion of the solid material from the source surface. FIG. 7, 704 shows an example of a repelling electrode. The repelling electrode may comprise a blade or a point that generates a repelling charge at its end (e.g., tip) position adjacent to the source surface. The end position points to the desired position from which the material-fall initiates. The methods, systems and/or apparatuses disclosed herein may further comprise a second energy source projecting a second energy beam that causes the material within the material-fall to transform. FIG. 6, 615 and FIG. 7, 715 show examples of the second (material-transforming) energy source.

The source surface may (e.g., horizontally) span the entire length of the target surface. The source surface may travel (e.g., laterally) along the width of the target surface. FIG. 9 shows an example of the length and width of the target surface 904.

The material can be disposed in the material bed using a material dispensing mechanism. The material dispensing mechanism may comprise a laser material printer (e.g., laser powder printer). FIGS. 6-7 show example of material dispensing mechanisms comprising a laser material printer. FIG. 6, 612 shows an example of a gap between the material dispensing mechanism and the target surface 611. For example, a material dispensing mechanism may be used to deposit a controlled amount of material in a certain location on the target surface (e.g., an exposed surface of a powder bed, or platform). The material dispensing mechanism may deposit the particulate material (e.g., powder) without contacting the target surface (e.g., the exposed surface of the material bed). Any height variation from planarity of the target surface may be evaluated using one or more calculations, algorithms, sensors, software, or any combination thereof. The particulate material may flow down using a force such as gravity, electrical, magnetic, pressure (e.g., pneumatic), or any combination thereof.

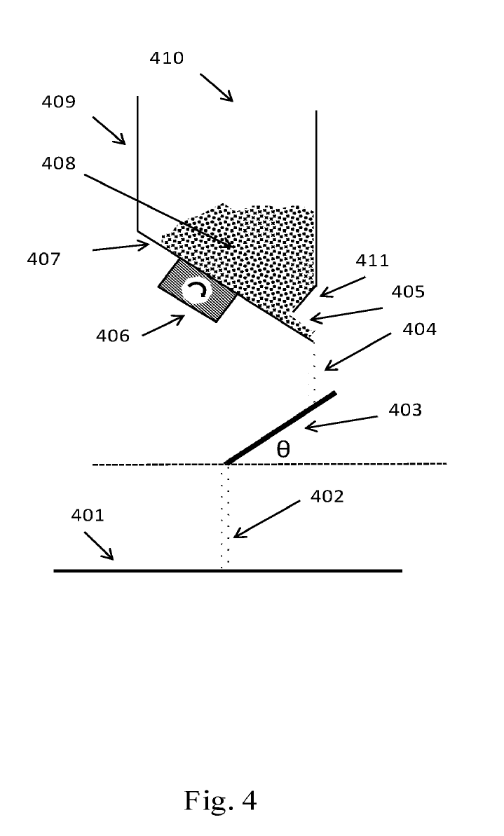

The material dispensing mechanism (e.g., powder dispenser) may comprise a material reservoir (e.g., FIG. 6, 601). The material dispensing mechanism may comprise an exit opening port for the particulate material. The exit opening port may be situated on the face of the material dispenser that points towards the target surface, or away from the target surface (e.g., directly away). The exit opening port may be situated on the face of the material dispenser that does neither point toward the target surface, not points away from the target surface (e.g., is situated at the side of the dispenser). The exit opening port may be situated at the top, bottom, or side of the material dispenser. The material dispenser may comprise a hopper. The bottom of the material dispenser as understood herein is the face of the material dispenser that points towards the bottom of the enclosure (e.g., towards the platform, target surface, and/or the material bed). The material dispenser by be referred herein as “material feeder.” The powder dispenser by be referred herein as “powder feeder.” The material dispensing mechanism may comprise a top opening from which the particulate material is being removed (e.g., by an intermediate surface, or a source surface). The material dispenser may comprise a reservoir comprising a top opening (e.g., exit opening port). The material dispensing mechanism (e.g., material dispenser) may comprise a slanted plane that is external to the material reservoir. FIG. 4 shows an example of a powder dispenser 410 comprising a side opening 405 and a slated plane 403 that is external to the powder reservoir 408. The slanted plane may comprise a rough surface on which the material is dispensed after exiting from the exit opening port. The slanted plane may be disposed adjacent the material exit opening port. The slanted plane may be disposed below the material exit opening port. The slanted plane may be disposed between the exit opening port and the source surface. The exit opening port may comprise an obstruction. The obstruction may include a mesh. The material dispensing member may comprise an electrical field potential. The material dispensing member may comprise an apparatus that injects into the particulate material a charge density (e.g., magnetic or electric). The material dispenser may be stationary. The material dispenser may be movable (e.g., vertically, horizontally, and/or at an angle). The material dispenser may be movable relative to the source surface, intermediate surface, and/or target surface. The material dispenser may be stationary relative to the source surface, intermediate surface, and/or target surface. The apparatuses, systems, mechanisms, and/or members disclosed herein may be translated at a constant or varied velocity. The one or more material-falls may be translated (e.g., laterally) at a constant or varied velocity. The one or more material-falls may be (e.g., horizontally and/or vertically) accelerated. The (e.g., lateral) velocity of the material-fall may be adjustable (e.g., by a controller). The movement (e.g., horizontal and/or vertical) of the material-fall may be controlled manually and/or by a controller. The movement (e.g., translation) of the material-fall may be programmed (e.g., using a software). The movement may comprise a direction, velocity, and/or acceleration of the movement. The movement of the material-fall may depend on a model design of the 3D object. The movement of the material-fall may be dependent on the adherence of the transformed material to a previously formed 3D object or part thereof.

The material dispensing member may comprise one or more material fluidization members. The material fluidization members may include gas openings, stirrers, shakers (e.g., vortex shaker), vibrators, or any combination thereof. The material fluidization member may cause isolated particles of particulate material (e.g., powder) to separate from each other. The material dispensing member may comprise one or more gas openings (e.g., tubes, or nozzles). The material fluidization member may comprise one or more gas openings (e.g., tubes, or nozzles). The material fluidization member may comprise one or more mixing members (e.g., mixing blades, magnetic stirrers, and/or mechanical stirrers). The material fluidization member may comprise one or more vibrators, or shakers. The material dispensing member may comprise a magnetic material. The material dispensing member may comprise an elemental metal, a polymer, a metal alloy, a ceramic, an organic polymer, a resin, or an allotrope of elemental carbon. The material fluidization members may comprise a rod (e.g., shaking rod, vibrating rod, and/or stirring rod). In some examples, the particulate material within the material dispenser is fluidized to dispersion. The dispersion may be substantially homogenous. In some examples, the particulate material within the material dispenser does not form dispersion. The dispersion may be a mixture of the particulate material (e.g., powder) and one or more gases.

The systems, methods, software and/or apparatuses disclosed herein may comprise and/or use one or more sensors (at least one sensor). The sensor can detect one or more characteristics of the material-fall. The characteristics can include amount of particulate material per unit area, vertical velocity of falling material within the material-fall, width of the material-fall, lateral velocity of the material-fall, cross-section of the material-fall at various planes (e.g., target plane), trajectory of the particulate material-falling in the material-fall, or deviation from ideal trajectory of the falling material within the material-fall. The sensors can detect the temperature at various positions within the material-fall (e.g., temperature of the particulate material and/or the transformed material). The sensors can detect the temperature at the target surface. For example, the sensors can detect the temperature of the hardened material at the target surface. The sensor can detect the topology of the target surface (e.g., the exposes surface of the material bed). The sensor can detect the amount of material deposited on the target surface. For example, the sensor can detect the amount of particulate material deposited on the exposes surface of a material bed. The sensor can detect the physical state of material deposited on the target surface. The sensor can detect the crystallinity and/or the density of material deposited on the target surface. The sensor can detect the amount of material transformed. The sensor can detect the temperature of the material. For example, the sensor may detect the temperature of the particulate material in a material dispensing mechanism, within various positions in the material-fall, at the target surface, or any combination thereof. The sensor may detect the temperature of the material during its transfer to the target surface. The sensor may detect the temperature and/or pressure of the atmosphere within an enclosure (e.g., a chamber) in which the material-fall is disposed. The sensor may detect the temperature of the material (e.g., powder) bed. The sensor may detect the homogeneity of the temperature and/or pressure within the enclosure and/or within the material bed.

The at least one sensor can be operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, or proximity sensor. The sensor may include temperature sensor, weight sensor, powder level sensor, gas sensor, or humidity sensor. The gas sensor may sense any of the gas delineated herein. The temperature sensor may comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, or Pyrometer. The pressure sensor may comprise Barograph, Barometer, Boost gauge, Bourdon gauge, hot filament ionization gauge, Ionization gauge, McLeod gauge, Oscillating U-tube, Permanent Downhole Gauge, Piezometer, Pirani gauge, Pressure sensor, Pressure gauge, tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the material bed can be monitored by one or more weight sensors in, or adjacent to, the material. For example, a weight sensor in the material bed can be at the bottom of the material bed. The weight sensor can be between the bottom of the enclosure and the substrate on which the base or the material bed may be disposed. The weight sensor can be between the bottom of the enclosure and the base on which the material bed may be disposed. The weight sensor can be between the bottom of the enclosure and the material bed. A weight sensor can comprise a pressure sensor. The weight sensor may comprise a spring scale, a hydraulic scale, a pneumatic scale, or a balance. At least a portion of the pressure sensor can be exposed on a bottom surface of the material bed. In some cases, the weight sensor can comprise a button load cell. The button load cell can sense pressure from powder adjacent to the load cell. In another example, one or more sensors (e.g., optical sensors or optical level sensors) can be provided adjacent to the material bed such as above, below, or to the side of the material bed. In some examples, the one or more sensors can sense the powder level. The material (e.g., powder) level sensor can be in communication with a material dispensing system (also referred to herein as powder dispensing member, or powder dispensing mechanism). Alternatively, or additionally a sensor can be configured to monitor the weight of the material bed by monitoring a weight of a structure that contains the material bed. One or more position sensors (e.g., height sensors) can measure the height of the material bed relative to the substrate. The position sensors can be optical sensors. The position sensors can determine a distance between one or more energy sources (e.g., a laser or an electron beam.) and a surface of the material (e.g., powder). The one or more sensors may be connected to a control system (e.g., to a processor, to a computer).

The methods, systems, software and/or apparatuses can comprise a first and second energy source. In some cases, the system can comprise three, four, five, or more energy sources. FIG. 6 shows an example of a system comprising two energy sources 615 and 604. The system can comprise an array of energy sources. In some cases, the system can comprise a third energy source. The energy source can interact with at least a portion of the particulate material within the material-fall. FIG. 6 shows an example an energy beam emitted from energy source 615 and interacts with the material-fall 612. FIG. 1 shows an example an energy beam emitted from energy source 114 and interacts with the material-fall 116. The energy beam can interact with at least a portion of the material in the material bed. The energy beam can heat the material before during and/or after the material interacts with the source surface, reaches the material-fall, and/or reaches the material bed. The energy beam can heat at least a fraction of a 3D object at any point during formation of the 3D object. Alternatively or additionally, the material bed may be heated by a heating member comprising a lamp, a strip heater (e.g., mica strip heater), a heating rod, or a radiator (e.g., a panel radiator).

In some cases, the system can have a single (e.g., first) energy source. An energy source can be a source configured to deliver energy to an area (e.g., a confined area). An energy source can deliver energy to the confined area through radiative heat transfer. The energy beam may include a radiation comprising an electromagnetic, or charge particle beam. The energy beam may include a radiation comprising electromagnetic, electron, positron, proton, plasma, or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy source may include a laser source. The laser source may comprise a Nd:YAG, Neodymium (e.g., neodymium-glass), or an Ytterbium laser. The energy source may include an electron gun. The energy source may include an energy source capable of delivering energy to a point or to an area. In some embodiments the energy source can be a laser. In an example a laser can provide light energy at a peak wavelength of at least about 100 nanometer (nm), 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). An energy beam can be incident on, or be directed to, the material-fall, the source surface (e.g., photoconductive surface), the target surface (e.g., the top surface of the powder bed), or any combination thereof. In some examples, the energy beam can be directed substantially perpendicular to the average plane of the material-fall. The energy beam can be directed at the average plane of the material-fall at an angle. The acute angle formed by energy beam and the average plane of the material-fall may be at least about 1°, 5°, 10°, 20°, 30°, 40°, 50°, 60°, 70°, 80°, or 90°. The acute angle formed by energy beam and the average plane of the material-fall may be at most about 1°, 5°, 10°, 20°, 30°, 40°, 50°, 60°, 70°, 80°, or 90°. The acute angle formed by energy beam and the average plane of the material-fall may be any angle between the aforementioned angles (e.g., from about 1° to about 90°, from about 30° to about 90°, from about 80° to about 90°, or from about 70° to about 90°).

In some embodiments, the 3D printer may comprise an element that absorbs and/or disperses the energy beam (referred to herein as the “energy beam dump”). For example, the 3D printer may comprise an optical energy beam dump. The energy beam dump may reduce any reflection, scattering, and/or dissipation of heat generated by absorption of the energy beam. The energy beam dump may comprise a cloth or paper (e.g., a velvet or flock paper glued onto a (e.g., stiff) backing). The energy beam dump may comprise a 3D plane. The energy beam dump may comprise deep, or dark cavities lined with an absorbing material to dump the energy beam. The energy beam dump may comprise a stack of razor blades (e.g., having sharp edges facing the beam). The energy beam dump may comprise deep and/or dark cavities from which little energy (e.g., light) escapes. The energy beam dump may comprise a cone (e.g., of aluminum). The cone may be disposed in an enclosure (e.g., a can or a box). The cone may have a diameter greater than the cross section of the energy beam. The energy beam dump may comprise an absorber that abosrbs the energy beam. The absorber may comprise a liquid (e.g., water). The absorber may comprise a color (e.g., colored salt such as copper(II) sulfate. The liquid may circulate and/or cooled. The energy beam dump may be cooled (e.g., using a heat exchanger).

The methods, systems, software and/or apparatuses disclosed herein may comprise at least one energy source. In some cases, the system can comprise two, three, four, five, or more energy sources. The system can comprise an array of energy sources. An energy beam from the first and/or second energy source can be incident on, or be directed perpendicular to, the target surface. The energy beam can be directed onto a specified area of the material-fall for a specified time period. The material in the material-fall can absorb the energy from the energy beam and, and as a result, a localized region of the solid material can increase in temperature. The energy beam can be moveable such that it can translate relative to the material-fall. In some instances, the energy source may be movable such that it can translate relative to the target surface. The energy beam(s) and/or source(s) can be moved via a scanner (e.g., as disclosed herein). The energy sources can be movable with the same scanner. The energy beams can be movable with the same scanner. The energy source(s) and/or beam(s) can be translated independently of each other. In some cases, the energy source(s) and/or beam(s) can be translated at different rates (e.g., velocities). At times, the energy source(s) and/or beam(s) can be comprise at least one different characteristic. The characteristics may comprise wavelength, power, amplitude, trajectory, footprint, intensity, energy, or charge. The charge can be electrical and/or magnetic charge.

The energy beam can be directed to a specified area (e.g., of the material-fall), for a specified time period. The particulate material in the material-fall can absorb the energy from the energy source (e.g., energy beam, radiator or lamp) and, and as a result, a localized region of the material can increase in temperature. The energy source and/or beam can be moveable such that it can translate relative to the material-fall, to the target surface, to the source surface, or any combination thereof. In some instances, the energy source may be movable such that it can translate relative to the top surface of the material bed, relative to the side surface of the material-fall, and/or to the source (e.g., photoconductive) surface. The energy beam(s) and/or source(s) can be moved via a scanner, a polygon, a mechanical stage, or any combination of thereof. The galvanometer may comprise a mirror. The scanner may comprise a modulator. The scanner may comprise a polygonal mirror. The scanner can be the same scanner for two or more energy sources and/or beams. Each energy source and/or beam may have a separate scanner. The energy sources can be translated independently of each other. In some cases, at least two energy sources and/or beams can be translated at different rates. For example, the movement of the first energy source may be faster as compared to the movement of the second energy source. The systems and/or apparatuses disclosed herein may comprise one or more shutters (e.g., safety shutters).

The material-fall can have a (e.g., substantially) cuboid shape. The length of the cuboid may span the length of the building chamber (e.g., the length of the target surface). The length of the cuboid may be at least about 10 mm, 30 mm, 50 mm, 100 mm, 300 mm, 500 mm, 1000 mm, 2500 mm, or 5000 m. The length of the cuboid may be at most about 5000 mm, 2500 mm, 1000 mm, 500 mm, 300 mm, 100 mm, 50 mm, 30 mm, or 10 mm. The length of the cuboid may be any value between the aforementioned values (e.g., from about 10 mm to about 300 mm, or from about 100 mm to about 5000 mm). The height of the cuboid may be at least about 1 mm, 10 mm, 50 cm, 100 cm, 500 cm, or 1000 cm. The height of the cuboid may be at most about 1000 cm, 500 cm, 100 cm, 50 cm, 10 cm, or 1 cm. The height of the cuboid may be any value between the aforementioned values (e.g., from about 1 mm to about 1000 cm, or from about 10 cm to about 100 cm). The material-fall may be situated in a gap formed between an exit port of a powder dispensing mechanism, and a target surface. The gap may be adjustable. The vertical distance of the gap may be the height of the cuboid. The width of the cuboid may be about the average FLS (e.g., the diameter, spherical equivalent diameter, diameter of a bounding circle, or largest of height, width and length) of particles of the solid material. The width of the cuboid may be about the average FLS (e.g., diameter or diameter equivalent) of particles of the solid material. The width of the cuboid may be at least about 0.01 mm, 0.03 mm, 0.05 mm, 0.1 mm, 0.2 mm, 0.3 mm, 1 mm, 10 μm, 20 μm, 30 μm, 40 μm, 50 μm, 60 μm, 70 μm, 80 μm, 90 μm, or 100 μm. The width of the cuboid may be at most about 100 μm, 9 μm, 80 μm, 70 μm, 60 μm, 50 μm, 4 μm, 30 μm, 2 μm, 10 μm μm, 0.5 mm, 0.3 mm, 0.2 mm, 0.1 mm, 0.05 mm, 0.03 mm, or 0.01 mm. The width of the cuboid may be any value between the aforementioned values (e.g., from about 0.01 μm to about 100 μm, 0.01 μm to about 2 μm, or from about 1 μm to about 50 μm). At times, the material-fall may comprise two material-falls. In some examples, the material-fall that is generated from the exit of the material dispensing mechanism may be narrowed in at least one dimension. For example, the material-fall at its exits from the powder dispensing mechanism may have a width, or a length that may be reduced before the material reaches the target surface. One or more lenses may narrow the material-fall. The lenses may comprise a pneumatic, electrostatic, or magnetic lens. The lenses may comprise a mechanical lens (e.g., funnel). For example, the mechanical lens may comprise one or more slated surfaces. The mechanical lens may comprise one or more parallel planes. The mechanical lens may direct the flow of the material to the target surface. The mechanical lens may comprise an aperture. The mechanical lens may comprise a slit (e.g., which is a type of an opening port) through which particles may flow (e.g., fall) though. The mechanical lens may comprise a directive path. The mechanical lens may comprise a restrictive opening (e.g., which is a type of an opening port). The restrictive opening may prevent diverging particles from reaching the target surface. The restrictive opening may comprise an aperture. The lens may collimate, disperse, or densify the trajectories of the solid material within the material-fall. The lens may focus, blur, narrow, or broaden the cross-section of the material-fall on the target surface.

The lens may comprise an aperture. The lens(es) may be an electrostatic or magnetic lens. The lens may induce, exhibit, form, or cast an electric field. The lens may induce a voltage. The lens may induce, exhibit, form, or cast a magnetic field. The lens may direct the movement of one or more charged particles. The lens may exhibit (or form) an electric and/or magnetic field. The lens may include cylindrical, quadropole, multipole, or Einzel lens. The lens(es) may induce movement, and/or acceleration of the charged particle. The lens(es) may induce a change in the energy, and/or trajectory of the charged particle. The lens(es) may preserve the energy and/or trajectory of the charged particle. The lens(es) may deter movement and/or acceleration of the charged particle. The lens(es) may induce alteration of the electric and/or magnetic field adjacent to the lens. The lens may comprise a doughnut shaped lens. The lens may comprise a curvature. The lens may comprise a non-curved section. At times, the lens may be non-curved. At times, the lens may be curved. The lens may comprise a plane. The lens may comprise one, two, or more electrodes. The electrode may form a constant field or a pulsing field. The field may be generated by a direct or alternating current. A pulsing current may generate the field. The electrodes may produce an electric arc (i.e., an arc discharge). The electrodes may be electrically and/or magnetically opaque.

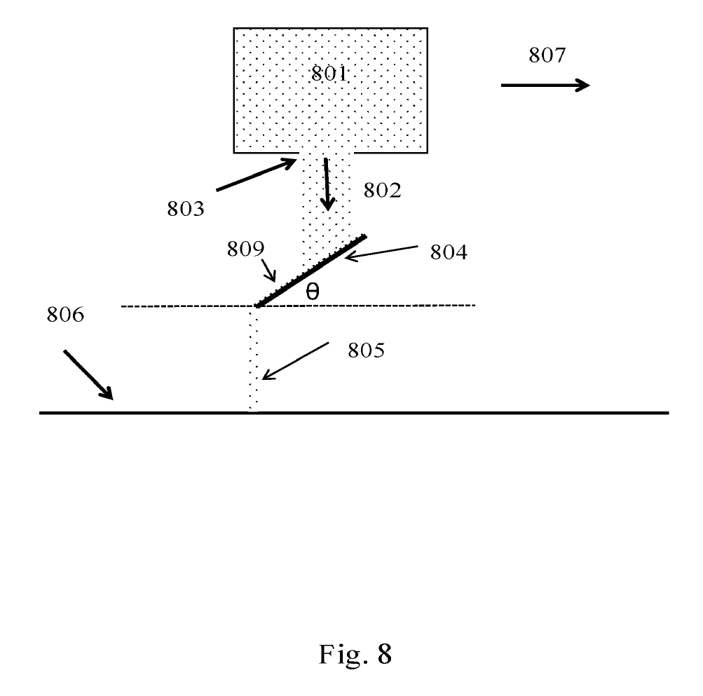

FIG. 8 shows an example of two material-falls (e.g., 802 and 805). The material-falls may influence each other or flow independent of each other. The material-falls may be connected or disconnected. FIG. 8 shows an example of two material-falls that influence each other, for example, a lack of particulate material in the first material-fall 802, will cause a (e.g., subsequent) lack of particulate material in the second material-fall 805. In that sense, for example, the material-falls 802 and 805 are connected. The particulate material may exit the material dispensing mechanism onto one or more slanted surfaces. FIG. 8 and FIG. 4 show an example of powder dispensing mechanisms including slated surfaces (e.g., FIG. 4, 403 and FIG. 8, 804). The slanted surface may form an acute angle theta (“e”) with the average target surface plane. The slanted (e.g., angled, skewed, sloped, or oblique) surface may constitute a mechanical lens. The angle of the slanted surface may be adjustable (e.g., before, during and/or after the 3D printing). The top surface of the slanted surface may comprise flat or rough portions. The top surface of the slanted surface may comprise extrusions and/or depressions. The depressions and/or extrusions may be random or follow a pattern. The top exposed surface of the slanted surface may be blasted (e.g., by any blasting method disclosed herein). The top exposed surface (e.g., 809) of the slanted surface (e.g., 804) may be formed by sanding with a sand paper. The sand paper may be of at most about 24 grit, 30 grit, 36 grit, 40 grit, 50 grit, 60 grit, 70 grit, 80 grit, 90 grit, 100 grit, 120 grit, 140 grit, 150 grit, 160 grit, 180 grit, 200 grit, 220 grit, 240 grit, 300 grit, 360 grit, 400 grit, 600 grit, 800 grit, or 1000 grit. The sand paper may be of at least 24 grit, 30 grit, 36 grit, 40 grit, 50 grit, 60 grit, 70 grit, 80 grit, 90 grit, 100 grit, 120 grit, 140 grit, 150 grit, 160 grit, 180 grit, 200 grit, 220 grit, 240 grit, 300 grit, 360 grit, 400 grit, 600 grit, 800 grit, or 1000 grit. The sand paper may be a sand paper between any of the afore mentioned grit values (e.g., from about 60 grit to about 400 grit, from about 20 grit to about 300 grit, from about 100 grit to about 600 grit, or from about 20 grit to about 1000 grit). The roughness of the top surface of the slanted surface may be equivalent to the roughness of the sand paper. The roughness of the top surface of the slanted surface may be equivalent to a roughness of a treatment with the sand paper mentioned herein. Top is in the direction opposite to the gravitational center, and/or the platform. The slanted surface (e.g., plane) and the body of the material dispensing mechanism (e.g., reservoir 801) may be of the same type of material or of different types of materials. The slanted surface may comprise a rougher material than the one substantially composing the body of the material dispensing mechanism. The slanted surface may comprise a denser material than the one substantially composing the body of the material dispensing mechanism. The slanted surface may comprise a harder (e.g., less bendable) material than the one substantially composing the body of the material dispensing mechanism. For example, the body of the material dispensing mechanism may be made of a light metal (e.g., aluminum), while the slanted surface may be made of steel or a steel alloy. The slanted surface may be mounted, while the body of the material dispensing mechanism may vibrate or bend. The particulate material may dispense out of the exit opening (e.g., port) of the material dispensing mechanism reservoir (e.g., FIG. 8, 803), and may travel downwards using the gravitational force (e.g., 802), contact the slanted surface (e.g., 804) as it falls, optionally bounce off the slanted surface, and continue its downward fall (e.g., 805) to the target surface (e.g., 806). In some embodiments, as the material exits the material dispensing mechanism (e.g., FIG. 4, 405) to the environment of the enclosure (e.g., chamber) and travels in a (e.g., substantially) vertical direction towards the target surface (e.g., FIG. 4, 401) (e.g., travels down towards the material bed), it encounters at least one obstruction. The obstruction can be a surface (e.g., FIG. 4, 403). The surface can be stationary or moving (e.g., a conveyor). The surface can be rough or smooth. The obstruction comprises a rough surface. The obstruction can be one or more slanted surfaces that form an angle with the target surface. The angle can be any of the theta angles described herein. Theta may be at least about 5°, 10°, 15°, 20°, 30°, 40°, 50°, 60°, 70°, or 80°. Theta may be at most about 5°, 10°, 15, ° 20°, 30°, 40°, 50°, 60°, 70°, or 80°. Theta may be of any value between the afore-mentioned degree values for gamma and/or delta (e.g., from about 5° to about, 80°, from about 5° to about, 40°, or from about 40° to about, 80°).

Although FIG. 8 shows two material-falls, various numbers and configurations of materials falls may be used. For example, at least 1, 2, 3, 4, 5, 6, 7, 8, 9, 10, 20, 30, 40, 50, or 100 material-falls may be used. The material-falls may be aligned or offset along a horizontal axis. In some embodiments, two or more material-falls (e.g., a material-fall array) may span the width or length of the build chamber (e.g., target surface). For example, at least 2, 3, 4, 5, 6, 7, 8, 9, or 10 material-falls may span the width or length of the build chamber. For example, at most 10, 9, 8, 7, 6, 5, 4, 3, or 2 material-falls may span the width or length of the build chamber. Each material-fall may be associated with its own actuator, and/or scanner. Each scanner may be associated with its own respective material-fall energy beam. In some embodiments, one scanner is associated with two or more material-falls. In some embodiments, one material-fall energy beam is associated with two or more scanners. The use of a material-fall array may reduce the time required to build a layer of hardened material that forms at least a portion of the 3D object.

FIG. 1 depicts an example of a system that can be used to generate a 3D object using a 3D printing process disclosed herein. The system can include an enclosure (e.g., a chamber 112). At least a fraction of the components in the system can be enclosed in the chamber. At least a fraction of the chamber can be filled with a gas to create a gaseous environment (i.e., an atmosphere). The gas can comprise an inert gas. The chamber can be filled with another gas or mixture of gases. The gas can be a non-reactive gas (e.g., an inert gas). The gaseous environment can comprise argon, nitrogen, helium, neon, krypton, xenon, hydrogen, carbon monoxide, or carbon dioxide. In some cases, the pressure in the chamber can be standard atmospheric pressure. In some examples, the chamber can be under vacuum pressure, or positive pressure (e.g., as disclosed herein).

The chamber can comprise two or more gaseous layers. The gaseous layers can be separated by molecular weight or density such that a first gas with a first molecular weight or density is located closer to the target surface, and a second gas with a second molecular weight or density is located in a second region of the chamber more distant than the target surface (e.g., substantially above a layer of the first gas). The first molecular weight or density may be smaller than the second molecular weight or density. The first molecular weight or density may be larger than the second molecular weight or density. The gaseous layers can be separated by temperature. The first gas can be in a lower region of the chamber relative to the second gas. The second gas and the first gas can be in adjacent locations. The second gas can be on top of, over, and/or above the first gas. In some cases, the first gas can be argon and the second gas can be helium. The molecular weight or density of the first gas can be at least about 1.5*, 2*, 3*, 4*, 5*, 10*, 15*, 20*, 25*, 30*, 35*, 40*, 50*, 55*, 60*, 70*, 75*, 80*, 90*, 100*, 200*, 300*, 400*, or 500* larger or greater than the molecular weight or density of the second gas. “*” used herein designates the mathematical operation “times,” or “multiplied by.” The molecular weight of the first gas can be higher than the molecular weight of air. The molecular weight or density of the first gas can be higher than the molecular weight or density of oxygen gas (e.g., O₂). The molecular weight or density of the first gas can be higher than the molecular weight or density of nitrogen gas (e.g., N₂). At times, the molecular weight or density of the first gas may be lower than that of oxygen gas or nitrogen gas.

The first gas with the relatively higher molecular weight or density can fill a region of the system where at least a fraction of the powder is stored. The second gas with the relatively lower molecular weight or density can fill a region of the system where the 3D object is formed. The material layer can be supported on a substrate (e.g., 109). The substrate can have a circular, rectangular, square, or irregularly shaped cross-section. The substrate may comprise a base disposed above the substrate. The substrate may comprise a base (e.g., 102) disposed between the substrate and a material layer (or a space to be occupied by a material layer). A thermal control unit (e.g., a cooling member such as a heat sink or a cooling plate, a heating plate, or a thermostat) can be provided inside of the region where the 3D object is formed or adjacent to the region where the 3D object is formed. The thermal control unit can be provided outside of the region where the 3D object is formed (e.g., at a predetermined distance). In some cases, the thermal control unit can form at least one section of a boundary region where the 3D object is formed (e.g., the container accommodating the powder bed).

The concentration of oxygen in the enclosure (e.g., chamber) can be minimized. The concentration of oxygen or humidity in the chamber can be maintained below a predetermined threshold value. For example, the gas composition of the chamber can contain a level of oxygen or humidity that is at most about 100 parts per billion (ppb), 10 ppb, 1 ppb, 0.1 ppb, 0.01 ppb, 0.001 ppb, 100 parts per million (ppm), 10 ppm, 1 ppm, 0.1 ppm, 0.01 ppm, or 0.001 ppm. The gas composition of the chamber can contain an oxygen or humidity level between any of the aforementioned values (e.g., from about 100 ppb to about 0.001 ppm, from about 1 ppb to about 0.01 ppm, or from about 1 ppm to about 0.1 ppm). In some cases, the chamber can be opened at the completion of a formation of a 3D object. When the chamber is opened, ambient air containing oxygen and/or humidity can enter the chamber. Exposure of one or more components inside of the chamber to air can be reduced by, for example, flowing an inert gas while the chamber is open (e.g., to prevent entry of ambient air), or by flowing a heavy gas (e.g., argon) that rests on the surface of the powder bed. In some cases, components that absorb oxygen and/or water on to their surface(s) can be sealed while the chamber is open.

The chamber can be configured such that gas inside of the chamber has a relatively low leak rate from the chamber to an environment outside of the chamber. In some cases, the leak rate can be at most about 100 milliTorr/minute (mTorr/min), 50 mTorr/min, 25 mTorr/min, 15 mTorr/min, 10 mTorr/min, 5 mTorr/min, 1 mTorr/min, 0.5 mTorr/min, 0.1 mTorr/min, 0.05 mTorr/min, 0.01 mTorr/min, 0.005 mTorr/min, 0.001 mTorr/min, 0.0005 mTorr/min, or 0.0001 mTorr/min. The leak rate may be between any of the aforementioned leak rates (e.g., from about 0.0001 mTorr/min to about, 100 mTorr/min, from about 1 mTorr/min to about, 100 mTorr/min, or from about 1 mTorr/min to about, 100 mTorr/min. The enclosure can be sealed such that the leak rate of gas from inside the chamber to an environment outside of the chamber is low. The seals can comprise O-rings, rubber seals, metal seals, load-locks, or bellows on a piston. In some cases, the chamber can have a controller configured to detect leaks above a specified leak rate (e.g., by using a sensor). The sensor may be coupled to a controller. In some instances, the controller is able to identify a leak by detecting a decrease in pressure in side of the chamber over a given time interval.

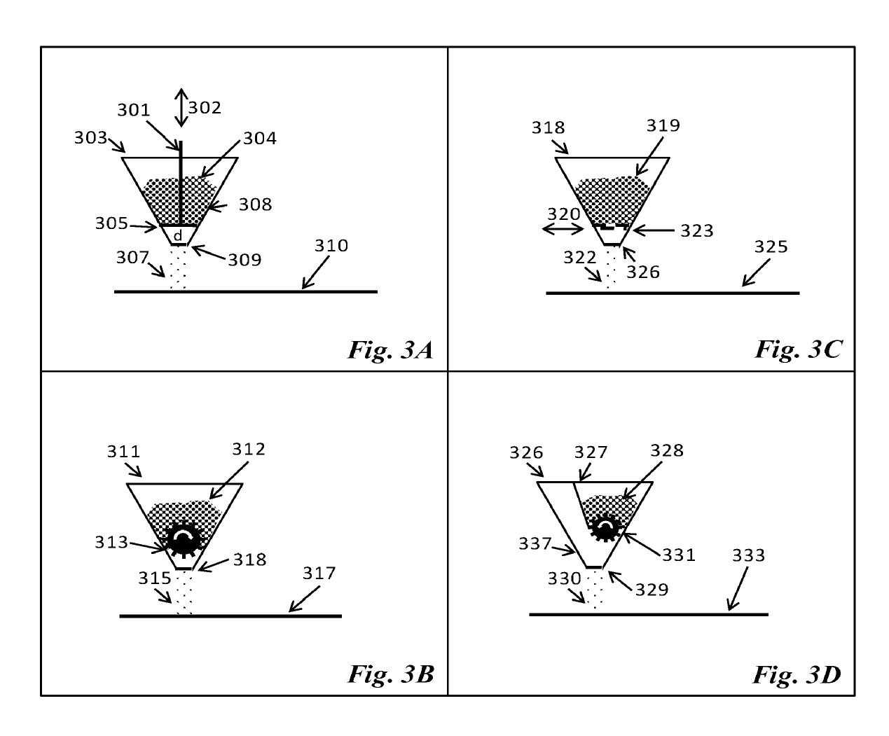

In some embodiments, the material dispensing mechanism dispenses the material onto the source surface. Examples for material (e.g., powder) dispensing mechanisms are shown in FIGS. 3-6. The material dispensing mechanism can dispense particulate material (e.g., powder) onto the target surface. Dispensing onto the target surface can be direct. The material dispensing mechanism can dispense particulate material (e.g., powder) directly onto the source surface. The material dispensing mechanism can dispense material (e.g., powder) indirectly onto the source surface (e.g., by using an intermediate surface). The intermediate surface and/or the source surface can comprise a planar surface, or a curved surface. The planar surface may comprise a slanted surface. FIG. 4 shows an example of a material dispensing mechanism 410 that dispenses particulate material onto an intermediate slanted surface 403, from which the particulate material dispenses onto the target surface 401. In some embodiments, the intermediate surface is an integral part of the material dispensing mechanism. The intermediate surface can be separate from the material dispensing mechanism. FIG. 6 shows an example of a material dispensing mechanism that dispenses particulate material onto an intermediate curved surface 606, from which the particulate material dispenses onto a source surface 607, and from which it is dispensed onto the target surface 611 forming a material-fall spanning the gap 612.

Other material dispensing mechanism may form the material-fall. For example, FIGS. 3A-3D schematically depict vertical side cross sections of various mechanisms for dispensing the material. FIG. 3A depicts a material dispenser 303 situated above the target surface 310. FIG. 3B depicts a material dispenser 311 situated above the target surface 317. FIG. 3C depicts a material dispenser 318 situated above the target surface 325. FIG. 3D depicts a material dispenser 326 situated above the target surface 333.

The material dispensing mechanism may translatable horizontally, vertically, or at an angle. The material dispensing mechanism may comprise a material entrance opening port and a material exit opening port. The material entrance port and material exit port may be the same opening. The material entrance port and material exit port may be different openings. The material entrance and material exit ports may be spatially separated. The spatial separation may be on the external surface of the material dispensing mechanism. The spatial separation may be on the surface area of the material dispensing mechanism. The material entrance and material exit ports may be connected. The material entrance and material exit ports may be connected within the material dispensing mechanism. The connection may be an internal cavity within the material dispensing mechanism. The material may travel from the material entry port to the material exit port, though the internal cavity. For example, FIG. 4 shows an entrance port 410 and an internal cavity in which the material 408 resides, and an exit port 405. The material can be dispensed from a top material dispensing mechanism. The top material dispensing mechanism can be located above the target surface. FIG. 9 shows an example of a top material dispensing mechanism 902, located above the target surface 904. The top material dispensing mechanism can be located above the source (e.g., photoconductive) surface.

A material dispensing mechanism can dispense material at a predetermined time, rate, location, dispensing scheme, or any combination thereof. In some examples, the material dispensing mechanism contacts the source surface and/or the intermediate surface. In some examples, the material dispensing mechanism does not contact the target surface, source surface, and/or intermediate surface. The material dispensing mechanism may be separated from the target surface, source surface, and/or intermediate surface by a gap. The gap may be adjustable. The vertical distance of the gap may be at least about 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. The vertical distance of the gap may be at most about 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. The vertical distance of the gap may be any value between the aforementioned values (e.g., from about 0.5 mm to about 100 mm, from about 0.5 mm to about 60 mm, or from about 40 mm to about 100 mm).

The material dispensing mechanism may have at least one opening. The size of the opening, the shape of the opening, the timing and the duration of the opening may be controlled (e.g., directed and/or regulated) by a controller and/or may be variable (e.g., before, during and/or after the 3D printing).

A material removal mechanism may comprise a force that causes the material to travel from the source surface towards the interior of the material removal mechanism (e.g., a reservoir). The material removal mechanism may comprise a force that causes the material to travel from the target surface (or from the material bed) towards the interior of the material removal mechanism (e.g., a reservoir). The material removal mechanism may comprise negative pressure (e.g., vacuum), positive pressure (e.g., compressed gas), electrostatic force, electric force, magnetic force, or physical force (e.g., scooper).

The material removal mechanism may be integrated with the material dispensing mechanism. The material dispensing mechanism may be spaced apart from the material removal mechanism. A component of the material dispensing mechanism (e.g., a material exit opening port) may be spaced apart from a component of the material removal mechanism (e.g., a material entrance opening port). The integration of the components may form a pattern, or may be separated into two groups each of which containing one type of component, or may be randomly situated. The one or more material exit ports and one or more material entry (e.g., vacuum) ports may be arranged in a pattern (e.g., sequentially), grouped together, or at random. The one or more powder exit ports and one or more vacuum entry ports operate sequentially, simultaneously, in concert, separate from each other, or any combination thereof.

The controller may control the level of pressure (e.g., vacuum or positive pressure) in the material removal system. The pressure level (e.g., vacuum or positive pressure) may be constant or varied. The pressure level may be turned on and off manually or by the controller. The pressure level may be less than about 1 atmosphere pressure (760 Torr). The pressure level may be any pressure level disclosed herein. The controller may control the amount of force exerted or residing within the material removal system. For example, the controller may control the amount of magnetic force, electric force, electrostatic force, gas pressure (e.g., positive or negative) and/or physical force exerted by the material removal system. The controller may control if and when the aforementioned forces are exerted.

The removed material may be recycled and re-applied into the source surface by the material dispensing mechanism. The particulate material may be (e.g., continuously) recycled though the operation of the material removal system. The material may be recycled after each layer of particulate material has been removed (e.g., from the source surface). The material may be recycled after a plurality of layers of material have been removed (e.g., from the source surface. The material may be recycled after a 3D object has been printed.

In some embodiments, the 3D printing system does not require a material leveling mechanism that levels the exposed surface of the material bed. The 3D printing system may comprise a material leveling mechanism that levels the exposed surface of the material bed. For example, after the material-fall travels (e.g., laterally) across the target surface, and the energy source transforms the falling material in at least one position, a leveling mechanism (e.g., material leveling mechanism such as a powder leveling mechanism) may level the exposed surface of the material bed. For example, the leveling mechanism may comprise a material removal mechanism that can level the exposed surface of the material bed regardless of protruding objects (e.g., at least a portion of the hardened material).

The leveling mechanism may comprise a roll, brush, rake, spatula, or blade. The leveling mechanism may be configured to move and/or level material along the material layer. The leveling mechanism may comprise a vertical cross section (e.g., side cross section) of a circle, triangle, square, pentagon, hexagon, octagon, or any other polygon, or partial shape or combination of shapes thereof. The leveling mechanism may comprise a vertical cross section (e.g., side cross section) of an amorphous shape. The leveling mechanism may comprise one or more blades. In some examples, the leveling mechanism comprises a blade with two mirroring sides, or two blades attached to form two mirroring blades. Such mirroring arrangement may ensure a similar action when the leveling mechanism is traveling in one side and in the opposite side of the building platform (e.g., material bed). The leveling mechanism may comprise a roller (e.g., a reverse rotating roller), or a squeegee. The blade may be of a hard or soft (e.g., polymeric) material. A controller may control the material removal system and/or leveling mechanism. The controller may control the speed (velocity) of lateral movement of the leveling mechanism.

The material dispensing mechanism may comprise positive pressure (e.g., a gas) that causes the material to leave the material dispensing mechanism and travel into its opening. The gas may comprise any gas disclosed herein. The gas may aid in fluidizing the material (e.g., powder) that remains in the material bed. The reservoir of the powder dispensing mechanism can be of any shape. The reservoir can be a tube (e.g., flexible or rigid). The reservoir can be a funnel. The reservoir can have a rectangular cross section or a conical cross section. The reservoir can have an amorphous shape.

A controller may control or regulate any apparatus, member, mechanism, system, and/or components thereof (e.g., the material dispensing mechanism). Control may comprise regulate, monitor, restrict, limit, govern, restrain, supervise, direct, guide, manipulate, or modulate. For example, the controller may control the material-fall, source surface, intermediate surface, and/or target surface. Such control may comprise controlling the speed (velocity) of lateral movement. The controller may control the level of pressure (e.g., vacuum, ambient, or positive pressure) in the material dispensing mechanism, and/or the enclosure (e.g., chamber). The pressure level (e.g., vacuum, ambient, or positive pressure) may be constant or varied (e.g., over time). The pressure level may be turned on and off manually or by the controller. The pressure level may be less than about 1 atmosphere pressure (760 Torr), more than about 1 atmosphere pressure, or about 1 atmosphere pressure. The controller may control the charging mechanism that changes the particulate material prior to adherence to the source surface. For example, the controller may control the amount of magnetic, and/or electrical charge generated by the charging mechanism. For example, the controller may control the polarity type of the magnetic, and/or electrical charge generated by the charging mechanism. The controller may control the timing, duration, and/or frequency at which the charge is generated.

The charging mechanism may comprise a corona discharge member. The corona may be positive or negative. The charging mechanism may comprise an ionizing gas. The charging mechanism may comprise a charging fluid. The charging mechanism may comprise a gas discharge lamp. The gas discharge lamp may comprise low pressure, high pressure, or high intensity discharge lamp. The charging mechanism may comprise a dielectric-barrier discharge. The charging mechanism may charge induce an electrostatic charge on the photoconductive surface. The photoconductive polymer surface may comprise conductive polyurethane. The electrostatic charge may be of at least about 400 Volts (V), 500V, 600V, 700V, or 800V of a certain electrical polarity (e.g., negative polarity).

The material dispensing mechanism can be oriented adjacent to the target surface. Adjacent may by above, below, or to the side. The material dispensing mechanism may rotate around an axis. In one example, the source and/or intermediate surface may rotate around an axis. The axis of rotation may be normal to the direction in which material exits the material dispensing mechanism. The movement can be synchronized such that there is no relative movement between the material dispensing system and target surface. The movement can be synchronized such that there is a constant relative movement between the material dispensing system and target surface. The movement can be synchronized such that there is a controlled relative movement between the material dispensing system and target surface. The movement may comprise constant and/or accelerated movement. In some examples, the material dispensing mechanism may not be rotatable. The material dispensing mechanism may translatable horizontally, vertically, or at an angle. The axis of rotation of the material dispensing mechanism may be (e.g., substantially) normal or parallel to the direction of translation. The material dispenser may dispense particulate material predetermined time, rate, location, dispensing scheme, or any combination thereof.

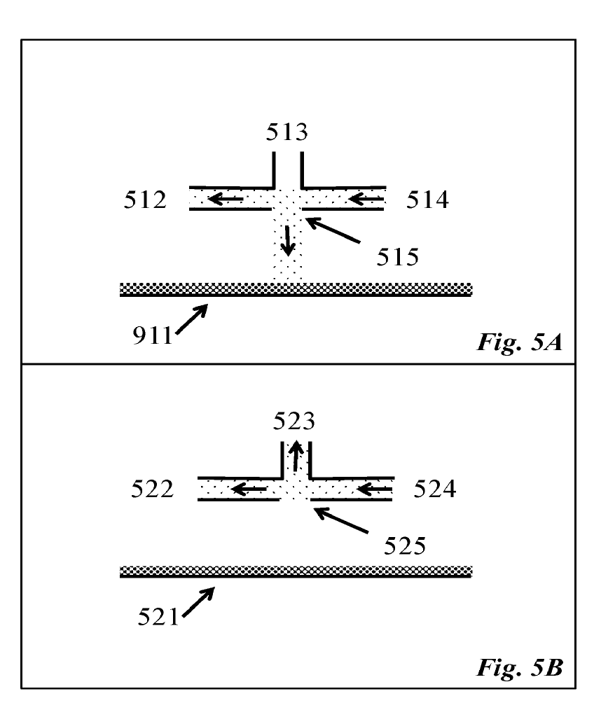

In some instances, the reservoir of the material dispensing mechanism comprises an exit opening port, wherein the material is being displaced (e.g., flows) within the reservoir from one side of the exit port to the other side. The displacement may be a lateral displacement (e.g., from right to left), or an angular displacement (e.g., at a planar or compound angle). The rate of the displacement may determine the amount of material that exits though the exit port (e.g., due to gravitational, magnetic, and/or electrostatic force). In some embodiments, the material is attracted to a position away from the exit port. The attraction may comprise electrical, magnetic, or physical attraction. The physical attraction may comprise positive or negative pressure (e.g., vacuum). A pressure variation may effectuate the displacement. The pressure variation may comprise positive pressure at one side of the opening, and ambient pressure (i.e., about 1 atmosphere) at the other side. The pressure variation may comprise positive pressure at one side of the opening, and negative pressure at the other side. The pressure variation may comprise ambient pressure at one side of the opening, and negative pressure at the other side. A charge (magnetic and/or electrical) variation may similarly effectuate the displacement in case the material responds to the charge type (i.e., magnetic or electrical respectively). FIGS. 5A and 5B show examples of similar mechanisms. In FIG. 5A, powder flows from one side of the opening 515 (e.g., from 514) to the other side (e.g., to 512), for example due to pressure variation. In FIG. 5A, there is no attracting force (e.g., at position 513) that attracts the material away from the exit opening 515, which results in particular material (e.g., powder) flow downwards though the exit opening 515. In FIG. 5B, particular material flows from one side of the opening 525 (e.g., from 524) to the other side (e.g., to 522), and wherein there is an attracting force (e.g., at position 523) that attracts the material away from the exit opening 525, and therefore (e.g., substantially) no powder flows though the exit opening 525.

The reservoir of the material dispensing mechanism may comprise a single compartment or a multiplicity of compartments. The multiplicity of compartments may have identical or different vertical cross sections, horizontal cross sections, surface areas, and/or volumes. The walls of the compartments may comprise identical or different materials. The multiplicity of compartments may be connected such that gas may travel (flow) from one compartment to another (termed herein “flowable connected” or “fluidly connected”). The multiplicity of compartments may be connected such that material that was picked up by the gas (e.g., airborne particulate material) may travel (flow) from one compartment to another. FIG. 5B shows examples of a particulate material dispensing mechanism having three compartments of substantially identical cross sections that are fluidly connected as illustrated by the gas flow 522, 523 and 524 within the internal cavity of the material dispensing mechanism. The material dispensing mechanism may comprise a gas entrance port, gas exit port, material entrance port, and material exit port. In some examples, the material dispensing mechanism may comprise two material exits. The gas entrance and the material entrance port may be the same or different entrance port(s). The gas exit and the material exit ports may be the same or different entrances. The material dispensing mechanism may have an exit opening port trough which material exits (e.g., FIG. 5A, 515; FIG. 5B, 525). In some examples, a material exit opening port faces the target surface. In some examples, an exit opening port resides at the bottom of the material dispensing system. The exit opening port may comprise a mesh, slit, hole, slanted baffle, shingle, ramp, slanted plane, or any combination thereof. The mesh may have any mesh values disclosed herein. In some examples, the mesh can comprise hole sizes of at least about 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, or 1000 μm. The mesh can comprise hole sizes of at most about 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, or 1000 μm. The mesh can comprise hole sizes between any of the hole sizes disclosed herein (e.g., from about 5 μm to about 1000 μm, from about 5 μm to about 500 μm, from about 400 μm to about 1000 μm, or from about 200 μm to about 800 μm).

The reservoir in which the bottom opening is situated can be symmetrical (e.g., FIG. 3B), or unsymmetrical (e.g., FIG. 3D). The direction of the gas flow can coincide with the direction of lateral movement of the material dispensing and/or removal system, not coincide, or flow opposite thereto. The material can be supplied from a reservoir. The supply of the material can be from the top of the material dispensing mechanism, from the bottom, or from the side. The material can be elevated by an elevation mechanism (e.g., vertical actuator) into the reservoir or out of the reservoir. The elevation mechanism can comprise a conveyor or an elevator. The elevation mechanism can comprise a mechanical lift. The elevation mechanism can comprise an escalator, elevator, conveyor, lift, ram, plunger, auger screw, or Archimedes screw. The elevation mechanism can comprise a transportation system that is assisted by gas (e.g., pressurized gas), gravity, electricity, heat (e.g., steam), or gravity (e.g., weights). Any conveyor and/or surface described herein may comprise a smooth surface or a coarse surface. The conveyor may comprise ledges, protrusions, or depressions. The protrusions or depressions may trap material to be conveyed to the reservoir or from the reservoir.

Any of the material dispensing mechanisms described herein can be configured to deliver the particulate material from the reservoir to the material bed and/or to a surface (e.g., source surface, target surface, or intermediate surface). Particulate material in the reservoir can be preheated, cooled, be at an ambient temperature or maintained at a predetermined temperature at a particular time (e.g., before, during, and/or after the 3D printing).

The gas may travel (e.g., flow in the material dispensing system) at a velocity. The velocity may be varied. The velocity may be variable or constant. The velocity may be at least about 0.001 Mach, 0.03 Mach, 0.005 Mach, 0.007 Mach, 0.01 Mach, 0.03 Mach, 0.05 Mach, 0.07 Mach, 0.1 Mach, 0.3 Mach, 0.5 Mach, 0.7 Mach, 1 Mach, 2 Mach, 3 Mach, 4 Mach, 5 Mach, 6 Mach, 7 Mach, 8 Mach, 9 Mach, 10 Mach, 15 Mach, 20 Mach, 25 Mach, or 30 Mach. The velocity may be at most about at most about 30 Mach, 25 Mach, 20 Mach, 15 Mach, 10 Mach, 9 Mach, 8 Mach, 7 Mach, 6 Mach, 5 Mach, 4 Mach, 3 Mach, 2 Mach, 1 Mach, 0.7 Mach, 0.5 Mach, 0.3 Mach, 0.1 Mach, 0.07 Mach, 0.05 Mach, 0.03 Mach, 0.01 Mach, 0.007 Mach, 0.005 Mach, 0.003 Mach, 0.001 Mach. The velocity may be between any of the aforementioned velocity values (e.g., from about 1 Mach to about 30 Mach, from 1 Mach to 8 Mach, or from 7 Mach to 30 Mach, from about 0.01 Mach to about 0.7 Mach, from about 0.005 Mach to about 0.01 Mach, from about 0.05 Mach to about 0.9 Mach, from about 0.007 Mach to about 0.5 Mach, or from about 0.001 Mach to about 1 Mach).

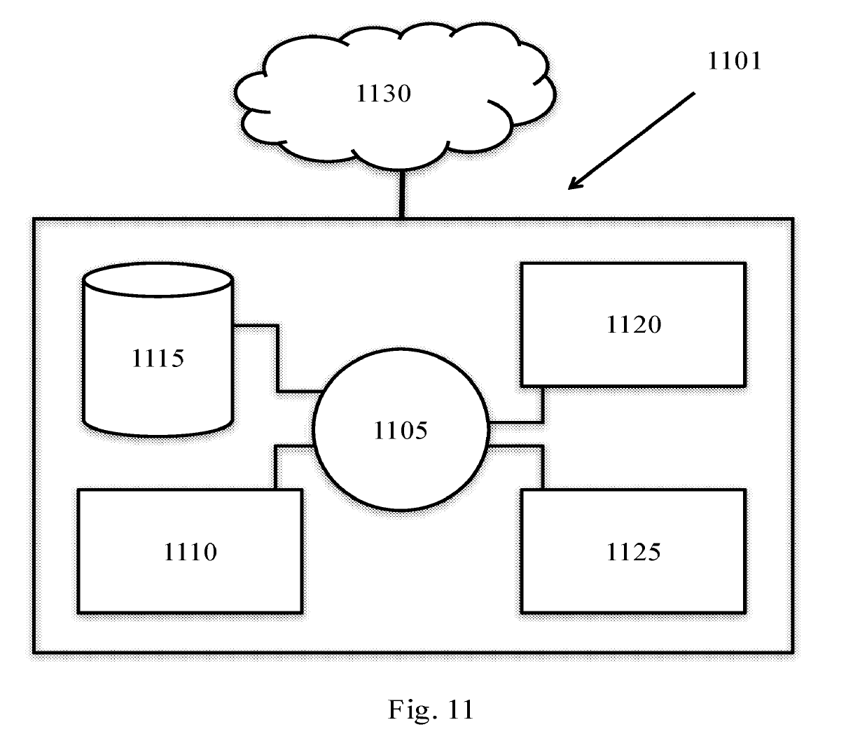

The controller may control the gas velocity. The controller may control type of gas that travels within the material dispensing mechanism, and/or enclosure. The controller may control the amount of material released by the material dispensing mechanism and/or by the source surface. The controller may control the position in which the material is deposited on the surface (e.g., target surface and/or source surface). The controller may control the radius of the material deposited on the surface. The surface may comprise a target, source, or intermediate surface. The controller may control the rate of material deposition on the surface. The controller may control the vertical height of the material dispenser, intermediate surface, source surface, target surface, and/or material bed. The controller may control any of the gap distances disclosed herein. The control of the gap comprises control of the vertical height of the gap, and/or the atmospheric content of the gap. The controller may control the movement (e.g., rotation) of the target and/or intermediate surface. For example, the controller may control the velocity and direction of the rotation. The controller may control the angle (FIG. 11, theta “θ”) of that slanted plane. The controller may control the rate of vibration of the vibrators that are part of the material dispensing system (e.g., FIG. 4, 406). For example, the controller may control the rate of vibration of the material in the reservoir within the material (e.g., powder) dispensing system.

The mechanism (e.g., material dispensing mechanism, or material charging mechanism), the surface (e.g., intermediate, source, or target), the substrate, the base, the powder bed, the enclosure, the energy source, the energy beam, or any combination thereof may be movable (e.g., horizontal, vertical, or at an angle). The control may be manual and/or automatic. The control may be programmed or be effectuated a whim. The control may be according to an algorithm. The algorithm may comprise a printing algorithm, and/or motion control algorithm.

In some cases, the material dispensing mechanism can be ultrasonic. For example, the material dispensing mechanism can be vibratory. For example, the material dispensing mechanism may comprise a vibrator or a shaker. The mechanism configured to deliver the material to the surface (e.g., source surface) can comprise a vibrating mesh. The vibration may be formed by an ultrasonic transducer, a piezo-electric device, a rotating motor (e.g., having an eccentric cam), or any combination thereof. The vibrations may be produced by a sonicator. The ultrasonic and/or vibratory material dispensing mechanism can dispense particulate material (e.g., powder) in two, or three dimensions. The frequency of an ultrasonic and/or vibratory disturbance of the material dispenser can be chosen such that material is delivered to the surface at a predetermined rate. The ultrasonic and/or vibratory dispenser can dispense material onto a point on the surface from a location above the surface. The ultrasonic and/or vibratory material dispenser can dispense material onto the surface (e.g., target, source and/or intermediate surface) from a location that is at a relatively higher height relative to the target surface (e.g., from the top of the enclosure). The ultrasonic and/or vibratory dispenser can dispense material onto the surface in a downward or sideward direction. The ultrasonic and/or vibratory dispenser can dispense material onto the surface in a downward direction. The material may be dispensed using gravitational force. The ultrasonic and/or vibratory dispenser can be a top-dispenser that dispenses the material from a position above a particular position on the surface. The vibrator may comprise a spring. The vibrator may be an electric or hydraulic vibrator.

The material dispenser can comprise a vibrator. The vibrator can be located within the material dispenser reservoir, or outside of the material dispenser reservoir. The vibrator may be a vibrating rod. FIG. 4 shows an example for a material dispenser 410 comprising a vibrator 406 that is located outside of the material dispenser reservoir. The material dispenser can comprise two or more vibrators (e.g., an array of vibrators). The array of vibrators can be arranged linearly, non-linearly, or at random. The array of vibrators can be arranged along the opening of the material dispenser, or in proximity thereto. The material dispenser can comprise of multiple opening ports. The array of vibrators can be situated along the array of opening ports (e.g., the multiple openings). The vibrators can be arranged along a line. The vibrators can be arranged along a linear pattern. The vibrators can be arranged along a non-linear pattern. The arrangement of the vibrators can determine the rate at which the material exits the material dispenser. The vibrator(s) may reside on a face of the material dispensing mechanism. The vibrator may reside next to an exit opening (e.g., port). The material dispensing mechanism can comprise a mesh that is connected to a vibrator. The material dispensing mechanism comprises a mesh that is capable of vibrating. The vibrator(s) can vibrate at least part of the material within the material dispensing mechanism (e.g., within the reservoir, FIG. 4, 408). The vibrators(s) can vibrate at least a part of the material dispenser body. The body of the material dispensing mechanism (e.g., the reservoir body) may comprise a light material such as a light elemental metal or metal alloy (e.g., aluminum). The vibrators can be controlled manually or automatically (e.g., by a controller). The vibrator frequency may be at least about 20 Hertz (Hz), 30 Hz, 40 Hz, 50 Hz, 60 Hz, 70 Hz, 80 Hz, 90 Hz, 100 Hz, 110 Hz, 120 Hz, 130 Hz, 140 Hz, 150 Hz, 160 Hz, 170 Hz, 180 Hz, 190 Hz, 200 Hz, 210 Hz, 220 Hz, 230 Hz, 240 Hz, 250 Hz, 260 Hz, 270 Hz, 280 Hz, 290 Hz, 300 Hz, 350 Hz, 400 Hz, 450 Hz, 500 Hz, 550 Hz, 600 Hz, 700 Hz, 800 Hz, 900 Hz, or 1000 Hz. The vibrator frequency may be at most about 20 Hertz (Hz), 30 Hz, 40 Hz, 50 Hz, 60 Hz, 70 Hz, 80 Hz, 90 Hz, 100 Hz, 110 Hz, 120 Hz, 130 Hz, 140 Hz, 150 Hz, 160 Hz, 170 Hz, 180 Hz, 190 Hz, 200 Hz, 210 Hz, 220 Hz, 230 Hz, 240 Hz, 250 Hz, 260 Hz, 270 Hz, 280 Hz, 290 Hz, 300 Hz, 350 Hz, 400 Hz, 450 Hz, 500 Hz, 550 Hz, 600 Hz, 700 Hz, 800 Hz, 900 Hz, or 1000 Hz. The vibrator frequency may be any number between the afore-mentioned vibrator frequencies (e.g., from about 20 Hz to about 1000 Hz, from about 20 Hz, to about 400 Hz, from about 300 Hz to about 700 Hz, or from about 600 Hz to about 1000 Hz). The vibrators in the array of vibrators can vibrate in the same or in different frequencies. The vibrators can have a vibration amplitude of at least about 1 times the gravitational force (G), 2 times G, 3 times G, 4 times G, 5 times G, 6 times G, 7 times G, 8 times G, 9 times G, 10 times G, 11 times G, 15 times G, 17 times G, 19 times G, 20 times G, 30 times G, 40 times G, or 50 times G. The vibrators can have a vibration amplitude of at most about 1 times the gravitational force (G), 2 times G, 3 times G, 4 times G, 5 times G, 6 times G, 7 times G, 8 times G, 9 times G, 10 times G, 11 times G, 15 times G, 17 times G, 19 times G, 20 times G, 30 times G, 40 times G, or 50 times G. The vibrators can vibrate at amplitude having any value between the afore-mentioned vibration amplitude values (e.g., from about 1 times G to about 50 times G, from about 1 times G to about 30 times G, from about 19 times G to about 50 times G, or from about 7 times G to about 11 times G).

The systems and/or apparatuses disclosed herein may comprise one or more motors. The motors can be actuators. The motors may comprise servomotors. The servomotors may comprise actuated linear lead screw drive motors. The motors may comprise belt drive motors. The motors may comprise rotary encoders. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

In some cases, the mechanism configured to deliver the particulate material from the reservoir to the target surface (i.e., material dispensing mechanism) can comprise a screw, an elevator, or a conveyor. The screw can be a rotary screw in a vessel. When the screw is rotated material can be dispensed from the screw though an exit opening (e.g., exit port). The screw can dispense material in an upward, lateral, or downward direction relative to the target surface. The screw can be an auger or Archimedean screw. The spacing and size of the screw thread can be chosen such that a predetermined amount of material is dispensed on to the substrate with each turn or partial turn of the screw. The turn rate of the screw can be chosen such that material is dispensed on the substrate at a predetermined rate. In some cases, material dispensed by the screw can be spread on at least a fraction of the target surface by a rotary screw, linear motion of a spreading tool, and/or one or more baffles. The screw can be an Archimedes screw. The screw can be an auger screw.

At least a cross section (e.g., vertical, and/or horizontal) of the material dispensing mechanism may be shaped as an inverted cone, a funnel, an inverted pyramid, half of an inverted pyramid, a cylinder, any irregular shape, or any combination thereof. Examples of funnel dispensers are depicted in FIGS. 3A-3D, showing vertical side cross sections of various material dispensing mechanisms. The material dispensing mechanism may comprise at least one plane (e.g., facing the platform and/or the gravitational center) that is slanted with respect to the platform (e.g., FIG. 3A, 308).

The bottom opening of the material dispensing mechanism (e.g., FIG. 3A, 309) may be completely blocked by a vertically movable plane (e.g., 305) above which particulate material is disposed (e.g., 304). The plane can be situated directly at the opening, or at a vertical distance “d” from the opening. The vertical movement (e.g., 302) of the vertically movable plane may be controlled (e.g., manually and/or automatically, for example, by using a controller). When the plane is moved vertically upwards (e.g., away from the target surface (e.g., 310)), side openings may be formed between the plane (e.g., 305) and the edges of the material dispenser (e.g., 308), out of which material can flow (e.g., slide) though the opening (e.g., 309) of the material dispenser (e.g., funnel) and form a material-fall (e.g., 307). The material dispensing mechanism may comprise at least one mesh. The mesh may ensure homogenous (e.g., even) distribution of the material in the material-fall and/or on to the target surface. The mesh can be situated at the bottom opening of the material dispenser (e.g., 309) or at any position between the bottom opening and the position at which the plane completely blocks the material dispenser (e.g., at any position within the distance “d” in FIG. 3A). In some embodiments, the plane (e.g., 305) may comprise a mesh.

The material dispensing mechanism can comprise a double mesh dispenser. The mesh may be a plane comprising one or more holes. An opening of the material dispenser can comprise a mesh or a plane with holes (collectively referred to herein as “mesh”). The mesh comprises a hole (or an array of holes). The hole (or holes) can allow the material to exit the material dispenser. The plurality of holes may be arranged in a series or randomly. The bottom of the double mesh dispenser can comprise an opening (e.g., FIG. 3C, 326). The opening may comprise of two meshes (e.g., 323) of which at least one is movable (e.g., horizontally; FIG. 3C, 320). The two meshes may be aligned such that the opening of one mesh can be completely blocked by the second mesh and not allow the particulate material to flow though. A movement (e.g., horizontal) of the at least one movable mesh may misalign the two meshes and expose openings that allow flow of the particulate material (e.g., 322) from the reservoir above the two meshes (e.g., 319) down towards the direction of the target surface (e.g., 325). The degree of misalignment of the meshes can alter the size and/or shape of the openings though which the particulate material can exit the material dispenser (e.g., 318). At times, a hole in the mesh can have a FLS of at least about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm 950, μm, 1000 μm, 2 mm, 3 mm, 4 mm, 5 mm, or 10 m. A hole in the mesh can have a FLS of at most about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm 950, μm, 1000 μm, 2 mm, 3 mm, 4 mm, 5 mm, or 10 m. A hole in the mesh can have a FLS of any value between the afore-mentioned FLSs (e.g., from about 10 μm to about 1000 μm, from about 10 μm to about 600 μm, from about 500 μm to about 1000 μm, from about 50 μm to about 300 μm, from about 10 μm to about 10 mm, or from 100 μm to about 5 mm). The FLS of the hole may be adjustable or fixed. In some embodiments the opening comprises two or more meshes. At least one of the two or more meshes may be movable (e.g., FIG. 3D, 323). The movement of the two or more meshes may be controlled manually or automatically (e.g., by a controller). The relative position of the two or more meshes with respect to each other may determine the rate at which the material passes through the hole (or holes). The FLS of the holes may be electrically controlled. The FLS of the holes may be thermally controlled. The mesh may be heated or cooled. The may vibrate (e.g., controllably vibrate). The temperature and/or vibration of the mesh may be controlled manually or by a controller. The holes of the mesh can shrink or expand as a function of the temperature and/or electrical charge of the mesh. The mesh can be conductive. The mesh may comprise a mesh of standard mesh number 50, 70, 90, 100, 120, 140, 170, 200, 230, 270, 325, 550, or 625. The mesh may comprise a mesh of standard mesh number between any of the aforementioned mesh numbers (e.g., from 50 to 625, from 50 to 230, from 230 to 625, or from 100 to 325). The standard mesh number may be US or Tyler standards. The two meshes may have at least one position where no material can pass though the exit opening. The two meshes may have a least one position where a maximum amount of material can pass though the exit opening. The two meshes can be identical or different. The size of the holes in the two meshes can be identical or different. The shape of the holes in the two meshes can be identical or different. The shape of the holes can be any hole shape described herein.

The material dispensing mechanism may comprise an exit opening port that resides within a face of the material dispensing mechanism. The face may be the bottom of the material dispenser, which faces the target surface. The face may be different from the bottom of the material dispenser (e.g., side face). The face may comprise the bottom face of the material dispenser and/or a face different from the bottom of the material dispenser (e.g., side face). FIG. 3C shows an example of a material dispensing mechanism having a bottom facing exit opening port (e.g., 326). The face in which the exit opening port resides may be different than the bottom face of the power dispenser. For example, the face may be a side of the material dispenser. The face may be a face that is not parallel to the exposed surface of the material bed. The face may be (e.g., substantially) perpendicular to the average plane formed by the top surface of the material bed. FIG. 4 shows an example of a material dispensing mechanism having a side exit opening port (e.g., 405) that is substantially perpendicular to the target surface (e.g., 401). The face may be (e.g., substantially) perpendicular to the average plane of the target surface and/or platform. The face may be situated at the top face of the material dispensing mechanism. The top face of the dispensing mechanism may be the face that faces away from the target surface, platform, bottom of the enclosure, and/or exposed surface of the material bed. The face may be a side face. The side face may be a face that is not the bottom or the top face. A plane in the face (e.g., the entire face) may lean towards the target surface, material bed, substrate, bottom of the container, and/or base. Leaning may comprise a plane that is curved towards the target surface, substrate, base, and bottom of the enclosure, and/or towards the material bed. The curved surface may have a radius of curvature centering at a point below the bottom of the material dispenser. The curved surface may have a radius of curvature centering at a point above the bottom of the material dispenser. Leaning may comprise a plane forming an acute angle with an average target surface.

The material dispensing mechanism may comprise a bottom having a first slanted bottom surface, slating in a first direction (e.g., FIG. 4, 407). In some instances, one edge (e.g., side) of the surface at the bottom of the material dispensing mechanism lies vertically above another edge of that surface. The surface may be convex or concave. The surface may be planar. The angle of the first slanted bottom surface may be adjustable or non-adjustable. The first slanted bottom surface (e.g., 407) may face the bottom of the enclosure, and/or target surface (e.g., 401; e.g., platform, and/or the exposed surface of the material bed). The bottom of the material dispenser may be a slanted 3D plane.

The 3D plane may be planar, curved, or assume an amorphous 3D shape. The 3D plane may comprise a curvature. The 3D plane may be curved. The 3D plane may be planar (e.g., and flat). The 3D plane may have a shape of a curving scarf. The term “3D plane” is understood herein to be a generic (e.g., curved) 3D surface. For example, the 3D plane may be a curved 3D surface. The 3D plane may be from a rigid or flexible material (e.g., any material as disclosed herein).

The bottom of the material dispenser may comprise one or more additional 3D planes (e.g., each comprising a surface). The one or more additional 3D planes (e.g., 804) may be adjacent to the bottom of the material dispenser (e.g., 803). The one or more additional 3D planes may be connected to the bottom of the material dispenser. The one or more additional 3D planes may be disconnected from the material dispenser (e.g., FIG. 8, 804). The one or more additional 3D planes may be extensions of the bottom face of the material dispenser. The one or more additional 3D planes may be slanted (e.g., with respect to the platform, bottom of the enclosure and/or the average plane of the exposed surface of the material bed). The angle between the one or more additional 3D planes and the platform, bottom of the enclosure and/or the average plane of the exposed surface of the material bed may be adjustable or non-adjustable (e.g., before, during, and/or after the 3D printing). The one or more additional 3D planes that are slanted may form an acute angle (theta “θ”; FIG. 4, 403) in a second direction with the platform, bottom of the enclosure and/or the average plane of the exposed surface of the material bed. The direction (first and/or second) may be clockwise or anti-clockwise direction. The direction may be positive or negative direction. The first direction may be the same as the second direction. The first direction may be opposite to the second direction. For example, the first and second direction may be clockwise. The first and second direction may be anti-clockwise. The first direction may be clockwise and the second direction may be anti-clockwise. The first direction may be anti-clockwise and the second direction may be clockwise. The first and second direction may be viewed from the same position. At least part of the one or more additional surfaces may be situated at a vertical position that is different than the bottom of the first slanted bottom surface (e.g., 407 and 403). At least part of the one or more additional surfaces may be situated at a vertical position that is higher than the bottom of the first slanted bottom surface. At least part of the one or more additional surfaces may be situated at a vertical position that is lower than the bottom of the first slanted bottom surface. The lower most position of the one or more additional surfaces may be situated at a vertical position that is higher or lower than the lower most position of the first slanted bottom surface. The upper most position of the one or more additional surfaces may be situated at a vertical position that is higher or lower than the upper most position of the first slanted bottom surface. The one or more additional surface may comprise a conveyor. The conveyor can move in the direction of movement of the material dispenser, or in a direction opposite to the direction of movement of the material dispenser. FIG. 4 shows an example of a material dispensing mechanism (e.g., material dispenser) 410 having a slanted bottom surface 407. The powder dispensing mechanism comprises an additional slanted surface 403 forming an angle theta with an imaginary plane 402 parallel to the target surface 401. The slanted surface may be horizontally and/or vertically separated from the material exit opening (e.g., port) by a gap. The gap may be adjustable (e.g., before, during, and/or after the 3D printing). The angle of the slanted surface may be adjustable (e.g., before, during, and/or after the 3D printing).

The material dispenser may comprise a bottom having a vertical cross section forming a first curved bottom plane. The first curved bottom plane may have a radius of curvature that is situated below the bottom of the material dispenser (e.g., in the direction of the substrate). The first curved bottom plane may have a radius of curvature that is situated above the bottom of the material dispenser (e.g., in the direction away from the substrate). The radius of curvature of the first curved bottom plane may be adjustable or non-adjustable. The bottom of the material dispenser may comprise one or more additional planes. The one or more additional planes may be adjacent to the bottom of the material dispenser. The one or more additional planes may be connected to the bottom of the material dispenser. The one or more additional planes may be disconnected from the material dispenser. The one or more additional planes may be extensions of the bottom face of the material dispenser. The one or more additional planes may be curved. The radius of curvature of the one or more additional planes may be adjustable or non-adjustable. The vertical cross section of the one or more additional curved planes may have a radius of curvature that is situated below the one or more additional curved planes (e.g., towards the direction of the substrate). The vertical cross section of the one or more additional curved planes may have a radius of curvature that is situated above the one or more additional curved planes (e.g., towards the direction away from the substrate). The radius of curvature of the one or more additional curved planes may be the same or different than the radius of curvature of the first curved bottom plane. The radius of curvature of the one or more additional curved planes may be smaller or larger than the radius of curvature of the first curved bottom plane. The material dispenser may have a planar bottom that may or may not be slanted. The material dispenser may have a planar bottom that is parallel to the substrate (or to an average plane formed by the substrate). The material dispenser may have one or more additional planes that are curved. The radius of curvature of the curved planes (or a vertical cross section thereof) may be situated below the curved plane (e.g., in the direction of the substrate). The material dispenser may have one or more additional planes that are or are not slanted. The material dispenser may have one or more additional planes that are parallel or perpendicular to the substrate. The radius of curvature of the curved planes (or a vertical cross section thereof) may be situated below the curved plane (e.g., towards the direction of the substrate). The radius of curvature r₁, r₂ and/or r₁₂ may be at least about 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. The radius of curvature r₁, r₂ and/or r₁₂ may be at most about 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. The radius of curvature r₁, r₂ and/or r₁₂ may be of any value between the afore-mentioned values (e.g., from 0.5 mm to about 100 mm, from about 0.5 mm to about 50 mm, or from about 50 mm to about 100 mm).

In some examples, the material dispenser comprises both an exit opening port and at least a first slanted surface as delineated above. For example, the material dispenser can comprise both a side exit opening port and at least a first slanted surface. The material dispenser can comprise both a side exit opening and at least a first slanted plane and a second slanted 3D plane. The one or more slanted 3D planes can reside at the bottom of the material dispenser. The second 3D plane can be an extension of the bottom of the material dispenser. The second 3D plane can be connected or disconnected from the bottom of the material dispenser.

The opening (e.g., port) of the material dispenser can comprise an obstruction. The obstruction can be a 3D plane. The obstruction can be a blade. The blade can be a “doctor's blade.” FIG. 4 shows an example of a material dispenser 410 having an opening comprising an obstruction 411. The opening may comprise both a blade and one or more meshes. The mesh(es) may be closer to the exit opening than the blade. The blade may be closer to the exit opening than the mesh(es). The exit opening can comprise a plurality of meshes and/or blades. The exit opening can comprise a first blade followed by a mesh that is followed by a second blade (e.g., disposed closest to the external surface of the exit opening). The exit opening can comprise a first mesh followed by a blade, which is followed by a second mesh (e.g., disposed closest to the external surface of the exit opening). The first and second blades may be identical or different. The first and second meshes may be identical or different. The exit opening can comprise a first mesh, followed by a second mesh, followed by a blade arranged in a direction towards the powder exit direction. The exit opening can comprise a blade followed by a first mesh, followed by a second mesh arranged in a direction towards the powder exit direction. The meshes and blades may be arranged in any sequential order arranged in a direction towards the powder exit direction. The material dispenser may comprise a spring at the exit opening.

Any of the layer dispensing mechanisms described herein can comprise a bulk reservoir (e.g., a tank, a pool, a tub, or a basin) of material. The dispensing mechanism can comprise a mechanism configured to deliver the material from the bulk reservoir to the layer dispensing mechanism (e.g., a recoater). The material reservoir can be connected or disconnected from the layer dispensing mechanism or any of its components (e.g., from the material dispenser). The (e.g., disconnected) material reservoir can be located above, below, or to the side of the material bed. The (e.g., disconnected) bulk reservoir can be located above the material bed, for example above the material entrance opening to the material dispenser. The (e.g., connected) bulk reservoir may be located above, below, or to the side of the material exit opening port of the material dispenser. The (e.g., connected) bulk reservoir may be located above the material exit opening of the material dispenser. Particulate material (e.g., fresh or recycled) can be stored in the bulk reservoir. The bulk reservoir may hold at least an amount of particulate material sufficient for one layer, or sufficient to build the entire 3D object. The bulk reservoir may hold at least about 200 grams (gr), 400 gr, 500 gr, 600 gr, 800 gr, 1 Kilogram (Kg), or 1.5 Kg of material. The bulk reservoir may hold at most 200 gr, 400 gr, 500 gr, 600 gr, 800 gr, 1 Kg, or 1.5 Kg of material. The bulk reservoir may hold an amount of material between any of the afore-mentioned amounts of bulk reservoir material (e.g., from about 200 gr to about 1.5 Kg, from about 200 gr to about 800 gr, or from about 700 gr to about 1.5 kg).

The material dispenser reservoir may hold at least an amount of material sufficient for at least one, two, three, four or five layers of material (e.g., within the material bed). The material dispenser reservoir may hold at least an amount of particulate material sufficient for at most one, two, three, four or five layers. The material dispenser reservoir may hold an amount of material between any of the afore-mentioned amounts of material (e.g., sufficient to a number of layers from about one layer to about five layers). The material dispenser reservoir may hold at least about 20 grams (gr), 40 gr, 50 gr, 60 gr, 80 gr, 100 gr, 200 gr, 400 gr, 500 gr, or 600 gr of material. The material dispenser reservoir may hold at most about 20 gr, 40 gr, 50 gr, 60 gr, 80 gr, 100 gr, 200 gr, 400 gr, 500 gr, or 600 gr of material. The material dispenser reservoir may hold an amount of material between any of the afore-mentioned amounts of material dispenser reservoir material (e.g., from about 20 gr to about 600 gr, from about 20 gr to about 300 gr, or from about 200 gr to about 600 gr.). Material may be transferred from the bulk reservoir to the material dispenser reservoir by any analogous method described herein for exiting of particulate material from the material dispenser.

At times, the bulk reservoir exit opening port comprises one or more smaller opening ports that are smaller in size with the bulk reservoir exit opening port. The one or more smaller exit opening ports (e.g., holes) of the bulk reservoir and/or the bulk reservoir opening port may have a larger FLS relative to the exit opening port (e.g., or hole(s) thereof) of the material dispenser. For example, the bulk reservoir may comprise an exit comprising a mesh or a surface comprising at least one hole. The mesh (or a surface comprising at least one hole) may comprise a hole with a FLS of at least about 0.25 mm, 0.5 mm. 1 mm, 2 mm, 3 mm, 4 mm, 5 mm, 6 mm, 7 mm, 8 mm, 9 mm, or 1 centimeter. The mesh (or a surface comprising at least one hole) may comprise a hole with a FLS of any value between the afore-mentioned values (e.g., from about 0.25 mm to about 1 cm, from about 0.25 mm to about 5 mm, or from about 5 mm to about 1 cm). The hole can be of a shape comprising a rectangle (e.g., cube), ellipsoid (e.g., circle), triangle, pentagon, hexagon, heptagon, octagon, icosahedron, or an irregular shape. The hole can be of a shape comprising a geometric shape (e.g. Euclidian shape). The hole can comprise a curved shape. The hole can comprise a non-curved shape (e.g., angular shape). The bulk reservoir may comprise a 3D plane that may have at least one edge that is translatable into or out of the bulk reservoir (e.g., before, during, or after the 3D printing). The bulk reservoir may comprise a 3D plane that may pivot (e.g., swivel) into, or out of, the bulk reservoir (e.g., a flap door). Such translation may create an opening, which may allow material in the reservoir to flow out of the reservoir (e.g., using gravity).

A controller may be operatively coupled to the bulk and/or material dispenser reservoir. The controller may control the amount of particulate material released from the bulk reservoir. Controlling the amount released can be by controlling, for example, the amount of time the conditions for allowing particulate material to exit the bulk reservoir are in effect. A controller may control the amount of particulate material released from the material dispenser by controlling, for example, the amount of time the conditions for allowing particulate material to exit the material dispenser are in effect. In some examples, the material dispenser dispenses of any excess amount of particulate material that is retained within the material dispenser reservoir, prior to the loading of particulate material from the bulk reservoir to the material dispenser reservoir (e.g., 328 or 319). In some examples, the material dispenser does not dispense of excess amount of particulate material that is retained within the material dispenser reservoir, prior to loading of particulate material from the bulk reservoir to the material dispenser reservoir. Particulate material may be transferred from the bulk reservoir to the material dispenser reservoir using a scooping mechanism that scoops particulate material from the bulk reservoir and transfers it to the material dispenser. The scooping mechanism may scoop a fixed or predetermined amount of particulate material. The scooped amount may be adjustable (e.g., during, before, and/or after the 3D printing). The scooping mechanism may pivot (e.g., rotate, or swivel) in the direction perpendicular to the scooping direction. The bulk reservoir may be exchangeable, removable, non-removable, or non-exchangeable. The bulk reservoir may comprise exchangeable parts. The material dispenser (and/or any of its parts) may be exchangeable, removable, non-removable, or non-exchangeable. The material dispensing mechanism may comprise exchangeable parts.

Particulate material in the bulk reservoir or in the material dispensing mechanism (e.g., material dispenser reservoir) can be preheated, cooled, maintained at an ambient temperature or maintained at a predetermined temperature.

The material dispenser may dispense material at an average rate of at least about 1000 cubic millimeters per second (mm³/s), 1500 mm³/s, 2000 mm³/s, 2500 mm³/s, 3000 mm³/s, 3500 mm³/s, 4000 mm³/s, 4500 mm³/s, 5000 mm³/s, 5500 mm³/s, or 6000 mm³/s. The material dispenser may dispense material at an average rate of at most about 1000 mm³/s, 1500 mm³/s, 2000 mm³/s, 2500 mm³/s, 3000 mm³/s, 3500 mm³/s, 4000 mm³/s, 4500 mm³/s, 5000 mm³/s, 5500 mm³/s, or 6000 mm³/s. The material dispenser may dispense material at an average rate between any of the afore-mentioned average rates (e.g., from about 1000 mm³/s to about 6000 mm³/s, from about 1000 mm³/s to about 3500 mm³/s, or from about 3000 mm³/s to about 6000 mm³/s).

The material dispenser can comprise a rotating roll (e.g., roller or drum). The surface of the roll may be a smooth surface or a rough surface. An example of a roller within a material dispenser is shown in FIG. 3B (e.g., 311). The surface of the roller may include depressions, protrusions or both protrusions and depressions. The roller may be situated such that at a certain position, the material disposed above the roller (e.g., 312) is unable to flow downwards as the roll shuts the opening of the material dispenser. When the roller rotates (either clockwise or counter clockwise), a portion of the particulate material may be trapped within the depressions or protrusions (or both), and may be transferred from the particulate material occupying side of the material dispenser (e.g., 312), to the material free side of the material dispenser (e.g., that is closer to the exit opening port 318). Such transfer may allow the material to be expelled out of the exit opening of the material dispenser (e.g., 318) towards the target surface (e.g., 317). A similar mechanism is depicted in FIG. 3D showing an example of a material dispenser (e.g., 326) that comprises an internal wall (e.g., 327) within the material dispenser (e.g., 326). The material transferred by the roller (e.g., 331) may be thrown onto a surface that is a part of the material dispenser (e.g., internal wall surface, 337), and may then exit the material dispenser though the exit opening port (e.g., 329) towards the target surface (e.g., 333) and form a material-fall (e.g., 330).

The material dispenser can comprise a flow of gas mixed with the particulate material. The number density of the particles in the gas and the flow rate of the gas can be chosen such that a predetermined amount of particulate material is dispensed from the material dispenser in a predetermined time period. The gas flow rate can be chosen such that gas flowing (e.g., blown) towards the substrate does not disturb an exposed surface of the material bed and/or the (e.g., forming) 3D object. The gas flow rate can be chosen such that gas flowing towards the substrate does not disturb at least the position of the 3D object.

An exit opening of a material dispensing mechanism may comprise an obstruction (e.g., a plane or a mesh such as, for example, disclosed herein).

The material dispenser may comprise a tube (e.g., including a straight and/or curved portion). The tube can comprise an opening. The opening can be located at an inflection point of the curved tube shape. The opening can be located on the outside of the curved tube shape. The opening can be on a side of the tube towards the substrate. The opening can be a pinhole. The pinhole can have a FLS (e.g., diameter or radius) of at least about 0.001 mm, 0.01 mm, 0.03 mm, 0.05 mm, 0.07 mm, 0.09 mm, 0.1 mm, 1 mm, 2 mm, 3 mm, 4 mm, 5 mm, or 10 mm. The pinhole can have a FLS between any of the aforementioned values. A mixture of gas and particulate material can flow (e.g., forced) through the curved tube. The particulate material can be suspended in the gas. At least a fraction of the particulate material may exit the curved tube through the opening (e.g., exit opening port). The number density of the particles (e.g., of particulate material) in the gas and the flow rate of the gas can be selected such that a predetermined amount of particulate material is dispensed on to the target surface in a certain (e.g., predetermined) time period. The gas flow rate can be chosen such that gas flowing (e.g., blown) onto the target surface does not disturb the exposed surface of the material bed and/or the 3D object. The distance between the opening and the source and/or intermediate surface (e.g., of a roller) can be adjusted such that a certain (e.g., predetermined) amount of particulate material is dispensed on to the source and/or intermediate surface in a predetermined time period. In some cases, the size of the opening can be selected such that particulate material of a predetermined size range exit the curved tube through the exit opening port and dispensed onto the source and/or intermediate surface. The target surface can be the platform, exposed surface of the material bed, intermediate surface, platform, or source surface.

The systems (collectively “the system”), and/or apparatuses (collectively “the apparatus”) may comprise a controller. The methods and/or software may use a controller. The controller may control the vibrator(s). For example, the controller may control the operation of the vibrator(s). The controller may control the amplitude and/or frequency of vibrations of the vibrator(s). The controller may control each of the plurality of vibrators individually, or as a group (e.g., collectively). The controller may control at least two vibrators individually, or collectively. The controller may control at least two of the vibrators sequentially. The controller may control the amount of particulate material released by the material dispenser (e.g., by controlling the vibrator(s)). The controller may control the velocity of the particular material released by the material dispenser. The controller may control the height from which particulate material is released from the material dispenser. The controller may control the position of the material dispenser. The controller can control the height, length, and/or width of the material-fall. The controller can control the position of the material-fall relative to the target surface (e.g., the exposed surface of the material bed or platform). The position may comprise a vertical position, horizontal position, or angular position. The position may comprise coordinates.

The controller may control the operation of the item (e.g., roller or drum) comprising the intermediate and/or source surface. The controller may control the velocity of the item (e.g., lateral, angular, and/or rotational velocity). When the controller may control each item (e.g., roller) individually or control all the items in concert. The controller may control each of the items (e.g., drums) sequentially. The controller may control the amount of particulate material dispensed on the intermediate and/or source surface. The controller may control the velocity of the particulate material deposited on the intermediate and/or source surface. The controller may control the height (e.g., thickness) of the layer of particulate material on the intermediate and/or source surface. The controller may control the position of the item(s), intermediate surface, and/or source surface. The controller may control the position of the scraper (e.g., doctor blade; FIG. 6, 603, or FIG. 7, 703). The position may comprise a vertical position, horizontal position, or angular position. The position may comprise coordinates.

As the material is picked up from the reservoir (e.g., 602) by the item (e.g., intermediate surface 606 and/or source surface 607), it can be leveled. The leveling can be achieved by a 3D plane (e.g., 603). For example, the leveling can be effectuated by using a blade (e.g., Doctor's blade). FIG. 6 shows an example of a reservoir 601 comprising particulate material 602 that is picked up by an intermediate surface 606 disposed on a roller as it rotates. A 3D plane 603 allows only a certain layer height (e.g., 614) to be picked up by the rotating roller, by forming a narrow opening. The layer of particulate material 614 disposed on the intermediate roller subsequently transfers to the source surface 607 to form a layer of particular material 613 on it. The material dispenser travels (e.g., comprising the reservoir, intermediate and source surfaces) travels in a direction 609 relative to the exposed surface of the material bed 611 and the platform 602. FIG. 7 shows an example of a reservoir 701 comprising particulate material 702 that is picked up by an intermediate surface 706 disposed on a roller as it rotates. A 3D plane 703 allows only a certain layer height (e.g., 714) to be picked up by the rotating roller, by forming a narrow opening. The layer of particulate material 714 disposed on the intermediate roller subsequently transfers to the source surface 707 to form a layer of particular material 713 on it. The material dispenser travels (e.g., comprising the reservoir, intermediate and source surfaces) travels in a direction 709 relative to the exposed surface of the material bed 711 and the platform 702. The controller may control the path (e.g., lateral path) traveled by the material dispensing mechanism, target surface, and/or items. The controller may control the path traveled by the energy beam. The controller may control the path traveled by the material-fall (e.g., lateral travel). The controller may control the level of a layer of particulate material that is deposited on the target surface (e.g., intermediate surface, source surface, platform, and/or exposed surface of the material bed). The particulate material may be leveled to a layer by a leveling mechanism. The layer of particulate material can comprise particles of homogeneous or heterogeneous size and/or shape.

At least a portion of the 3D object can sink in the material bed. At least a portion of the 3D object can be surrounded by the particulate material within the material bed (e.g., submerged). At least a portion of the 3D object can rest in the particulate material without substantial sinking (e.g., vertical movement). Lack of substantial sinking can amount to a sinking (e.g., vertical movement) of at most about 40%, 20%, 10%, 5%, or 1% of the layer thickness. Lack of substantial sinking can amount to at most about 100 μm, 30 μm, 10 μm, 3 μm, or 1 μm. At least a portion of the 3D object can rest in the particulate material without substantial movement (e.g., horizontal movement, movement at an angle). Lack of substantial movement can amount to at most 100 μm, 30 μm, 10 μm, 3 μm, or 1 μm. The 3D object can rest on the substrate when the 3D object is sunk or submerged in the fluidizable material bed. Fluidizable refers to the material bed comprising particulate material that has not been sintered (e.g., lightly sintered), or bound in any way. The material bed is in a (e.g., substantially) homogenous pressure though its width, length, and/or height.

The material dispensing method may utilize any of the material dispensing mechanism described herein. The material dispensing method may utilize gravitational, electrostatic, magnetic, and/or gas flow (e.g., comprising vacuum or positive pressure).

The systems, apparatuses, and/or methods described herein can comprise a material recycling system (herein “recycling system”). The recycling system can collect particulate material that did not transform to form the 3D object, and return the unused material to a reservoir of a material dispensing mechanism (e.g., the material dispensing reservoir), or to the bulk reservoir. The unused particulate material (e.g., the remainder) can be sieved and/or conditioned. Unused particulate material may be particulate material that was not used to form at least a portion of the 3D object. At least a fraction of the particulate material within the material bed that did not transform to subsequently form the 3D object can be recovered by the recycling system. A vacuum (e.g., which can be located at an edge of the material bed) can collect unused material. Unused material can be removed from the material bed without vacuum. Unused material can be removed from the material bed by actively pushing it from the material bed (e.g., mechanically or using a positive pressurized gas). Unused material can be removed from the material bed manually. Unused material can be removed from the material bed by positive pressure (e.g., by blowing away the unused material). A gas flow can direct unused material to the vacuum and/or to an opening. A material collecting mechanism (e.g., a shovel) can direct unused material to exit the material bed (e.g., and optionally enter the recycling system). The recycling system can comprise one or more filters (e.g., sieves) to control a size range of the particles returned to the reservoir. In some cases, a Venturi scavenging nozzle can collect unused material. The nozzle can have a high aspect ratio (e.g., at least about 2:1, 5:1, 10:1, 20:1, 30:1, 40:1, or 100:1) such that the nozzle does not become clogged with material particle(s). At times, unused material exits the material bed though an opening (e.g., drainage) port. The opening (e.g., drainage) port may facilitate exit of the remainder from the enclosure. In some embodiments, the material may be collected by a drainage system though one or more drainage ports that drain material from the material bed into one or more drainage reservoirs. The drainage reservoirs may be separate from the bulk and/or material dispenser reservoirs. The drainage reservoirs may be fluidly connected to the bulk and/or material dispenser reservoirs. The drainage reservoirs may be the bulk and/or material dispenser reservoirs. The material in the one or more drainage reservoirs may be re used (e.g., after filtration and/or further treatment).

The system, methods, software, and/or apparatus described herein can be adapted and configured to generate a 3D object. The 3D object can be generated through a 3D printing process. A first layer of particulate material can be provided adjacent to a platform, and/or bottom of an enclosure. A platform can be a previously formed layer of the 3D object or any other surface upon which a layer or bed of material is spread, held, placed, or supported. In the case of formation of the first layer of the 3D object the first material layer can be formed in the material bed without a platform, without auxiliary support (e.g., rods), and/or without other supporting structure other than the particulate material (e.g., within the material bed). Subsequent layers can be formed such that at least one portion of the subsequent layer melts, sinters, fuses, binds and/or otherwise connects to the at least a portion of a previously formed layer. In some instances, the at least a portion of a previously formed layer of hardened material, acts as a platform for formation of the 3D object. In some cases, the first layer of hardened material comprises at least a portion of the platform.

The power per unit area of the energy beam may be at least about 100 Watt per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm2, 7000 W/mm², or 10000 W/mm². The power per unit area of the tiling energy flux may be at most about 110 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the energy beam may be any value between the aforementioned values (e.g., from about 100 W/mm² to about 3000 W/mm², from about 100 W/mm² to about 5000 W/mm², from about 100 W/mm² to about 10000 W/mm², from about 100 W/mm² to about 500 W/mm², from about 1000 W/mm² to about 3000 W/mm², from about 1000 W/mm² to about 3000 W/mm², or from about 500 W/mm² to about 1000 W/mm²). The energy beam may be continuous or non-continuous (e.g., pulsing). The energy beam may be modulated before and/or during the formation of a transformed material as part of the 3D object. The energy beam may be modulated before and/or during the 3D printing process.

The energy source can project an energy beam having a power of at least about 100 watt (W), 150 W, 200 W, 250 W, 350 W, 500 W, 550 W, 600 W, 650 W, 700 W, or 1000 W. The energy source can project an energy beam having a power of at most about 100 W, 150 W, 200 W, 250 W, 350 W, 500 W, 550 W, 600 W, 650 W, 700 W, or 1000 W. The energy source can project an energy beam having a power of any value between the aforementioned values (e.g. from about 100 W to about 1000 W, or from about 200 W to about 500 W). The energy source can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of a value between the aforementioned values (e.g., from about 50 J/cm² to about 5000 J/cm², from about 200 J/cm² to about 1500 J/cm², from about 1500 J/cm² to about 2500 J/cm², from about 100 J/cm² to about 3000 J/cm², or from about 2500 J/cm² to about 5000 J/cm²).

An energy beam projected from the energy source(s) can be incident on, or be directed (e.g., substantially) perpendicular to, the average surface of the material-fall. An energy beam projected from the energy source(s) can be directed at an acute angle beta relative to the target surface (e.g., exposed surface of the material bed or platform). Beta may be at least about 0.1°, 0.25°, 0.5°, 10, 2°, 3°, 4°, 50, 10°, 15°, 20°, 30°, or 40°. Beta may be at most about 0.1°, 0.25°, 0.5°, 1°, 2°, 3°, 4°, 5°, 10°, 15°, 20°, 30°, 40°, or 50°. Beta may be of any value between the afore-mentioned degree values for gamma and/or delta (e.g., from about 0.1° to about 50°, from about 0.1° to about 5°, from about 5° to about, 50°, from about 0.1° to about, 2°, or from about 0.1° to about, 1°). The energy beam can be directed onto a specified area of at least a portion of the material-fall and/or target surface for a specified time period. At times, the energy beam does not intersect the target surface. The energy beam may travel incident to the target surface. The energy beam may travel away from the target surface. The energy beam may travel (e.g., substantially) parallel to the target surface. The energy beam may travel towards the target surface. The particulate material in material-fall may absorb the energy from the energy beam and, and as a result, a localized region of the particulate material within the material-fall may increase in temperature. The energy beam can be moveable such that it can translate relative to the average surface (e.g., length) of the material-fall. FIG. 9 shows an example of the length of a material-fall 903. FIG. 2 shows an example of energy beam that interacts with particulate material within the material-fall 207 (e.g., that originates from an opening of a material dispenser 204) at specified locations 205, which interaction causes the particulate material within the material-fall to increase in temperature and transform. The transformed material may subsequently form the hardened material 202 disposed in the material bed 206 that is located on the substrate 201. The energy source may be movable such that it can translate relative to the material-fall. Alternatively or additionally, the material-fall may be movable such that it can translate relative to the energy beam. The energy beam(s) and/or energy source(s) can be moved via at least one scanner (e.g., as disclosed herein). At times, the 3D printer may comprise a plurality of energy beams, energy sources, and/or scanners. At least two of the energy sources and/or beams may be movable with the same scanner. Each of at least two of the energy sources and/or beams may be movable with different scanners (e.g., each has its own scanner). At least two of the energy source(s) and/or beam(s) can be translated independently of each other. In some cases, at least two of the energy source(s) and/or beam(s) can be translated at different rates (e.g., velocities). In some cases, the energy source(s) and/or beam(s) can be comprise at least one different characteristic. The characteristics may comprise wavelength, power, power density, amplitude, trajectory, footprint, intensity, energy, focus, or charge. The charge can be electrical and/or magnetic charge.

The energy source can be an array, or a matrix, of energy sources (e.g., laser diodes). At least two (e.g., each) of the energy sources (e.g., laser diodes) in the array (or matrix) can be independently controlled (e.g., by a control mechanism) such that the at least two energy sources can be turned off and on independently. At least two of the energy sources in the array (or matrix) can be collectively controlled such that the at least two of the energy sources can be turned off and on simultaneously. In some instances, all the energy sources in the array (or matrix) are collectively controlled such that all of the energy sources can be turned off and on simultaneously. The energy per unit area or intensity of at least two of the energy sources in the matrix (or array) can be modulated independently (e.g., by a control mechanism or system). At times, the energy per unit area or intensity of at least two of the energy sources in the matrix or array can be modulated collectively (e.g., by a control mechanism or manually). At times, the energy per unit area or intensity of all of the energy sources in the matrix or array can be modulated collectively (e.g., by a control mechanism). The energy source can scan along the material wall. The scanning may be effectuated by one or more scanners. The scanning may be effectuated by mechanical movement of the energy source(s), one or more adjustable reflective mirrors, or one or more polygon light scanners. The energy source(s) can project energy using a DLP modulator, a one-dimensional scanner, a two-dimensional scanner, or any combination thereof. The energy source(s) can be stationary. The target surface can translate vertically, horizontally, or in an angle relative to the material-fall.

The energy source(s), beam(s), and/or scanners can be independently or collectively controllable by a control mechanism (e.g., computer), as described herein. At times, at least two of the energy source(s), beam(s), and/or scanners can be controlled (e.g., independently or collectively) by a control mechanism, or manually.

In some cases, a layer of the 3D object is formed within at most about 1 hour (h), 30 minutes (min), 20 min, 10 min, 5 min, 1 min, 40 seconds (sec), 20 sec, 10 sec, 9 sec, 8 sec, 7 sec, 6 sec, 5 sec, 4 sec, 3 sec, 2 sec, or 1 sec. A layer of the 3D object can be formed within at least about 30 min, 20 min, 10 min, 5 min, 1 min, 40 sec, 20 sec, 10 sec, 9 sec, 8 sec, 7 sec, 6 sec, 5 sec, 4 sec, 3 sec, 2 sec, or 1 sec. A layer of the 3D can be formed within any time between the aforementioned time scales (e.g., from about 1 h to about 1 sec, from about 10 min to about 1 sec, from about 40 s to about 1 sec, from about 10 sec to about 1 sec, or from about 5 sec to about 1 s).

The final form of the 3D object can be retrieved soon after cooling of a final material layer. Soon after cooling may be at most about 1 day, 12 hours, 6 hours, 3 hours, 2 hours, 1 hour, 30 minutes, 15 minutes, 5 minutes, 240 sec, 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after cooling may be between any of the aforementioned time values (e.g., from about is to about 1 day, from about is to about 1 hour, from about 30 minutes to about 1 day, or from about 20 s to about 240 s. In some cases, the cooling can occur by method comprising active cooling by convection using a cooled gas or gas mixture comprising argon, nitrogen, helium, neon, krypton, xenon, hydrogen, carbon monoxide, carbon dioxide, or oxygen.

In some cases, unused particulate material can surround the 3D object in the material bed. The unused particulate material can be substantially removed from the 3D object. Substantial removal may refer to particulate material covering at most about 20%, 15%, 10%, 8%, 6%, 4%, 2%, 1%, 0.5%, or 0.1% of the surface of the 3D object after removal. Substantial removal may refer to removal of all the particulate material that was disposed in the material bed and remained as material at the end of the 3D printing process (e.g., the remainder), except for at most about 10%, 3%, 1%, 0.3%, or 0.1% of the weight of the remainder. Substantial removal may refer to removal of all the remainder except for at most about 50%, 10%, 3%, 1%, 0.3%, or 0.1% of the weight of the printed 3D object. The unused particulate material can be removed to permit retrieval of the 3D object without digging through the material bed. For example, the remainder can be suctioned out of the material bed by one or more vacuum ports (e.g., built adjacent to the material bed), by brushing off the remainder, by lifting the 3D object from the remainder, by allowing the remainder to flow away from the 3D object (e.g., by opening an exit opening port on the side(s) or on the bottom of the material bed from which the unused material can exit). After the remainder is evacuated, the 3D object can be removed and the unused particulate material can be re-circulated to a material reservoir for use in future builds. In some cases, cooling gas can be directed to the hardened material (e.g., 3D object) for cooling the hardened material during its retrieval.

In some cases, the 3D object (i.e., 3D part) can be retrieved within at most about 12 hours (h), 6 h, 5 h, 4 h, 3 h, 2 h, 1 h, 30 minutes (min), 20 min, 10 min, 5 min, 1 min, 40 seconds (s), 20 sec, 10 sec, 9 sec, 8 sec, 7 sec, 6 sec, 5 sec, 4 sec, 3 sec, 2 sec, or 1 sec after cooling of a last material layer. Cooling may be cooling to a temperature that allows a person or a machine (e.g., robot) to handle the 3D object. Handle the 3D object comprises handling it without (e.g., substantial) deformation. Cooling may be cooling to a handling temperature. The 3D object can be retrieved during a time period between any of the aforementioned time periods (e.g., from about 12h to about 1 sec, from about 12h to about 30 min, from about 1 h to about 1 sec, or from about 30 min to about 40 sec).

The generated 3D object can require very little or no further processing after its retrieval. In some examples, the diminished further processing or lack thereof, will afford a 3D printing process that requires smaller amount of energy and/or less waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforementioned values (e.g., from about 1.1 to about 10, or from about 1.5 to about 5). Further processing may comprise trimming. Further processing may comprise polishing (e.g., sanding). For example, the generated 3D object can be retrieved and finalized without removal of transformed material and/or auxiliary support. The 3D object can be retrieved when the 3D part, composed of hardened (e.g., solidified) material, is at a handling temperature that is suitable to permit the removal of the 3D object from the material bed without substantial deformation. The handling temperature can be a temperature that is suitable for packaging of the 3D object. The handling temperature a can be at most about 120° C., 100° C., 80° C., 60° C., 40° C., 30° C., 25° C., 20° C., 10° C., or 5° C. The handling temperature can be of any value between the aforementioned temperature values (e.g., from about 120° C. to about 20° C., from about 40° C. to about 5° C., or from about 40° C. to about 10° C.). The handling temperature can be room temperature or ambient temperature.

The 3D object can be formed without auxiliary support and/or without contacting a platform (e.g., a base, a substrate, or a bottom of an enclosure). The auxiliary support (which may include a platform support) can be used to hold (e.g., or restrain) the 3D object during its formation. In some cases, auxiliary support can be used to anchor or hold a 3D object (or a portion of a 3D object) in the material bed. The one or more auxiliary features can be specific to a part and can increase the time, starting material, and/or energy required to form the 3D object. The auxiliary support can be removed prior to use or distribution of the 3D object. The longest dimension of a cross-section of an auxiliary feature can be at most about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be at least about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be any value between the above-mentioned values (e.g., from about 50 nm to about 300 mm, from about 5 μm to about 10 mm, from about 50 nm to about 10 mm, or from about 5 mm to about 300 mm). Eliminating the need for auxiliary features can decrease the time and/or cost associated with generating the 3D part. In some examples, the 3D object may be formed with auxiliary features. In some examples, the 3D object may be formed with contact (e.g., but not anchor) to the container accommodating the material bed (e.g., side(s) and/or bottom of the container).

The methods, apparatuses, software, and/or systems provided herein can result in fast and efficient formation of 3D objects. In some cases, the 3D object can be transported within at most about 120 min, 100 min, 80 min, 60 min, 40 min, 30 min, 20 min, 10 min, or 5 min after the last layer of the 3D object hardens (e.g., solidifies and/or reaches a handling temperature). In some cases, the 3D object can be transported within at least about 120 min, 100 min, 80 min, 60 min, 40 min, 30 min, 20 min, 10 min, or 5 min after the last layer of the 3D object hardens (e.g., and reaches a handling temperature). In some cases, the 3D object can be transported within any time between the above-mentioned values (e.g., from about 5 min to about 120 min, from about 5 min to about 60 min, or from about 60 min to about 120 min). The 3D object can be transported once it cools to a temperature of at most about 100° C., 90° C., 80° C., 70° C., 60° C., 50° C., 40° C., 30° C., 25° C., 20° C., 15° C., 10° C., or 5° C. The 3D object can be transported once it cools to a temperature value between the above-mentioned temperature values (e.g., from about 5° C. to about 100° C., from about 5° C. to about 40° C., or from about 15° C. to about 40° C.). Transporting the 3D object can comprise packaging and/or labeling the 3D object. In some cases, the 3D object can be transported (e.g., directly) to a consumer, government, organization, company, hospital, medical practitioner, engineer, retailer, or any other entity, or individual that is interested in receiving the object.

The system, software, method, and/or apparatus can comprise a controlling mechanism (e.g., a controller) comprising a computer-processing unit (e.g., a computer) coupled to any of the systems and/or apparatuses, or their respective components (e.g., the energy source(s)). The computer can be operatively coupled through a wired or through a wireless connection. In some cases, the computer can be on board a user device. A user device can be a laptop computer, desktop computer, tablet, smartphone, another computing device, or any combination thereof. The controller can be in communication with a cloud computer system or a server. The controller can be programmed to (e.g., selectively) direct the energy source(s) to apply energy to the at least a portion of the source surface and/or target surface at a power per unit area. The controller can be in communication with the scanner configured to articulate the energy source(s) to apply energy to at least a portion of the target surface (e.g., source surface) and/or material-fall at a power per unit area.

The scanner can include an optical system that is configured to direct energy from an energy source to a (e.g., predetermined) position on the target surface (e.g., source surface) and/or material-fall. The controller can be programmed to control a trajectory of the energy source(s) with the aid of the optical system. The control system can regulate a supply of energy from the energy source to the particulate material (e.g., at the material-fall) to form a transformed material. Transformed may comprise (e.g., complete) transformation of a physical state (e.g., solid to liquid) or in shape of the particulate material.

One or more of the system components can be contained in the enclosure (e.g., chamber). The enclosure can include a reaction space that is suitable for introducing precursor to form a 3D object, such as particulate (e.g., powder) material. The enclosure can contain the building platform. In some cases, the enclosure can be a vacuum chamber, a positive pressure chamber, or an ambient pressure chamber. The enclosure can comprise a gaseous environment with a controlled (e.g., homogenous, or substantially homogenous) pressure, temperature, and/or gas composition. The gas composition in the environment contained by the enclosure can comprise an (e.g., substantially) oxygen free environment. For example, the gas composition can contain at most about 100,000 parts per million (ppm), 10,000 ppm, 1000 ppm, 500 ppm, 400 ppm, 200 ppm, 100 ppm, 50 ppm, 10 ppm, 5 ppm, 1 ppm, 100,000 parts per billion (ppb), 10,000 ppb, 1000 ppb, 500 ppb, 400 ppb, 200 ppb, 100 ppb, 50 ppb, 10 ppb, 5 ppb, 1 ppb, 100,000 parts per trillion (ppt), 10,000 ppt, 1000 ppt, 500 ppt, 400 ppt, 200 ppt, 100 ppt, 50 ppt, 10 ppt, 5 ppt, or 1 ppt oxygen. The gas composition in the environment contained within the enclosure can comprise a (e.g., substantially) moisture (e.g., water) free environment. The gaseous environment can comprise at most about 100,000 ppm, 10,000 ppm, 1000 ppm, 500 ppm, 400 ppm, 200 ppm, 100 ppm, 50 ppm, 10 ppm, 5 ppm, 1 ppm, 100,000 ppb, 10,000 ppb, 1000 ppb, 500 ppb, 400 ppb, 200 ppb, 100 ppb, 50 ppb, 10 ppb, 5 ppb, 1 ppb, 100,000 ppt, 10,000 ppt, 1000 ppt, 500 ppt, 400 ppt, 200 ppt, 100 ppt, 50 ppt, 10 ppt, 5 ppt, or 1 ppt water. The gaseous environment can comprise a gas selected from the group consisting of argon, nitrogen, helium, neon, krypton, xenon, hydrogen, carbon monoxide, carbon dioxide, and oxygen. The gaseous environment can comprise air. In some cases, the enclosure (e.g., homogenous) pressure can be standard atmospheric pressure. The gas can be an ultrahigh purity gas. For example, the ultrahigh purity gas can be at least about 99%, 99.9%, 99.99%, or 99.999% pure. The gas may comprise less than about 2 ppm oxygen, less than about 3 ppm moisture, less than about 1 ppm hydrocarbons, or less than about 6 ppm nitrogen.

The enclosure can be maintained under a vacuum, inert, dry, non-reactive, and/or oxygen reduced (or otherwise controlled) atmosphere (e.g., a nitrogen (N₂), helium (He), or argon (Ar) atmosphere). The atmosphere can be generated by providing an inert, dry, non-reactive, and/or oxygen reduced gas (e.g., Ar) and/or flowing the gas through the chamber.

In some examples, a pressure system is in fluid communication with the enclosure. The pressure system can be configured to regulate the pressure in the enclosure. In some examples, the pressure system includes one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector. The pressure system can include valves, such as throttle valves. The pressure system can include a pressure sensor for measuring the pressure of the chamber and relaying the pressure to the controller, which can regulate the pressure with the aid of one or more vacuum pumps of the pressure system. The pressure sensor can be coupled to a control system. The pressure can be electronically or manually controlled.

In some examples, the pressure system includes one or more pumps. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump, or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valveless pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump.

The systems, apparatuses, software, and methods presented herein can facilitate formation of custom (e.g., a stock of) 3D objects for a customer. A customer can be an individual, a corporation, an organization, a government organization, a non-profit organization, or another organization or entity. A customer can submit a request for formation of a 3D object. The customer can provide an item of value in exchange for the 3D object. The customer can provide a design or a model for the 3D object. The customer can provide the design in the form of a stereo lithography (STL) file. The customer can provide a design where the design can be a definition of the shape and dimensions of the 3D object in any other numerical or physical form. In some cases, the customer can provide a 3D model, sketch, or image as a design of an object to be generated. The design can be transformed in to instructions usable by the printing system to additively generate the 3D object. The customer can further provide a request to form the 3D object from a specific material or group of materials. For example, the customer can specify that the 3D object should be made from one or more than one of the materials used for 3D printing described herein. The customer can request a specific material within that group of material (e.g., a specific elemental metal, a specific alloy, a specific ceramic or a specific allotrope of elemental carbon). In some cases, the design does not contain auxiliary support.

In response to the customer request the 3D object can be formed or generated with the printing system as described herein. In some cases, the 3D object can be formed by an additive 3D printing process. Additively generating the 3D object can comprise successively depositing and melting a particulate comprising one or more materials as specified by the customer. The 3D object can subsequently be delivered to the customer. The 3D object can be formed without generation or removal of auxiliary support. In some cases, the 3D object can be additively generated in a period of at most about 7 days (d), 6 d, 5 d, 3 d, 2 d, 1 d, 12 hours (h), 6 h, 5 h, 4 h, 3 h, 2 h, 1 h, 30 min, 20 min, 10 min, 5 min, 1 min, 30 sec, or 10 sec. In some cases, the 3D object can be additively generated in a period between any of the aforementioned time periods (e.g., from about 10 sec to about 7 d, from about 10 sec to about 12 h, from about 12 h to about 7 d, or from about 12 h to about 10 min).

The 3D object (e.g., solidified material) can have an average deviation value from the intended dimensions of at most about 0.5 microns (μm), 1 μm, 3 μm, 10 μm, 30 μm, 100 μm, or 300 μm. The deviation can be any value between the aforementioned values (e.g., from about 0.5 μm to about 300 μm, from about 10 μm to about 50 μm, from about 15 μm to about 85 μm, from about 5 μm to about 45 μm, or from about 15 μm to about 35 μm). The 3D object can have a deviation from the intended dimensions in a specific direction, according to the formula Dv+L/K_{Dv}, wherein Dv is a deviation value, L is the length of the 3D object in a specific direction, and K_{Dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, or 300 μm. Dv can have any value between the aforementioned values (e.g., from about 0.5 μm to about 300 μm, from about 10 μm to about 50 μm, from about 15 μm to about 85 μm, from about 5 μm to about 45 μm, or from about 15 μm to about 35 μm). K_{dv} can have a value of at most about 3000, 2500, 2000, 1500, 1000, or 500. K_{dv} can have a value of at least about 500, 1000, 1500, 2000, 2500, or 3000. K_{dv} can have any value between the aforementioned values (e.g., from about 3000 to about 500, from about 1000 to about 2500, from about 500 to about 2000, from about 1000 to about 3000, or from about 1000 to about 2500).

The intended dimensions can be derived from a model design. The 3D part can have the stated accuracy value immediately after its formation, without additional processing or manipulation. Receiving the order for the object, formation of the object, and delivery of the object to the customer can take at most about 7 days (d), 6 d, 5 d, 3 d, 2 d, 1 d, 12 h, 6 h, 5 h, 4 h, 3 h, 2 h, 1 h, 30 min, 20 min, 10 min, 5 min, 1 min, 30 sec, or 10 sec. The 3D object can be additively generated in a period between any of the aforementioned time periods (e.g., from about 10 sec to about 7 d, from about 10 sec to about 12 h, from about 12 h to about 7 d, or from about 12 h to about 10 min). The time can vary based on the physical characteristics of the 3D object, including its size and/or complexity. The generation of the 3D object can be performed without iterative and/or corrective printing. The 3D object may be devoid of auxiliary support.

The methods, systems, and/or apparatuses disclosed herein may incorporate a controller mechanism that controls one or more of the components described herein. The controller may comprise a central processing unit (herein “CPU”). The controllers or control mechanisms (e.g., comprising a computer system) may be programmed to implement methods of the disclosure. The controller may control at least one component of the systems and/or apparatuses disclosed herein. FIG. 11 schematically depicts a computer system 1101 that is programmed or otherwise configured to facilitate the formation of a 3D object according to the methods provided herein. The computer system 1101 can regulate various features of printing methods, apparatuses and/or systems of the present disclosure, such as for example, regulating charging, translation, heating, cooling and/or maintaining the temperature, gas ratio, pressure, process parameters (e.g., chamber pressure), scanning route of the energy beam, trajectory of the particulate material within the material-fall, application of the amount of energy emitted to a selected location, or any combination thereof. The computer system 1101 can be part of, or be in communication with, a printing system or apparatus, such as a 3D printing system or apparatus of the present disclosure. The computer may be coupled to one or more mechanisms disclosed herein, and/or any parts thereof. For example, the computer may be coupled to one or more sensors, valves, pumps, switches, motors, or any combination thereof.

The computer system 1101 can include a central processing unit (CPU, also “processor,” “computer” and “computer processor” used herein) 1105, which can be a single core or multi core processor, or a plurality of processors (e.g., for parallel processing). Alternatively or additionally, the computer system can include a circuit (e.g., an application-specific integrated circuit (ASIC)). The computer system also includes memory or memory location 1110 (e.g., random-access memory, read-only memory, flash memory), electronic storage unit 1115 (e.g., hard disk), communication interface 1120 (e.g., network adapter) for communicating with one or more other systems, and/or peripheral devices 1125 (e.g., cache, other memory, data storage and/or electronic display adapters). The memory 1110, storage unit 1115, interface 1120, and peripheral devices 1125 may be in communication with the CPU 1105 through a communication bus (solid lines), such as a motherboard. The storage unit can be a data storage unit (or data repository) for storing data. The computer system can be operatively coupled to a computer network (“network”) 1130 with the aid of the communication interface. The network can be the Internet, an Internet and/or extranet, or an intranet and/or extranet that is in communication with the Internet. The network, in some cases, is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The CPU can execute a sequence of machine-readable instructions, which can be embodied in a program or software. The instructions may be stored in a memory location, such as the memory. The instructions can be directed to the CPU, which can subsequently program or otherwise configure the CPU to implement methods of the present disclosure. Examples of operations performed by the CPU can include fetch, decode, execute, and write back.

The CPU 1105 can be part of a circuit, such as an integrated circuit. One or more other components of the system 1101 can be included in the circuit. In some cases, the circuit is an application specific integrated circuit (ASIC).

The storage unit 1115 can store files, such as drivers, libraries and saved programs. The storage unit can store user data, e.g., user preferences and user programs. The computer system, in some cases, can include one or more additional data storage units that are external to the computer system, such as located on a remote server that is in communication with the computer system through an intranet or the Internet.

The computer system 1101 can communicate with one or more remote computer systems through the network 1130. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory or electronic storage unit. The machine executable or machine-readable code can be provided in the form of software. During use, the processor can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems, apparatuses, and/or methods provided herein, such as the computer system, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, wire (e.g., copper wire), and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1101 can include or be in communication with an electronic display that comprises a user interface (UI) for providing, for example, a model design or graphical representation of a 3D object to be printed. Examples of UI's include, without limitation, a graphical user interface (GUI), and web-based user interface. The computer system can monitor and/or control various aspects of the 3D printing system. The control may be manual and/or programmed. The control may rely on feedback mechanisms that have been pre-programmed. The feedback mechanisms may rely on input from sensors (described herein) that are connected to the control unit (i.e., control system or control mechanism e.g., computer). The computer system may store historical data concerning various aspects of the operation of the 3D printing system. The historical data may be retrieved at predetermined times and/or at a whim. The historical data may be accessed by an operator or by a user. The historical and/or operative data may be displayed on a display unit. The display unit (e.g., monitor) may display various parameters of the 3D printing system (as described herein) in real time and/or in a delayed time. The display unit may display the current 3D printed object, the ordered 3D printed object, or both. The display unit may display the printing progress of the 3D printed object. The display unit may display at least one of the total time, time remaining, and time expanded on printing the 3D object. The display unit may display the status of sensors, their reading, and/or time for their calibration or maintenance. The display unit may display the type of powder material used and various characteristics of the material such as temperature and flowability of the particulate material. The display unit may display the amount of oxygen, water, and pressure in the enclosure (e.g., the 3D printing chamber). The computer may generate a report comprising various parameters of the 3D printing system at predetermined time(s), on a request (e.g., from an operator), or at a whim. The display unit may comprise a screen. The display unit may comprise a printer. The controller may provide a report. The report may comprise any items recited as optionally displayed by the display unit.

Methods, systems, and/or apparatuses of the present disclosure can be implemented by way of one or more algorithms. An algorithm can be implemented by way of software upon execution by one or more computer processors.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for forming a three-dimensional object, comprising:
(a) generating a material-fall that is directed towards a target surface, wherein the material-fall comprises a particulate material;
(b) projecting an energy beam onto the material-fall in one or more specified locations that correspond to a model design of the three-dimensional object, wherein the energy beam does not intersect the target surface; and
(c) transforming at least a portion of the particulate material in the material-fall to a transformed material that forms at least a portion of the three-dimensional object.

2. The method of claim 1, wherein the target surface comprises a platform or an exposed surface of a material bed, which material bed is formed by the particulate material.

3. The method of claim 1, wherein the particulate material comprises a powder material.

4. The method of claim 1, wherein the particulate material comprises a solid material.

5. The method of claim 1, wherein the particulate material is formed of a material selected from the group consisting of an elemental metal, metal alloy, ceramic, and an allotrope of carbon.

6. The method of claim 1, wherein the particulate material is not suspended in at least one gas prior to entering the material-fall.

7. The method of claim 1, wherein transforming comprises melting or sintering.

8. The method of claim 1, wherein forms at least a portion of the three-dimensional object comprises hardens to form least a portion of the three-dimensional object.

9. The method of claim 8, wherein hardens comprises solidifies.

10. The method of claim 1, wherein the material-fall is a stream comprising the particulate material.

11. The method of claim 10, wherein the stream is a directional stream.

12. The method of claim 10, wherein the stream is a directed stream.

13. The method of claim 12, wherein the directed is collimated.

14. The method of claim 13, wherein the collimated comprises a gas.

15. The method of claim 13, wherein the collimated comprises a lens.

16. The method of claim 15, wherein the lens comprises a hydraulic lens.

17. The method of claim 15, wherein the lens comprises a magnetic lens.

18. The method of claim 15, wherein the lens comprises an electrostatic lens.

19. The method of claim 15, wherein the lens comprises an electrode.

20. The method of claim 1, wherein the energy beam projects in a direction that is parallel or forms an angle away from the target surface, which angle is between the energy beam and the average target surface plane.

21. The method of claim 20, wherein the energy beam projects substantially parallel to the target surface.

22. The method of claim 20, wherein the energy beam projects at an angle away from the target surface.

23. The method of claim 1, wherein the energy beam travels in a direction different from a direction of the material-fall.

24. The method of claim 1, wherein the energy beam is directed towards a first position that is different from a second position to which the material-fall is directed to.

25. The method of claim 1, wherein the material-fall and the target surface are disposed within an enclosure, and wherein the material-fall travels freely within the enclosure.

26. The method of claim 1, wherein the material-fall and the target surface are disposed within an enclosure, and wherein the energy beam is unconfined within the enclosure.

27. The method of claim 1, wherein the particulate material in the material-fall travels at a substantially constant speed.
